(19) United States
(12) Patent Application Publication
(10) Pub. No.: US 2004/0033317 A1
(43) Pub. Date: Feb. 19, 2004

(54) Surface-active photoinitators

(76) Inventors: Gisele Baudin, Allschwil (CH); Tunja Jung, Rheinfelden-Herten (DE)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/432,264

(22) PCT Filed: Dec. 6, 2001
(86) PCT No.: PCT/EP01/14357

(30) Foreign Application Priority Data
Dec. 13, 2000 (EP) 00811185.8

(51) Int. Cl. C08J 7/04

(52) U.S. Cl. 427/487; 427/498

(57) ABSTRACT

A process for the production of coatings having scratch-resistant durable surfaces, in which there are used photocurable formulations comprising a surface-active photoinitiator, concentrated at the surface of the formulation, of formula (Ia), (Ib), (Ic) or (Id), wherein R and R₁ are, for example, each independently of the other a radical of formula (II); R₂, R₃, R₄, R₅, R₆, R₇, R₈ and R₉ are each independently of the others, for example, hydrogen; A-X, A₁-X₁-; unsubstituted or substituted C₁-C₁₂alkyl or phenyl; with the proviso that in formulae (Ia) and (Ib) at least one substituent A-X, A₁—X₁— is present in at least one of the radicals R and R₁; and with the proviso that in formulae (Ic) and (Id) at least one of the radicals ); R₂, R₃, R₄, R₅, R₆, R₇, R₅ and R₉ is A—X, A₁—X₁—; A and A₁ are each independently of the other a surface-active radical of formula (M) or Aₒ; n is, for example, a number from 1 to 1000 m is a number from 0 to 100; p is a number from 0 to 10 000; Aₒ is, for example, C₆-C₃₀alkyl; G₁ and G₂ are, for example, C₁-C₁alkyl; R₁₈, R₁₉, R₂o, R₂₂, R₂₁, R₂₃, R₂₄, R₂₅, R₂₆ and R₂₇ are, for example, C₁-C₁₈alkyl; and X and X₁ are, for example, a single bond.

The invention relates to surface-active photoinitiators, to a process for the production of scratch-resistant durable coatings in which such photoinitiators are used, and to compositions comprising novel surface-active photoinitiators.

In order to improve the miscibility (compatibility) of photoinitiators with silicone-containing substrates that are to be photochemically crosslinked, there are proposed, for example in WO 97/49768, U.S. Pat. No. 5,776,658, U.S. Pat. No. 4,391,963 and EP 088 842, photoinitiators, for example of the hydroxyketone, aminoketone, benzoin ether, benzophenone or thioxanthone type, modified with silyl radicals, especially also polymeric silyl radicals. Also described, in patent specifications U.S. Pat. No. 4,536,265, U.S. Pat. No. 4,534,838 and EP 162 572, is a wide variety of photoinitiator structures provided with organopolysiloxane radicals. Such compounds are derived, for example, from dialkoxyacetophenones and exhibit an increased solubility in silicone substrates. U.S. Pat. No. 4,507,187 discloses silyl-group-containing diketo photoinitiators as photoinitiators that are readily soluble in silicone polymers, as well as the polymers obtained using those initiators. There are described in U.S. Pat. No. 4,477,326 self-polymerizing siloxane polymers that contain photoinitiator units as groups triggering a polymerization reaction. Polymeric photoinitiators having siloxane radicals are described in U.S. Pat. No. 4,587,276.

In J.M.S. Pure Appl. Chem. A31(3) (1994), 305-318, A. Kolar, H. F. Gruber and G. Greber report on reactive silylderived x-hydroxyketone photoinitiators. The literature references mentioned are concerned especially with solving the problem of improving the miscibility of the photoinitiators with the substrate to be polymerized, that is to say of making the distribution of the initiator in the substrate as homogeneous as possible. WO 98/00456 proposes specific coating compositions, as well as a curing method that results in improved properties of the coating surface.

In the coating industry, new, energy-saving curing mechanisms and applications causing as few emissions as possible are being sought for the production of durable scratch-resistant coatings. There is also a particular need to improve the surface of coatings, especially in respect of hardness, durability and gloss properties.

It has now been found that the desired properties can be attained by using certain photoinitiators in the coatings to be cured. For that purpose the photoinitiator is not distributed as homogeneously as possible in the formulation to be cured but concentrated specifically at th surface of the coating to be cured, specific orientation of the initiator towards the surface of the formulation thus taking place. To achieve this it is necessary to use photoinitiators having particular properties.

The invention relates to a process for the production of coatings having scratch-resistant durable surfaces, which comprises

(1) preparing a photocurable formulation comprising

(A) an ethylenically unsaturated polymerizable compound; and

(B) a photoinitiator;

(2) applying the formulation to a substrate; and

(3) curing the formulation either solely by irradiation with electromagnetic radiation, for example of a wavelength ranging from 200 nm into the IR region, especially, for example, from 200 to 800 nm or from 200 to 600 nm, or

by irradiation with electromagnetic radiation, for example of a wavelength ranging from 200 nm into the IR region, especially, for example, from 200 to 800 nm or from 200 to 600 nm, and the prior, simultaneous and/or subsequent action of heat;

wherein

the formulation comprises as photoinitiator (B) at least one surface-active photoinitiator, concentrated at the surface of the formulation, of formula Ia, Ib, Ic or Id:

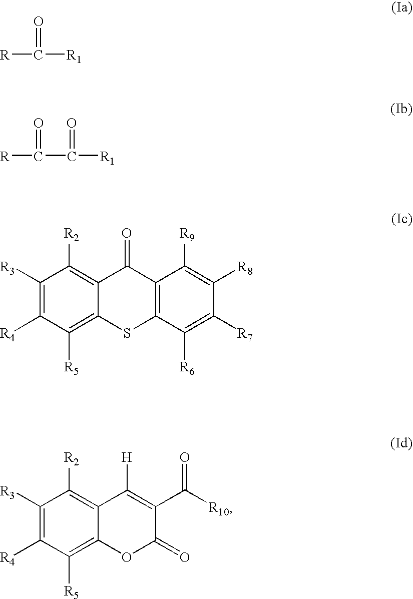

wherein

R and R₁ are each independently of the other a radical of formula II

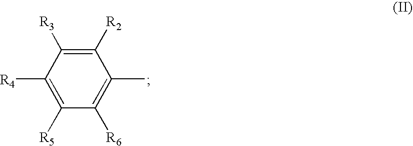

wherein in formula II

R₂, R₃, R₄, R₅ and R₆ are each independently of the others hydrogen; A-X—, A₁—X₁—; C₁-C₁₂alkyl unsubsututed or substituted by OH, C₁-C₄alkoxy, phenyl, naphthyl, halogen, CN, —C(O)R₁₁, and/or by —O(CO)R₁₁; or C₂-C₁₂alkyl interrupted by one or more non-consecutive oxygen atoms; or R₂, R₃, R₄, R₅ and R₆ are each independently OR₁₂, SR₁₃, NR₁₄R₁₅, —(C₁-C₆alkyl)NR₁₄R₁₅, —O—(C₁-C₆alkyl)-NR₁₄R₁₅, —C(O)R₁₁ or halogen; or are phenyl unsubstituted or substituted by C₁-C₄alkyl or by C₁-C₄alkoxy, the substituents OR₁₂, SR₁₃ and NR₁₄R₁₅ being capable, by way of the radicals R₁₂, R₁₃, R₁₄ and/or R₁₅ together with further substituents on the phenyl ring or together with one of the carbon atoms of the phenyl ring, of forming 5- or 6-membered rings;

with the proviso that in formulae (Ia) and (Ib) at least one substituent A-X— or A₁—X₁— is present in at least one of the radicals R and R₁;

or

R and R₁ are naphthyl, anthracyl, phenanthryl or a heterocyclic radical, the radicals naphthyl, anthracyl, phenanthryl and the heterocycle being unsubstituted or substituted by A-X—, A₁—X₁—, C₁-C₈alkyl, phenyl, OR₁₂, SR₁₃, NR₁₄R₁s, —(C₁-C₆alkyl)-NR₁₄R₁₅ or/and by —O—(C₁-C₆alkyl)-NR₁₄R₁₅, and the substituents OR₁₂, SR₁₃ and NR₁₄R₁₅ being capable, by way of the radicals. R₁₂, R₁₃, R₁₄ and/or R₁₅ together with further substituents on the naphthyl ring, anthracyl ring, phenanthryl ring or heterocycle or together with one of the carbon atoms of the naphthyl ring, anthracyl ring, phenanthryl ring or heterocycle, of forming 5- or 6-membered rings;

wherein in formula Ic

R₂, R₃, R₄, R₅, R₆, R₇, R₈ and R₉ are each independently of the others hydrogen; A-X—, A₁—X₁; C₁-C₁₂alkyl unsubstituted or substituted by OH, C₁-C₄alkoxy, phenyl, naphthyl, halogen, CN, —C(O)R₁₁ and/or by —O(CO)R₁₁; or C₂-C₁₂alkyl interrupted by one or more non-consecutive oxygen atoms; or R₂, R₃, R₄, R₅, R₆, R₇, R₈ and R₉ are each independently OR₁₂, SR₁₃, NR₁₄R₁s —(C₁-C₆alkyl)-NR₁₄R₁₅, —O—(C₁-C₆alkyl)NR₁₄R₁₅, —C(O)R₁₁ or halogen; or are phenyl unsubstituted or substituted by C₁-C₄alkyl or/and by C₁-C₄alkoxy, the substituents OR₁₂, SR₁₃ and NR₁₄R₁₅ being capable, by way of the radicals R₁₂, R₁₃, R₁₄ and/or R₁₅ together with further substituents on the phenyl ring or together with one of the carbon atoms of the phenyl ring, of forming 5- or 6-membered rings;

with the proviso that in formula (Ic) at least one of the radicals R₂, R₃, R₄, R₅, R₆, R₇, R₈ and R₉ is A—X— or A₁—X₁—;

wherein in formula Id

R₂, R₃, R₄ and R₅ are each independently of the others hydrogen; A-X—, A₁—X₁—; C₁-C₁₂alkyl unsubstituted or substituted by OH, C₁-C₄alkoxy, phenyl, naphthyl, halogen, CN, —C(O)R₁₁ and/or by —O(CO)R₁₁; or C₂-C₁₂alkyl interrupted by one or more nonconsecutive oxygen atoms; or R₂, R₃, R₄ and R₅ are OR₁₂, SR₁₃, NR₁₄R₁₅, —(C₁-C₆alkyl)-NR₁₄R₁₅ or/and —O—(C₁-C₆alkyl)-NR₁₄R₁₅, —C(O)R₁₁ or halogen; o'r are phenyl unsubstituted or substituted by C₁-C₄alkyl or/and by C₁-C₄alkoxy, the substituents OR₁₂, SR₁₃ and NR₁₄R₁₅ being capable, by way of the radicals R₁₂, R₁₃, R₁₄ and/or R₁₅ together with further substituents on the phenyl ring or together with one of the carbon atoms of the phenyl ring, of forming 5- or 6membered rings;

with the proviso that in formula (Id) at least one of the radicals R₂, R₃, R₄ and R₅ is A-X— or A₁—X₁—;

R₁₀ is C₁-C₈alkyl, or phenyl unsubstituted or substituted by A-X—, C₁-C₄alkyl and/or by C₁-C₄alkoxy;

R₁₁ is C₁-C₈alkyl, or phenyl unsubstituted or substituted by C₁-C₄alkyl and/or by C₁-C₄alkoxy;

R₁₂ and R₁₃ are each independently of the other hydrogen; or O₁—C₁₋₂alkyl unsubstituted or substituted by OH, C₁-C₄alkoxy, phenyl, phenoxy or/and by —O(CO)R₁; or R₁₂ and R₁₃ are C₂-C₁₂alkyl interrupted by one or more non-consecutive oxygen atoms; or R₁₂ and R₁₃ are phenyl, C₃-C₆alkenyl, cyclopentyl, cyclohexyl or naphthyl, those radicals being unsubstituted or substituted by C₁-C₄alkoxy, phenyl or/and by C₁-C₄alkyl;

R₁₄ and R₁₅ are each independently of the other hydrogen; C₁-C₁₂alkyl unsubstituted or substituted by OH, C₁-C₄alkoxy or/and by phenyl; or C₂-C₁₂alkyl interrupted by one or more non-consecutive oxygen atoms; or R₁₄ and R₁₅ are phenyl, —(CO)R₁₁ or SO₂R₁₈; or R₁₄ and R₁₅, together with the nitrogen atom to which they are bonded, form a 5-, 6- or 7-membered ring that is optionally interrupted by —O— or by —NR₁₇—;

R₁₆ is C₁-C₁₂alkyl, unsubstituted phenyl or phenyl substituted by C₁-C₄alkyl;

R₁₇ is hydrogen, C₁-C₄alkyl unsubstituted or substituted by OH or by C₁-C₄alkoxy; or phenyl unsubstituted or substituted by OH, C₁-C₄alkyl or by C₁-C₄alkoxy;

A and A₁ are each independently of the other a surface-active radical of formula III

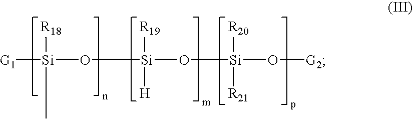

wherein the units IIIa1, IIIa2, IIIa3, IIIa4, IIIb and/or IIIc

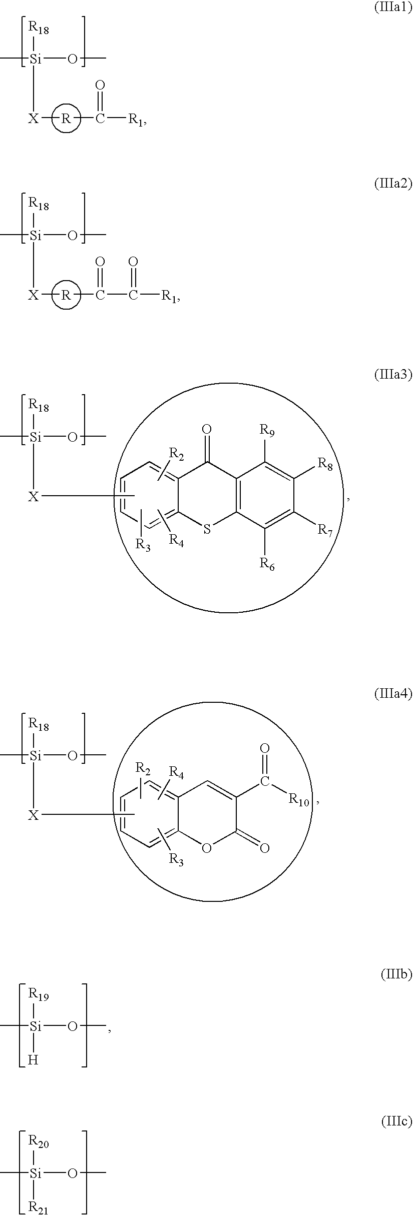

are distributed randomly or in blocks, and in which formulae the circle is intended to denote that an aromatic radical of formula Ia, Ib, Ic or Id as defined above is substituted by the appropriate silyl radical by way of the bridge X; or

A and A, are each independently of the other a surface-active radical Ao;

n is a number from 1 to 1000 or, when the siloxane starting material is a mixture of oligomeric siloxanes, n can also be less than 1 but great r than 0;

m is a number from 0 to 100;

p is a number from 0 to 10 000;

A₀ is C₈-C₃₀alkyl, C₆-C₃₀alkenyl, C₆C₃₀alkynyl, C₆-C₃₀aralkyl, C₆C₃₀alkyl-(CO)—, C₆C₃₀alkenyl-(CO)—, C₆-C₃₀alkynyl-(CO)—, C₈-C₃₀aralkyl-(CO)—, C₆-C₃₀alkyl-Si(R₁₈)(R₁₉)—, C₆C₃₀alkenyl-Si(R₁₈)(R₁₉)— or C₆-C₃₀alkynyl-Si(R₁₁)(R₁₉)—, each of which being unsubstituted or substituted by OH, C₁-C₄alkoxy, phenyl, naphthyi, halogen, CN, SR₁₃, NR₁₄R₁₅ and/or by —O(CO)R₁₁ and optionally being interrupted by one or more —O—, —S— or —NR₁₇—;

G₁ is C₁-C₁₈alkyl or a radical of formula

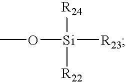

G₂ is C₁-C₁₈alkyl or a radical of formula

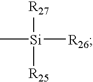

or

G₁ and G₂ together are a single bond;

R₁₈, R₁₉, R₂₀, R₂₂, R₂₃, R₂₄, R₂₅, R₂₆ and R₂₇ are each independently of the others C₁-C₁₈alkyl, phenyl, C₂-C₆hydroxyalkyl, C₂-C₆aminoalkyl or C₂-C₈cycloalkyl;

R₂₁ is unsubstituted C₁-C₁₈alkyl or C₁-C₁₈alkyl substituted by hydroxy, C₁-C₁₂alkoxy, halogen, C₃-C₈cycloalkyl and/or by N(R₁₄)(R₁₅); or R₂₁ is unsubstituted phenyl or phenyl substituted by Cl-C₁₋₂alkyl, C₁-C₁₂alkoxy, halogen, hydroxy and/or by N(R₁₄)(R₁₅); or R₂₁ is C₅-C₈cycloalkyl;

X and X₁, when A or A₁ is a radical of formula III, are each independently of the other a single bond,

-U-C₁-C₁₀alkylene, -U-C₃-C₁₂cycloalkylene, -U-C₆-C₁₂bicycloalkylene,

-U-C₁-C₁₀alkylene interrupted by one or more non-consecutive C₃-C₁₂cycloalkylene,

-U-COC₁₋₂cycloalkylene, C₆-C₁₂bicycloalkylene or -U-C₀-C₁₂bicycloalkylene, -U-C₆-C₁₀alkylene interrupted by one or more non-consecutive O and C₃WO

C₁₋₂cycloalkylene, -U-C₃-C₁₂cycloalkylene, C₆-C₁₂bicycloalkylene and/or -U-C₆-C₁₂bicycloalkylene,

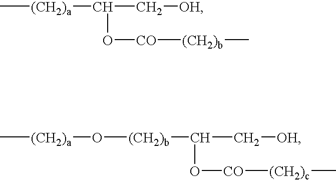

(CH₂)ₐ—O(CH₂)_{b}CH(OH)CH₂OCO(CH₂)_{b}

C₂-C₁₀alkenylene, C₂-C₁₀alkynylene, (CH₂)ₐ-O— —O—(CH₂)_{b}—, —O—(CH₂)_{b}—O—,

—(CH₂)ₐ—O—(CH₂)_{b}—, —O—(CH₂)ₐ—O—(CH₂)_{b}—, (CH₂)ₐ—O—(CH₂)_{b}—O—(CH₂)ₐ—NR₁₇—CH₂)_{b}—,

—(CH₂)ₐ—NR₁₇—, —(CH₂)ₐ—O—(CH₂)_{b}—NR₁₇—(CH₂)_{c}—,

—(CH₂)ₐ—O—(CH₂)_{b}—NR₁₇—, —(C₂-C₁₀alkenylene)-O—(CH₂)ₐ—, —(C₂-C₁₀alkenylene)-O—,

—(C₂-C₁₀alkynylene)-O—(CH₂)ₐ, —(C₂-C₁₀alkynylene)-O—,

—(C₂-C₁₀alkenylene)-O—(CH₂)ₐ—O—, —(C₂-C₁₀alkynylene)-O(CH₂)C—O—,

—(C₂-C₁₀alkenylene)-NR₁₇—, —(C₂-C₁₀alkynylene)-NR₁₇—,

—(C₂-C₁₀alkenylene)-NR₁₇—(CH₂)ₐ—, —(C₂-C₁₀alkynylene)-NR₁₇—(CH₂)ₙ—

—(C₂-C₁₀alkenylene)-O—(CH₂)ₐ—NR₁₇— or —(C₂-C₁₀alkynylene)-O—(CH₂)ₐ—NR₁₇—;

and

X and XI, when A or A₁ denotes Aₒ, are each independently of the other a single bond,

—O—, —S— or —NR₁₇—;

-U- is —COO—, —(CH₂)ₐ—COO—Si— or (CH₂)ₐ—Si—;

a, b and c are each independently of the others a number from 0 to 10; with the proviso, however, that they are at least 1 when the methylene group in question is positioned between two oxygen atoms or between an oxygen atom and a nitrogen atom.

Some of the compounds of formulae Ia, Ib, Ic and Id are novel and this invention relates also to those compounds.

It is advantageous (but not essential) to use the compounds of formulae Ia, Ib, Ic and Id in combination with amines.

C₁-C₁₈Alkyl is linear or branched and is, for example, C₁-C₁₂—, C₁-C₈-, C₁-C₆- or C₀-C₄-alkyl, Examples include methyl, ethyl, propyl, isopropyl, n-butyl, sec-butyl, isobutyl, tert-butyl, pentyl, hexyl, heptyl, 2,4,4trimethylpentyl, 2-ethylhexyl, octyl, nonyl, decyl, undecyl, dodecyl, tetradecyl, pentadecyl, hexadecyl, heptadecyl and octadecyl. C₁-C₁₂alkyl, C₁-C₈alkyl and C₁-C₄alkyl have the same meanings as given above up to the corresponding number of carbon atoms.

C₆-C₃₀Alkyl is likewise linear or branched and is, for example: C₆-C₂₄-, C₆-C₁₂-, C₁₀-C₃₀, C₁₀-C₂₄— or C₁₂—C₃₀-alkyl. Examples include hexyl, heptyl, 2,4,4trimethylpentyl, 2-ethylhexyl, octyl, nonyl, decyl, undecyl, dodecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl and triacontyl.

C₂-C₁₂Alkyl interrupted by one or more oxygen atoms is interrupted, for example, from 1 to 9 times, e.g. from 1 to 7 times or once or twice, by —O—. When the radicals are interrupted by a plurality of oxygen atoms, the oxygen atoms are in each case separated from one another by at least one methylene group resulting, for example, in structural units such as —CH₂—O—CH₃, —CH₂CH₂—O—CH₂CH₃, —[CH?CH₂O]_{y}—CH₃, in which y=from 1 to 9, —(CH₂CH₂O)₇CH₂CH₃, —CH₂—CH(CH₃)—O—CH₂—CH₂CH₃ or —CH₂—CH(CH₃)—O—CH₂CH₃.

C₂-C₆Hydroxyalkyl is C₂-C₆alkyl substituted by OH. The alkyl radical is linear or branched and can have the meanings given hereinabove (up to the corresponding number of carbon atoms).

C₂-C₆Aminoalkyl is C₂-C₆alkyl substituted by NH₂. The alkyl radical is linear or branched and can have the meanings given above (up to the corresponding number of carbon atoms). —(C₁-C₆Alkyl)-NR₁₄R₁₅ denotes C₁-C₆alkyl substituted by the radical NR₁₄R₁r. —O—(C₁-C₀Alkyl)-NR₁₄R₁₅ denotes C₀-C₆alkoxy substituted by the radical NR₁₄R₁₅. Definitions for the corresponding alkyl and alkoxy radicals are given hereinabove and hereinbelow.

C₁-C₁₂Alkoxy denotes linear or branched radicals and is, for example, C₁-C₁₀-, C₁-C₈—, C₁-C₆- or C₁-C₄-alkoxy. Examples include methoxy, ethoxy, propoxy, isopropoxy, n-butyloxy, secbutyloxy, isobutyloxy, tert-butyloxy, pentyloxy, hexyloxy, heptyloxy, 2,4,4-trimethylpentyloxy, 2-ethylhexyloxy, octyloxy, nonyloxy, decyloxy and dodecyloxy, especially methoxy, ethoxy, propoxy, isopropoxy, n-butyloxy, sec-butyloxy, isobutyloxy, tert-butyloxy, preferably methoxy. C₁-C₄Alkoxy is likewise linear or branched and has, for example, the meanings given hereinabove up to the corresponding number of carbon atoms.

C₃-C₈Cycloalkyl is linear or branched alkyl that contains at least one ring, for example cyclopropyl, cyclopentyl, methylcyclopentyl, cyclohexyl, methyl- or dimethyl-cyclohexyl, or cyclooctyl, especially cyclopentyl or cyclohexyl.

C₅-C₈Oycloalkyl has the meanings given hereinabove up to the corresponding number of carbon atoms.

C₃-C₆Alkenyl may be mono- or poly-unsaturated and also linear or branched and is, for example, C₃—O₄alkenyl. Examples include allyl, methallyl, 1,1-dimethylallyl, 1-butenyl, 2-butenyl, 1,3-pentadienyl and 1-hexenyl, especially alkyl.

C₆-C₃₀ Alkenyl is likewise linear or branched and mono- or poly-unsaturated and is, for example: C₆-C₂₄-, C₆-C₁₂-, C₁₀-C₃₀-, C₁₀-C₂₄ or C₁₂-C₃₀-alkenyl. Examples include hexenyl, heptenyl, 2,4,4-trimethylpentenyl, 2-ethylhexenyl, octenyl, nonenyl, decenyl, undecenyl, dodecenyl, tetradecenyl, pentadecenyl, hexadecenyl, heptadecenyl, octadecenyl, nonadecenyl, icosenyl, henicosenyl, docosenyl, tricosenyl, tetracosenyl, pentacosenyl, hexacosenyl, heptacosenyl, octacosenyl and triacontenyl.

C₆-C₃₀Alkynyl is linear or branched and mono- or poly-unsaturated and is, for example: C₆-C₂₄-, C₆-C₁₂-, C₁₀-C₃₀-, C₁₀-C₂₄ or C₁₂—C₃₀-alkynyl. Examples include hexynyl, heptynyl, 2,4,4-trimethylpentynyl, 2-ethylhexynyl, octynyl, nonynyl, decynyl, undecynyl, dodecynyl, tetradecynyl, pentadecynyl, hexadecynyl, heptadecynyl, octadecynyl, nonadecynyl, icosynyl, henicosynyl, docosynyl, tricosynyl, tetracosynyl, pentacosynyl, hexacosynyl, heptacosynyl, octacosynyl andtriacontynyl.

Alkylene and cycloalkylene groups are divalent forms of alkyl and cycloalkyl group as defined above.

C₆-C₁₂Bicycloalkylene is preferably bicycloheptylene, bicyclooctylene.

C₆-C₃₀Aralkyl is alkyl substituted by an aromatic radical: Examples include phenyl-C₁-C₂₄alkyl, naphthyl-C₁-C₂₀alkyl, anthryl-C₁-C₁₆alkyl and phenanthryl-C₁-C₁₆alkyl, the alkyl radicals C₁-C₂₄-, C₁-C₂₀— and C₁-C₁₆- in question being substituted by the respective aromatic radical phenyl, naphthyl, anthryl or phenanthryl. The alkyl radicals are linear or branched and may have the meanings given above. Examples include benzyl, phenylethyl, α-methylbenzyl, phenylpentyl, phenylhexyl and α,α-dimethylbenzyl, especially benzyl, naphthylmethyl, naphthylethyl, naphthylpropyl and naphthyl-1-methylethyl, more especially naphthylmethyl. The alkyl unit may be in either the 1- or the 2-position of the haphthyl ring.

Halogen is fluorine, chlorine, bromine or iodine, especially chlorine or bromine, preferably fluorine.

Substituted phenyl is mono- to penta-substituted, for example mono-, di- or tri-substituted, especially mono- or di-substituted, on the phenyl ring.

A heterocyclic radical is to be understood in this context as meaning either an aliphatic or aromatic ring containing one or more, especially one or two, hetero atoms. It may also be a fused ring system. There come into consideration as the hetero atoms, for example, especially O, N and S. Examples include furyl, thienyl, pyrrolyl, oxinyl, dioxinyl and pyridyl. 5 or 6-membered rings are preferred.

R and R₁ denoting heterocyclic radicals are, for example, pyrrolyl, pyrrolidinyl, oxazolyl, pyridyl, 1,3-diazinyl, 1,2-diazinyl, piperidyl, morpholinyl, thianthrenyl, furanyl, pyranyl, xanthenyl, imidazolyl, thiazoylyl, pyrimidinyl, indazolinyl, indolyl, indazolyl, purinyl, isoquinolyl, quinolyl, xanthyl, thioxanthyl, acridinyl etc.

When OR₁₂—, SR₁₃— or NR₁₄R₁₅-substituted naphthyl, anthracyl, phenanthryl or heterocyclic rings, together with the radicals R₁₂, R₁₃, R₁₄ or/and R₁₅, form 5- or 6-membered rings, then, for example, the following structures are included

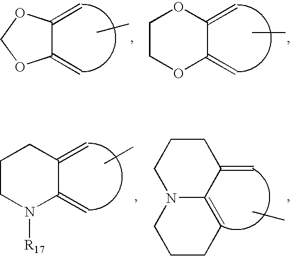

the arc and the two double bonds in each case representing the aromatic ring system.

When R₂, R₃, R₄, R₅, R₆, R₇, R₈ or R₉ denoting OR₁₂, SR₁₃ or NR₁₄R₁₅, together with further substituents on the phenyl ring or together with a carbon atom of the phenyl ring, form a 5or 6-membered ring, then, for example, the following systems are included

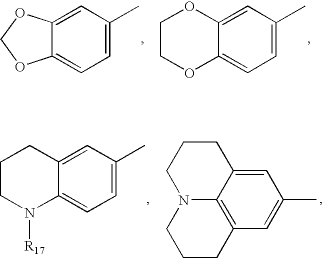

When R₁₄ and R₁₅, together with the nitrogen atom to which they are bonded, form a 5- or 6membered ring that in addition may be interrupted by —O— or by —NR₁₇—, the ring is, for example, a saturated or unsaturated ring, for example aziridine, piperazine, pyrrole, pyrrolidine, oxazole, pyridine, 1,3-diazine, 1,2-diazine, piperidine or morpholine; morpholinyl, piperidyl or piperazinyl rings, especially, are formed.

The units of formulae IIIa, IIIb and/or IIIc are arranged randomly or in blocks, that is to say the sequence of the units in the representation of formula III is as desired. For example, blocks of units of formulae IIIa1, IIIa2, IIIa3, IIIa4, IIIb, IIIc can appear in succession, but it is also possible for the individual units to be linked in random distribution, depending on the siloxane used in the preparation process.

X and X₁ denoting C₁-C₁₀alkylene are each linear or branched alkylene, for example C₁-C₈-, C₁-C₆-, C₁-C₄, C₂-C₈- or C₂-C₄-alkylene, for example methylene, ethylene, propylene, isopropylene, n-butylene, sec-butylene, isobutylene, tert-butylene, pentylene, hexylene, heptylene, octylene, nonylene or decylene. X and X₁ are especially C₁-C₈alkylene, e.g. ethylene, octylene,

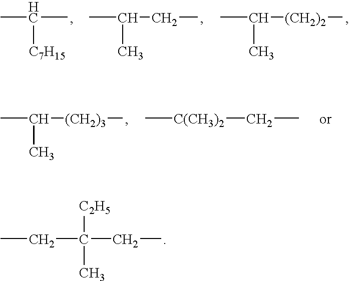

X and X₁denoting C₃-C₁₋₂cycloalkylene are each linear or branched alkylene groups containing at least one ring, for example cyclopropylene, cyclobutylene, cyclopentylene, cyclohexylene etc.

X and X¹ denoting C₈-C₁₂bicycloalkylene are each linear or branched groups containing at least one bicyclic ring, like for example bicycloheptylene, bicyclooctylene.

C₂-C₁₀alkenylene is mono- or poly-unsaturated, linear or branched, and is, for example, C₂-C₈-, C₄-C₈-, C₃-C₆— or C₂-C₄-alkenylene, e.g. ethenylene, 1-propenylene, 1-butenylene, 3-butenylene, 2-butenylene, 1,3-pentadienylene, 5-hexenylene or 7-octenylene. C₄-C₈Alkenylene has the same meanings as those given above, according to the number of carbon atoms.

C₂C₁₀Alkynylene is mono- or poly-unsaturated, linear or branched and is, for example, C₂-C₈-, C₃-C₈- or C₂-C₄-alkynylene. Examples include hexynylene, heptynylene, 2,4,4-trimethylpentynylene, 2-ethylhexynylene, octynylene, nonynylene and decynylene.

The expression “and/or” is intended to indicate that not only one of the defined alternatives (substituents) may be present, but equally a plurality of various of the defined alternatives (substituents) may be present simultaneously, that is to say mixtures of different alternatives (substituents).

The expression ‘at least’ is intended to define one or more than one, for example one, two or three, preferably one or two.

In the description and in the patent claims, unless expressly indicated otherwise the word “comprising” is to be understood as meaning that a defined entity or a defined group of entities are included, without, however, any other substances that have not been specifically mentioned being excluded.

“a”, “b' and “c” are preferably a number from 0 to 10, e.g. from 0 to 3, especially 3, but with the proviso that a, b, and/or c are at least 1 when the methylene group in question is positioned between two oxygen atoms or between an oxygen atom and a nitrogen atom; “n” is preferably from 1 to 100; “p” is, for example, from 1 to 1000, from 1 to 100, from 1 to 50 or from 1 to 25; and “m” is from 0 to 100, for example from 0 to 50 or from 0 to 25, especially 0.

When the siloxane starting material is a mixture of oligomeric siloxanes, “n” can also be less than 1 but greater than 0. It is in that case, for example, a number from 0.1 to 1000, from 0.5 to 1000, from 0.8 to 1000 etc.

A and A₁ are preferably a radical of formula III. In the compounds of formulae Ia and IIb, R and R₁ are especially a radical of formula II or are naphthyl; a radical of formula II is preferred.

In the compounds of formula Ic, R₂, R₃, R₄, R₅, R₆, R₇, R and Ra are especially a radical A-X— or A₁—X₁—. In the compounds of formula Id, R₂, R₃, R₄ and R₅ are especially a radical A-X— or A₁—X₁—. In the compounds of formulae Ia and Ib, when R and/or R₁ denote(s) a radical of formula 11, at least one of the substituents R₂, R₃, R₄, R₅ and l is a group —X-A or —X₁-A₁. Thus, for example, from 1 to 3 or 1 or 2 or one of the substituents R₂, R₃, R₄, R₅ and R₆ is/are a group —X-A or —X₁-A₁. Preferably, 1 or 2 of the radicals R₂, R₅, R₄, R₅ and R₆ is/are —X-A or —X₁-A₁. R₂, R₆ or/and R₄ is/are especially a group —X-A or —X₁-A₁. Preferably, R₄ or/and R₆ is/are a group —X-A or —X₁-A₁.

In the compounds of formula Ic, at least one of the substituents R₂, R₃, R₄, R₅, R, R₇, R₈ and R₉ is a group —X-A or —X₁-A₁. Thus, for example, from 1 to 3 or 1 or 2 or one of the substituents R₂, R₃, R₄, R₅, R₆, R₇, R₈ and R₉ is/are a group —X-A or —X₁-A₁. Preferably, 1 or 2 of the radicals R₂, R₃, R₄, R₅, R₆, R₇, R₈ and R₉ is/are —X-A or —X₁-A₁. Especially, R₂, R₅, R₆, R₉, R₄ or/and R₇ is/are a group —X-A or —X₁-A₁. Preferably, R₄ or/and R₇ is/are a group —X-A or —X₁-A₁.

In the compounds of formula Id, at least one of the substituents R₂, R₃′, R₄ and R₅ is a group —X-A or —X₁-A₁ or the substituent R₁₀ contains a group A-X—. Thus, for example, from 1 to 3 or 1 or 2 or one of the substituents R₂, R₃, R₄ and Rr is/are a group —X-A or —X₁-A₁. Preferably, 1 or 2 of the radicals R₂, R₃, R₄ and Rr is/are —X-A or —X₁-A₁, or the substituent R₁₀ contains a group A-X—. Preferably, R₄ is a group —X-A or —X₁-A₁ or the substituent R₁₀ contains a group A-X—.

In formula (Ic), R₂, R₃, R₄, R₅, R₆, R₇, R₈ and R₉, besides being a group —X-A or —X₁-A₁, are especially hydrogen, C₁-C₄alkyl or C₁-C₄alkoxy, preferably hydrogen.

In formula (Id), R₂, R₃, R₄ and R₅, besides being a group —X-A or —X₁-A₁, are especially hydrogen, C₁-C₄alkyl or C₁-C₄alkoxy, preferably hydrogen.

R₁₀ is especially phenyl substituted by A-X—.

R₁₁ is especially C₁-C₄alkyl or phenyl.

R₁₂ and R₁₃ are especially C₁-C₄alkyl, hydrogen, phenyl, or C₂-C₈alkyl interrupted by oxygen, preferably C₁-C₄alkyl or hydrogen.

R₁₄ and R₁₅ are especially C₁-C₄alkyl, preferably methyl, or, together with the nitrogen atom to which they are bonded, form a morpholinyl radical.

R₁₆ is especially C₁-C₄alkyl, unsubstituted phenyl or phenyl substituted by C₁-C₄alkyl.

R₁₇ is preferably hydrogen, C₁-C₄alkyl, or C₁-C₄alkyl substituted by OH.

R₁₈, R₁₉ and R₂₀ are preferably C₁-C₄alkyl, especially methyl.

R₂₁ is especially C₁-C₄alkyl, e.g. methyl.

A₀ is especially a C₆-C₃₀alkyl radical, that radical being unsubstituted or substituted by halogen. Preferably, C₆-C₃₀alkyl is unsubstituted or substituted by halogen, preferably fluorine. When the radical C₆-C₃₀alkyl is substituted by fluorine, it is preferably perfluorinated.

X and X₁ are preferably C₃-C₆alkylene, —(CH₂)ₐ-O—, —O—(CH₂).—O—(CH₂)_{b} or —(CH₂)ₐ, —(CH₂)_{b}—O—, especially —(CH₂)a-O—, —O—(CH₂)ₐ—O—(CH₂)_{b} or —(CH₂)ₐ—O—(CH₂)_{b}—O—, a being especially 2 or 3 and b being especially 2 or 3.

The compounds of formulae Ia, Ib, Ic and Id are prepared according to conventional methods known to the person skilled in the art.

I. When A or A₁ is a radical of formula III, the compounds of formulae Ia, Ib, Ic and Id can be obtained, for example, by reaction of a photoinitiator having (at least) one alkenyl radical (IV), (IVa), (IVb), (IVc), (IVd), (IVe), (IVf), (IVg), (IVh) and (IVi) with a siloxane (V) in the presence of a suitable catalyst:

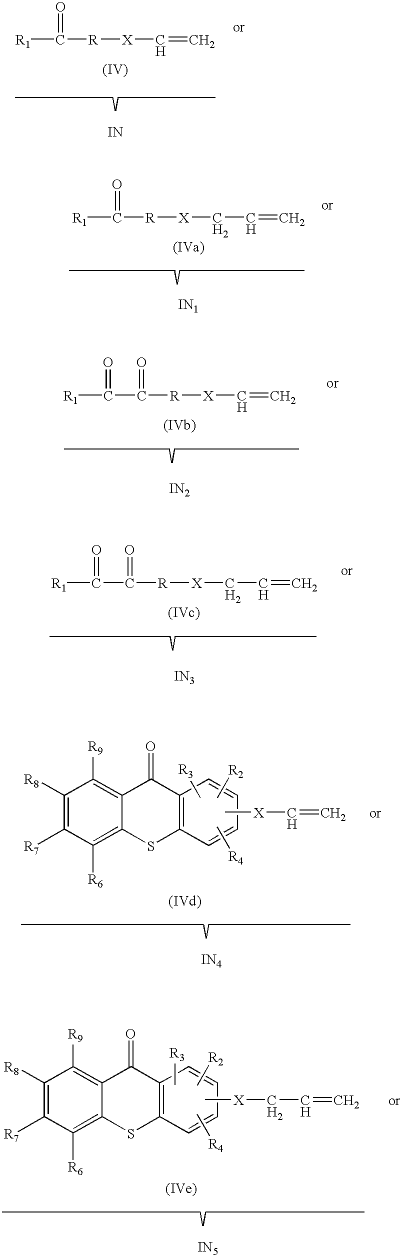

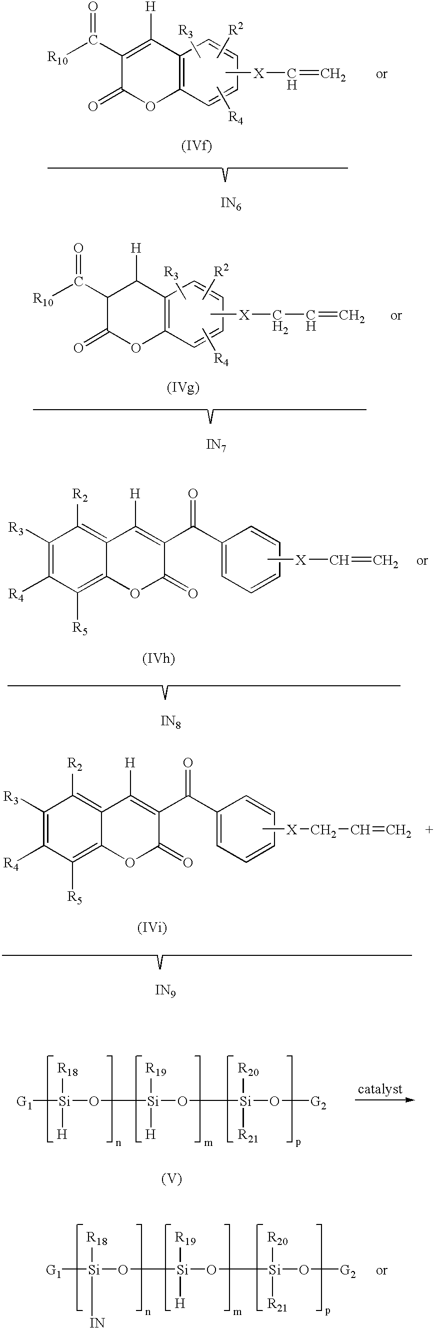

the corresponding structures containing IN₁, IN₂, IN₃, IN₄, IN₅, IN₆, IN₇, IN₈ or IN₉.

IN, IN₁, IN₂, IN₃, IN₄, IN₅, IN₆, IN₇, IN₈ and IN₉ denote the radicals indicated above, respectively, but in the reaction the double bonds each become single bonds and the CH group becomes a CH₂ group, that is to say, in the product, —CH═CH— becomes —CH₂—CH₂ and —CH═CH₂—CH₂— becomes —(CH₂)₃—; R, R₁, R₂, R₃, R₄, R₅, R₆, R₇, R₈, R₉, R₁₀, R₁₈, R₁₉, R₂₀, R₂₁, X, G₁, G₂, n, m and p are as defined hereinbefore.

Conditions for such reactions are known to the person skilled in the art. The molar ratios of the alkenyl-modified compounds (IV), (IVa), (IVb), (IVc), (IVd), (IVe), (IVf), (IVg), (IVh) or (IVi) and the siloxane compounds (V) depend on the product desired and are generally not critical. For example the amount of (IV), (IVa), (IVb), (IVc), (IVd), (IVe), (IVf), (IVg), (IVh) or (IVi) to be used is selected in accordance with the content of free Si—H groups in (V) and the desired degree of substitution of those groups in the case in question. If all groups are to react, then, for example, advantageously (IV), (IVa), (IVb), (IVc), (IVd), (IVe), (IVf), (IVg), (IVh) or (IVi) should be added in excess. It is, however, also possible to use an excess of component (V).

The reaction temperatures are advantageously maintained in a range from 20 to 150° C., preferably from 60 to 110° C. It is furthermore advantageous to carry out the reaction, for example, in a suitable aprotic organic solvent, for example tetrahydrofuran (THF), dioxane, hexane, heptane, cyclohexane, toluene, xylene, benzene or chlorobenzene, but it is, for example, also possible to work without solvents.

The reaction mixture is usually stirred while the reaction is being carried out.

The reaction is furthermore advantageously carried out under inert conditions, for example under an argon or nitrogen atmosphere.

Catalysts suitable for the reaction procedure include, for example, noble metal catalysts, for example platinum or rhodium catalysts. Examples include H₂PtCl₆ and PtCl₂(C₆H₅—CH═ClH₂)₂. Such catalysts can be supported, for example, on suitable carrier materials, for example on aluminium oxide, such as Pt/Al₂O₃ (obtainable, for example, from Heraeus). There can be used as carrier material, for example, also carbon (PVC—but that catalyst does not have to be anhydrous—obtainable, for example, from Johnson Matthey). Examples of suitable catalysts include platinum, palladium, rhodium, nickel, cobalt and other metals, especially in powder form or in the form of complexes. Examples include platinum sponge, platinum black, chloroplatinic acid, the reaction product of chloroplatinic acid and alcohol, a complex of chloroplatinic acid and vinylsiloxane. Such catalysts are available commercially, e.g. platinum-carbonyl-cyclovinylmethylsiloxane complex, platinum-divinyltetramethyldisiloxane complex, platinum octane aldehyde/octanol complex, or can be obtained according to methods that are known to the person skilled in the art and are customary in the art.

The concentration of the catalyst is advantageously, for example, from 1 to 1000 ppm, e.g. from 150 to 400 ppm.

Such reactions are described, for example, In WO 97/49768 or in EP 088 842.

II. A further possible method of preparing the surface-active photoinitiators is the reaction of a photoinitiator containing an appropriate silyl group with an alkenyl-modified siloxane:

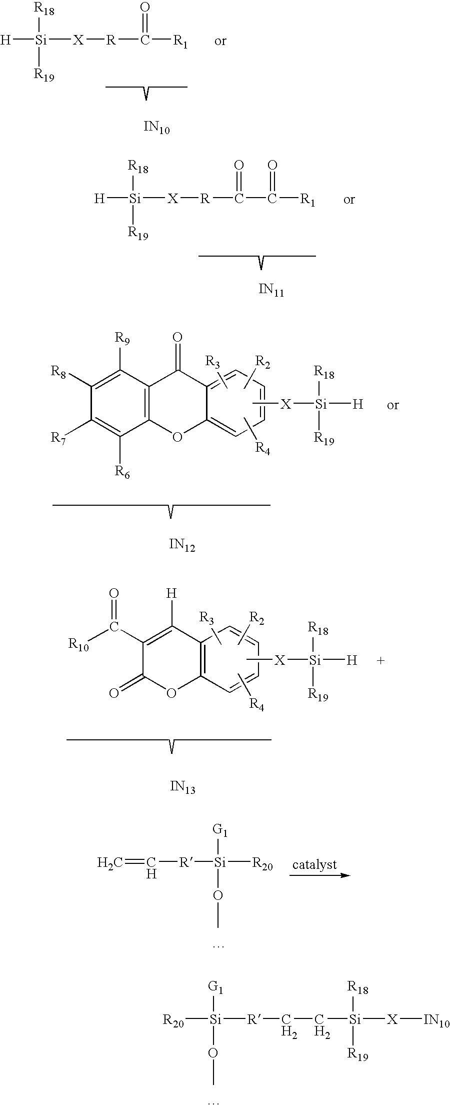

or the corresponding structures containing IN₁, IN₁₂ or IN₁₃.

X, R, R₁, R₂, R₁, Ra, R₅, R₆, R., R₈, R₉, R₁₀, R₁₈, R₁₉, R₂₀ and G₁ are as defined hereinabove;

R′ is an alkylene radical; “ . . . ” denotes that attached at that position is the radical of the siloxane molecule moiety defined in formula III (according to formula III, m must be 0 in the starting material in that reaction).

The double bound of the alkenyl-moiety of the siloxane can also be the double bound of a cycloakenyl rest or of a bycycloalkenyl rest.

The reaction conditions for that method correspond to those described hereinabove. In the literature, such reactions are described, for example, in U.S. Pat. No. 4,391,963 and JMS Pure Applied Chem. A31 (3) (1994), 305.

III. The surface-active photoinitiators can also be obtained, for example, by reaction of an OH-group-containing initiator with a siloxane:

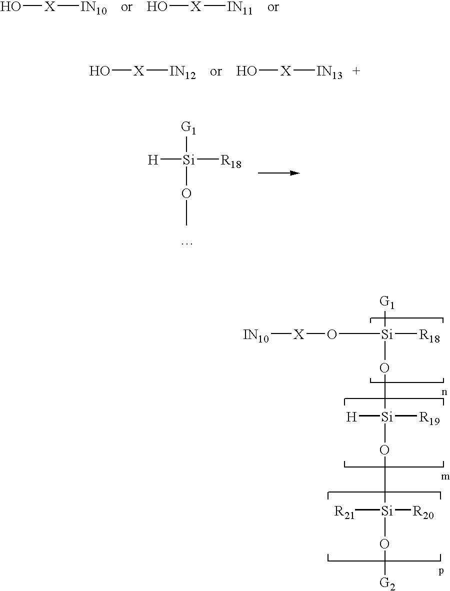

or the corresponding structures containing IN₁₁, IN₁₂ or IN₁₃.

IN₁₀, IN₁₁, IN₁₂, IN₁₃, X, R₁₈, R₁₉, R₂₀, G₁, n, m, p, R₂₁ and G₂ are as defined hereinabove;

“ . . . ” denotes that attached at that position is the radical of the siloxane molecule moiety defined in formula III.

Catalysts suitable for that reaction include, for example, tin octoate, dibutyltin dilaurate, tin octanoate and zinc octanoate. Examples of such reactions can be found in U.S. Pat. No. 4,921,589.

IV. In JMS Pure Appi. Chem. A 34(11) (1997), 2335-2363, L. Lecamp et al. describe a method for the preparation of siloxane-containing initiators in which an initiator containing an Si(OR″)₁₋₃ group is reacted with a siloxane containing an Si—(OH)₁₋₂ group. The catalyst used is, for example, dibutyltin dilaurate:

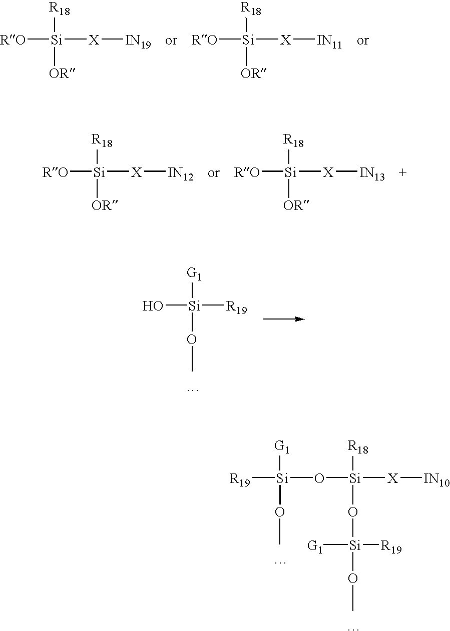

and the corresponding structures containing IN₁₁, IN₁₂ and IN₁₃.

IN₁₀, IN₁₁, IN₁₂, IN₁₃, X, R₁₈, R₁₉ and G₁ are as defined hereinabove; R″ is alkyl, especially methyl; “ . . . ” denotes that attached at that position is the radical of the siloxane molecule moiety defined in formula III.

V. Surface-active photoinitiators corresponding to the present invention can, for example, also be obtained by reaction of a photoinitiator containing at least one carbonyl group on the aromatic ring with a siloxane containing a C—C double bond as terminal group (e.g. allyl or vinyl):

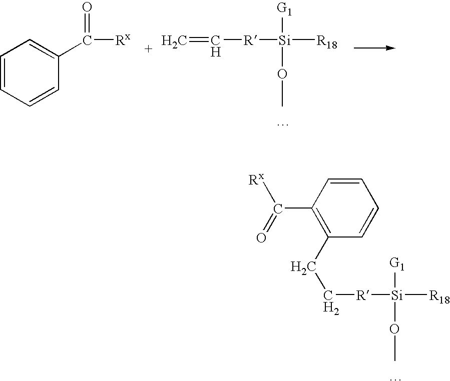

R₁₈ and G₁ are as defined hereinabove; in the examples of the literature references mentioned further below, R^{x} together with the adjacent carbonyl group form a benzoin, an α-hydroxyketone or an α-aminoketone; R′ is alkylene; “ . . . ” denotes that attached at that position is the radical of the siloxane molecule moiety defined in formula III. The reaction can be carried out with compounds of the type IN₁₄, IN₁₅, IN₁₆, and also with IN₁₇:

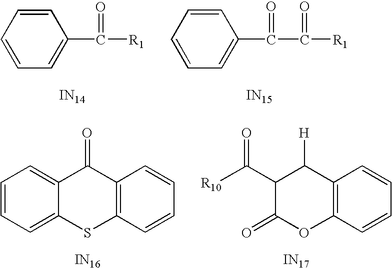

This reaction is published in U.S. Pat. No. 5,776,658. Catalysts suitable for the reaction include, for example, ruthenium compounds, as described by Murai et al. in Nature 366 (1993) 529.

VI. The polymerization or copolymerization of polyalkoxysiloxanes in the presence of a base or of an acid catalyst is described in U.S. Pat. No. 4,477,326 and JP 9-328522-A. The described method is also suitable for the preparation of surface-active photoinitiators according to the invention:

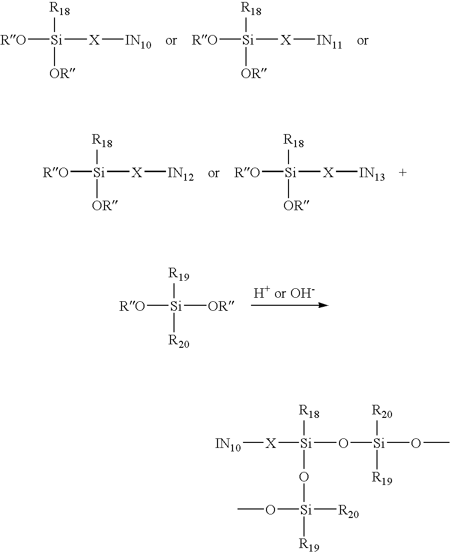

and the corresponding structures containing IN₁₁, IN₁₂ and IN₁₃.

IN₁₀, IN₁₁, IN₁₂, IN₁₃₁ X, R₁₈, R₁₉ and R₂₀ are as defined hereinabove; and R″ is alkyl.

Both polymeric and cyclic products can be obtained in such a reaction.

VII. A further method by which surface-active photoinitiators can be prepared is described, for example, in U.S. Pat. No. 4,587,276 and U.S. Pat. No. 4,477,276: the polymerization or copolymerization of siloxanes having hydrolysable groups (e.g. Si—Cl) in the presence of water:

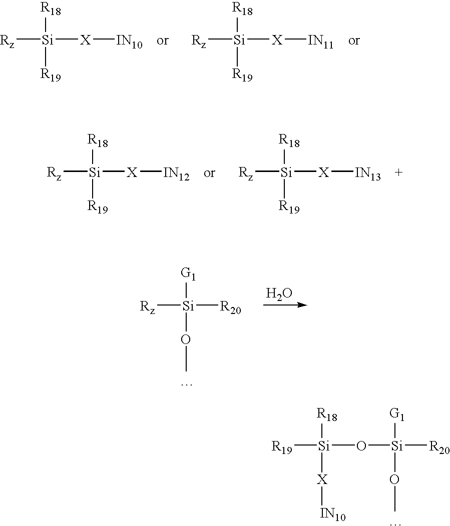

and the corresponding structures containing IN₁₁, IN₁₂ and IN₁₃. IN₁₀, IN₁₁, IN₁₂, IN₁₃, X, R₁₈, R₁₉, R₂₀ and G₁ are as defined hereinabove; R, is, for example, Cl or OCH₃; “ . . . ” denotes that attached at that position is the radical of the siloxane molecule moiety defined in formula III.

VII. In J.M.S. Pure Appl. Chem. A 31(3) (1994), 305-318, A. Kolar et al. describe the preparation of photoinitiators containing siloxane radicals using 1,4-dichlorobenzene as starting material. Grignard reaction is used to create a reactive centre that is reacted with dimethyldichlorosilane or dimethyl monochlorosilane to form the corresponding silyl-modified chlorobenzene on which the corresponding α-cleavable photoinitiator carbonyl radical is inserted by further reactions. Similarly, it is also possible for compounds of formula (Ia), (Ib), (Ic) or (Id) to be obtained by introducing the appropriate photoinitiator benzophenone radical, photoinitiator benzil radical, photoinitiator thioxanthone radical or photoinitiator coumarin radical.

IX. In Makromol. Chem. 193 (1992) 1273-1282, L. Pouliquen et al. published a multi-step reaction of photoinitiators containing acid groups with a siloxane containing epoxy radicals in the presence of acetic anhydride (the photoinitiator compounds in that reference are of the phenone/tert-amine type). That process can also be used, for example, for the preparation of the compounds according to the invention:

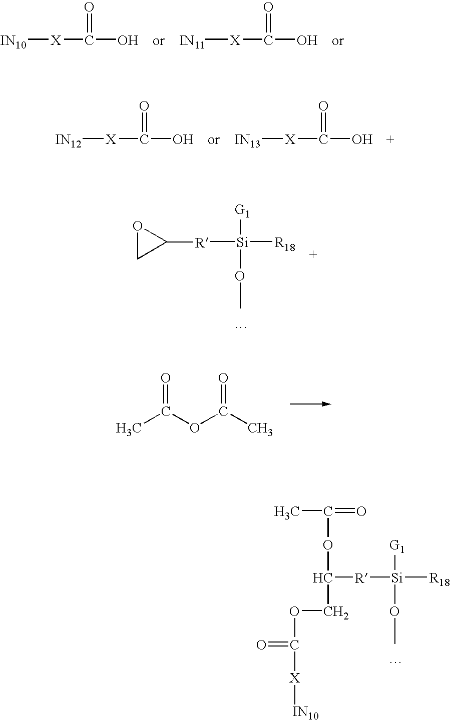

and the corresponding structures containing IN₁₁, IN₁₂ and IN₁₃.

Using adequate conditions, one can also add the photoinitiators containing the acid group to the siloxanes containing the epoxy radicals in the absence of acetic anhydride. IN₁₀, IN₁₁, IN₁₂, IN₁₃, X, G₁ and R₁₁ are as defined hereinabove; R′ is alkylene; n, “ . . . ” denotes that attached at that position is the radical of the siloxane molecule moiety defined in formula III.

Photoinitiators containing acid groups and siloxanes containing alkenyl, cycloalkenyl or bycycloalkenyl rest can be reacted to form surface active photoinitiators:

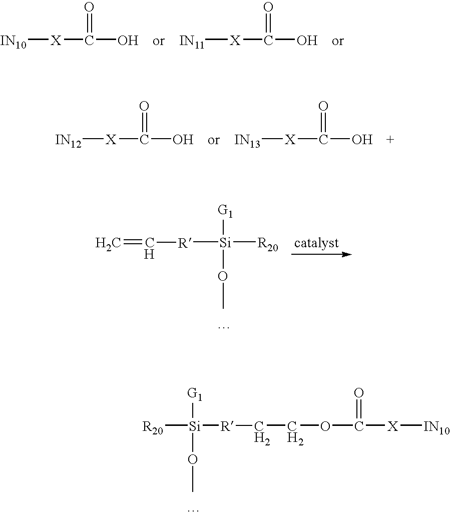

and the corresponding structures containing IN₁₁, IN₁₂ and IN₁₃.

The same reaction can be performed with siloxane derivatives containing cycloalkenyl or bycycloalkenyl rests.

IN₁₀, IN₁₁, IN₁₂, IN₁₃, X, G₁ and R₂₀ are as defined hereinabove; R′ is alkylene; “ . . . ” denotes that attached at that position is the radical of the siloxane molecule moiety defined in formula III.

X. Isocyanate-group-containing photoinitiators and siloxanes containing hydroxyl or amine groups can likewise be reacted to form surface-active photoinitiators:

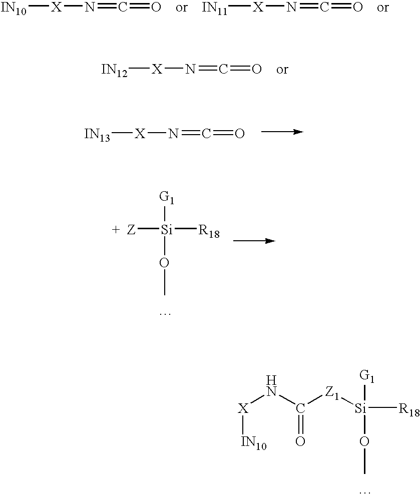

and the corresponding structures containing IN₁₁, IN₁₂ and IN₁₃.

IN₁₀, IN₁₁, IN₁₂, IN₁₃, X, G₁ and R₁₈ are as defined hereinabove; Z is NH₂ or OH; Z₁ is NH or O; “ . . . ” denotes that attached at that position is the radical of the siloxane molecule moiety defined in formula III.

Such reactions are described, for example, in WO 96/20919.

XI. Photoinitiators substituted by cyclic siloxane radicals can be obtained, for example, by carrying out the reactions described hereinabove under 1, with a cyclic siloxane, for example

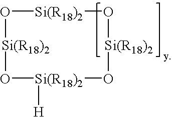

For the preparation of photoinitiators provided with cyclic siloxane radicals it is also possible, however, first of all to introduce linear siloxane radicals, for example using the methods described hereinabove, and then to bring about the cyclization thereof by the action of a base, for example sodium hydroxide, or by the action of an acid.

The surface-active photoinitiators containing cyclic siloxane radicals can be synthesised, for example, as described hereinabove by reaction of a cyclic siloxane with the initiator moiety in question:

IN; IN₁, IN₂, IN₃, IN₄, IN₅, IN₆, IN₇, IN₈, IN₉ (IV, IVa, IVb, IVc, IVd, IVe, IVf, IVg, IVh or IVi)

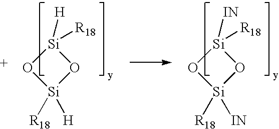

(IN, IN₁, IN₂, IN₃, IN₄, IN₅6,IN₆, IN₇, IN₈, IN₉ and R₁₈ are as defined hereinabove; y indicates the ring size; IN₁, IN₁, IN₂, IN₃, IN₄, IN₅, IN₆, IN₇, IN₈ and IN₉ being indicated in the above formula by IN only).

Also possible is a cyclization reaction of an OR″-group-containing siloxane-modified initiator moiety in the presence of acid or alkali:

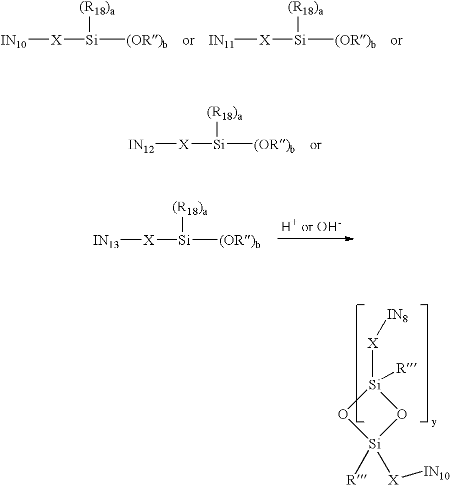

and the corresponding structures containing IN₁₁, IN₁₂ and IN₁₃. IN₁₀, IN₁₁, IN₁₂, IN₁₃, X and R₁₈ are as defined hereinabove; R″ is alkyl; a-0 or 1; b=2 or 3, wherein the sum of a and b is 3; depending on the definition of a and b, R′″ is either R₁₈ or OR″.

Cyclic compounds can furthermore be formed by reaction of an OR″-group-containing siloxane-modified initiator moiety with an OR″-group-containing siloxane:

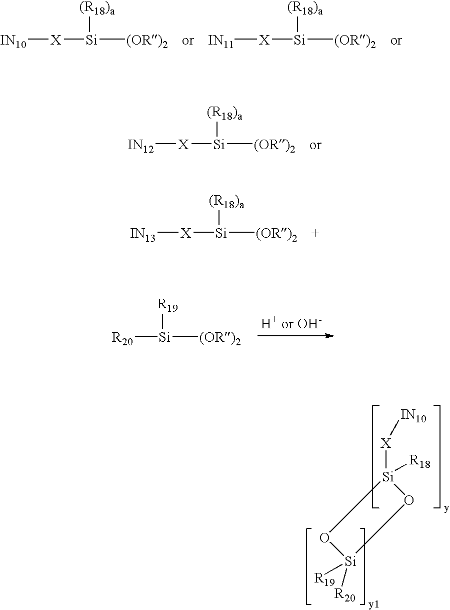

and the corresponding structures containing IN₁₁, IN₁₂ and IN₁₃.

(IN₁₀, IN₁₁, IN₁₂, IN₁₃, X, R₁₈, R₁₉ and R₂₀ are as defined hereinabove; R” Is alkyl; the sum of y and y1 determines the number or ring members)

The Si(IN₁₀)(R₁₈), SI(IN₁₁)(R₁₆), Si(IN₁₂)(R₁₈), Si(IN₁₃)(R₁₈) and Si(R₁₉)(R₂₀) groups are distributed randomly or in blocks.

Compounds of formulae Ia, Ib, Ic or Id having a plurality of different radicals —X-A or/and —X₁-A₁ can be obtained, for example, analogously to the above-described reactions I to XI, under similar conditions with the respective appropriately substituted photoinitiators.

In the preparation of siloxane-containing photoinitiators it is also possible for mixtures of active compounds to be formed. Such mixtures can be separated according to customary methods, for example distillation, crystallisation or chromatography, or can be used in that form as surface-active photoinitiators in compositions to be polymerized.

XII. Compounds of formulae Ia, Ib, Ic and Id wherein A or A₁ denotes A₀ can be obtained, for example, by Friedel-Crafts alkylation of a photoinitiator (VI), (VIa), (VIb) or (VIc) with an appropriate alkyl halide (VII) in the presence of a suitable catalyst:

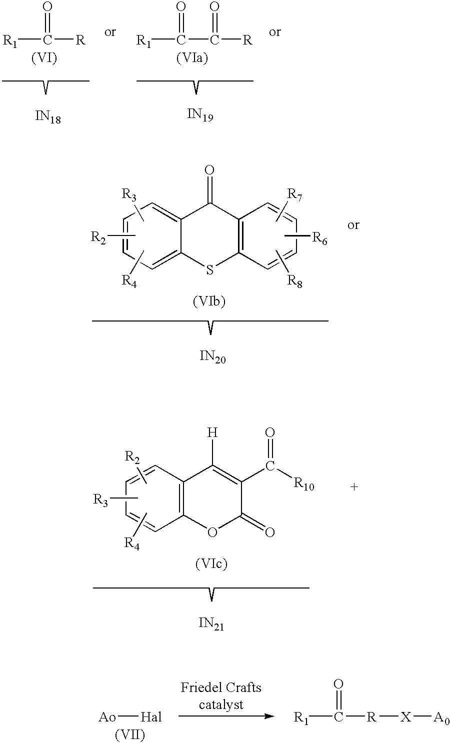

and the corresponding structures containing IN₁₉, IN₂₀ and IN₂₁,

wherein R, R₁, R₂, R₃, R₄, R₅, R₆, R₇, R₈, R₉, R₁₀ and Aₒ are as defined hereinabove; and X is a single bond.

The procedure for such reactions is known to the person skilled in the art and is described in detail in the literature (e.g. J. March, Advanced Organic Chemistry, 3^{rd} edition 1985, ch. 1-13, pages 479-484; or Olah, “Friedel-Crafts Chemistry”, Wiley NY 1973; and also Roberts and Khalaf, “Friedel-Crafts Alkylation Chemistry”, Marcel Dekker NY 1984).

XIII. Compounds of formulae Ia, Ib, Ic and Id in which A or A₁ denotes A₀ can also be obtained, for example, by Friedel-Crafts acylation of a photoinitiator (VI), (VIb), (VIc) or (VId) with an appropriate surface-active reagent (VIII) in the presence of a suitable catalyst:

IN₁₈(VI) or IN₁₉ (VIa) or IN₂₀ (VIb) or IN₂₁

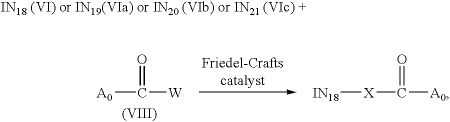

and the corresponding structures containing IN₁₉, IN₂₀ and IN₂₁. IN₁₈, IN₁₉, IN₂₀, Ip₂₁ and A₀ are as defined hereinabove; W is —OH or -Hal, -Hal being especially —Cl; and X is a single bond.

The procedure for such reactions is known to the person skilled in the art and is described in detail in the literature (e.g. J. March, Advanced Organic Chemistry, 3^{rd} edition 1985, ch. 1-15, pages 484-487; or Olah, “Friedel-Crafts and Related Reactions”, Interscience NY 1963-1964).

XIV. Compounds of formulae Ia, Ib, Ic and Id in which A or A₁ denotes A₀ can also be obtained by the customary reactions, known to the person skilled in the art, of ether formation or alkylation of a thiol group or of an amine group. For example, compounds of formulae Ia, Ib, Ic and Id can be prepared by reaction of a photoinitiator (IX), (IXa), (IXb) or (IXc) with an alkyl halide (VII) in the presence of a base:

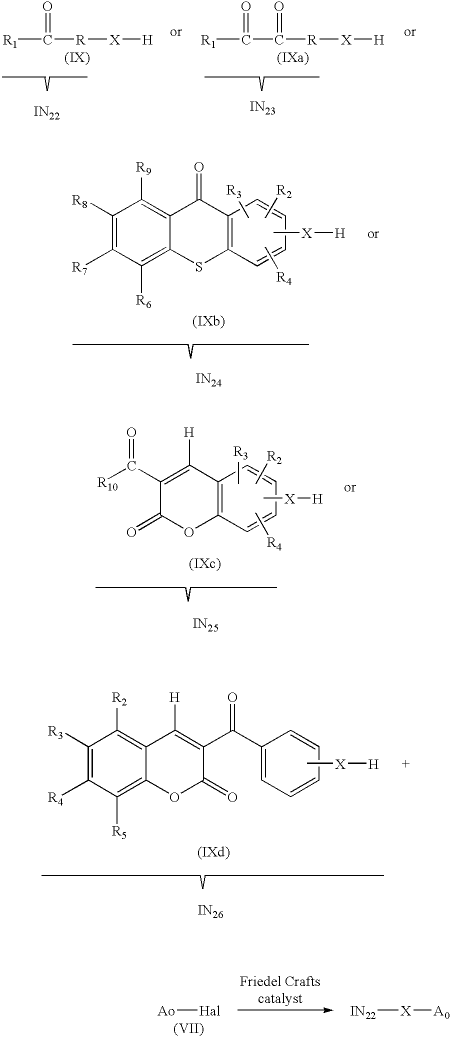

and the corresponding structures containing IN₂₃, IN₂₄, IN₂₅ and IN₂₆.

R, R₁, R₂, R₃, R₄, R₅, R₆, R₇, R₈, R₉, R₁₀ and A₀ are as defined hereinabove; and X is —O—, —S—or an —NR₁₇— group.

Such reactions are known to the person skilled in the art and are described in detail in the literature (e.g. J. March in Advanced Organic Chemistry, 3^{rd} edition 1985). When X is, for example, —O—, the reaction corresponds to a Williamson ether formation (J. March in Advanced Organic Chemistry, 3rd edition 1985, ch. 0-14, pages 342-343); when X is —S—, the reaction is as described, for example, in J. March in Advanced Organic Chemistry, 3^{rd} edition 1985, ch. 3-5, pages 589-590; when X is —NR₁₇—, the reaction corresponds to the alkylation of an amine (J. March in Advanced Organic Chemistry, 3^{rd} edition 1985, ch. 0-45, pages 364366).

XV. Compounds of formulae Ia, Ib, Ic and Id can also be obtained by acylation of appropriate photoinitiators wherein X is an —O—, —S— or —NR₁₇— group. The various possible conditions for such reactions are known to the person skilled in the art. For example, a compound Ia, Ib, Ic or Id can be reacted by acylation of a photoinitiator (IX) with an appropriate surface-active reagent (VII) that contains an acid group or an acid chloride group to form an ester, a thiol ester or an amide. Similar reactions can also be performed using photoinitiators (IXa), (IXb), (IXc) and (IXd) as starting materials. IN₂₂—X—H (IX) or IN₂₃—X—H (IXa) or IN₂₄—X—H (IXb) or IN₂₅—X—H (IXc) or IN₂₆—X—H (IXd)+

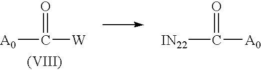

and the corresponding structures containing IN₂₃, IN₂₄, IN₂₅ and 1N₂₆. IN₂₂, IN_{23, 1}N₂₄ IN₂₅, IN₂₆ and A₀ are as defined hereinabove; X in this instance is —O—, —S— or —NR₁₇—; W is —OH or -halogen, -halogen being especially —Cl.

Such reactions are known to the person skilled in the art and are described in detail in the usual organic chemistry textbooks, for example in J. March in Advanced Organic Chemistry, 3^{rd} edition 1985.

XVI. Compounds of formulae Ia, Ib, Ic and Id can also be prepared by silylation of appropriate photoinitiators wherein X is an —O—, —S— or —NR₁₇— group. The various possible conditions for such reactions are known to the person skilled in the art. For example, compound Ia can be obtained by silylation of a photoinitiator (IX) with an appropriate surface-active reagent (X) that carries a silyl-active group, for example a group

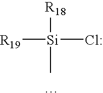

IN₂₂—X—H (IX) or IN₂₃—X—H (IXa) or IN₂₄—X—H (IXb) or IN₂₅—X—H (IXc) or IN₂₆—X—H (IXd)

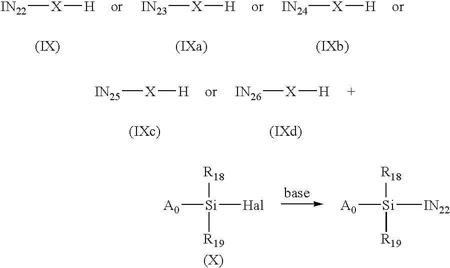

and the corresponding structures containing IN₂₃, IN₂₄, IN₂₅ and IN₂₆.

IN₂₂, IN₂₃, IN₂₄, IN₂₅, IN₂₆, R₁₈, R₁₉ and A₀ are as defined hereinabove; X in this instance is —O—, —S— or —NR₁₇—; and -Hal is a halogen atom, especially Cl.

Such reactions are described, for example, by Lalonde and Chan in Synthesis (1985), (9), 817-45.

The alkenyl-modified photoinitiators (IV), (IVa), (IVb), (IVc), (IVd), (IVe), (IVf), (IVg), (IVh) and (IVi) can be prepared according to methods known to the person skilled in the art, for example according to the method described in WO 97/49768 or in EP 088 842. Corresponding procedures are also published in Tetrahedron (1963) 1335, in Coll. Czechoslov. Chem. Commun. (1966) 31, 269.

The siloxane compounds (V) are in some cases available commercially, or they can be obtained according to methods known to the person skilled in the art. For example, methods of preparation and literature references for the preparation can be obtained from the catalogue of the company Geleste “ABCR Geleste 2000”, pages 434-447.

In the preparation of asymmetric compounds of formula Ia or Ib, that is to say compounds in which R and R₁ are not identical, for the reaction the appropriate different starting materials are advantageously used in a ratio of 1:1.

The reactions are carried out at different temperatures depending on the solvents and starting materials used. The temperatures and other reaction conditions necessary for the reactions in question are generally known and are familiar to the person skilled in the art. The reaction products can be separated and purified according to generally customary methods, for example by crystallisation, distillation or chromatography.

The preparation of the photoinitiator starting materials that are surface-active-modified in accordance with the invention with A₀, is known to the person skilled in the art and is carried out according to customary methods. The starting materials are in some cases available commercially, or they can be obtained according to methods known to the person skilled in the art. For example, such compounds are described in EP 499 836, U.S. Pat. No. 4,602,097, in BE 865 202, in Mol. Cryst. Liq. Cryst. (1981), 78, 263-270 or in J. Indian. Chem. Soc. (1960), 37,159.

Preference is given to a process in which, in the compounds of formulae Ia, Ib, Ic and Id, R and R₁ are each independently of the other a radical of formula II,

wherein in formula II

R₂, R₃, R₄, R₅ and R₆ are each independently of the others hydrogen; A-X—, A₁-X₁—, unsubstituted C₁-C₁₂alkyl, or C₂-C₁₂alkyl interrupted by one or more nonconsecutive oxygen atoms; or R₂, R₃, R₅ and Re are OR₁₂, halogen or unsubstituted phenyl;

with the proviso that in formulae (Ia) and (Ib) at least one substituent A-X— or A₁-X₁— is present in at least one of the radicals R and R₁;

or

R and R₁ are naphthyl, the naphthyl radical being unsubstituted or substituted by A-X—, A₁-X₁—, C₁-C₈alkyl and/or by OR₁₂;

wherein in formula Ic

R₂, R₃, R₄, R₅, R₆, R₇, R₈ and R₉ are each independently of the others hydrogen; A-X—, A₁-X₁—, unsubstituted C₁-C₁₂alkyl, or C₂-C₁₂alkyl interrupted by one or more non-consecutive oxygen atoms; or R₂, R₃, R₄, R₅ and Re are OR₁₂, halogen or unsubstituted phenyl;

with the proviso that in formula (Ic) at least one of the radicals R₂, R₃, R₄, R₅, R₆, R₇, R₈ and R₉ is A-X— or A₁-X₁—;

wherein in formula Id

R₂, R₃, R₄ and R₅ are each independently of the others hydrogen; A-X—, A₁-X₁—, unsubstituted C₁-C₁₂alkyl, or C₂-C₁₂alkyl interrupted by one or more nonconsecutive oxygen atoms; or R₂, R₃, R₄, R₅ and R₆ are OR₁₂, halogen or unsubstituted phenyl;

with the proviso that in formula (Id) at least one of the radicals R₂, R₃, R₄ and R₅ is A-X— or A₁-X₁—;

R₁₀ is C₁-C₈alkyl, or phenyl unsubstituted or substituted by A-X—;

R₁₂ is hydrogen or unsubstituted C₁-C₁₂alkyl; or R₁₂ is C₂-C₁₂alkyl interrupted by one or more nononsecutive oxygen atoms; or R₁₂ is phenyl, C₃-C₆alkenyl, cyclopentyl or cyclohexyl;

R₁₈, R₁₉, R₂₀, R₂₁, R₂₂, R₂₃, R₂₄, R₂₅, R₂₆ and R₂₇ are each independently of the others C₁-C₁₈alkyl or phenyl;

X and X₁, when A or A₁ is a radical of formula III, are each independently of the other C₁-C₁₀alkylene, —(CH₂)ₐ—O—, (CH₂)ₐ-——(CH₂)_{b}, —O—(CH₂)ₐ—O—(CH₂)_{b}—, —(CH₂)ₐ—O—(CH₂)_{b}—O—, —(CH₂)ₐ—NR₁₇—(CH₂)_{b}— or —(CH₂)ₐ—NR₁₇—;

and

X and X₁, when A or A₁ denotes A₀, are each independently of the other a single bond, —O—, —S— or —NR₁₇—.

Special preference is given to a process in which, in the compounds of formulae Ia, Ib, Ic and Id, A and A₁ are a radical of formula III.

The following are examples of compounds of formulae Ia, Ib, Ic and Id according to the invention:

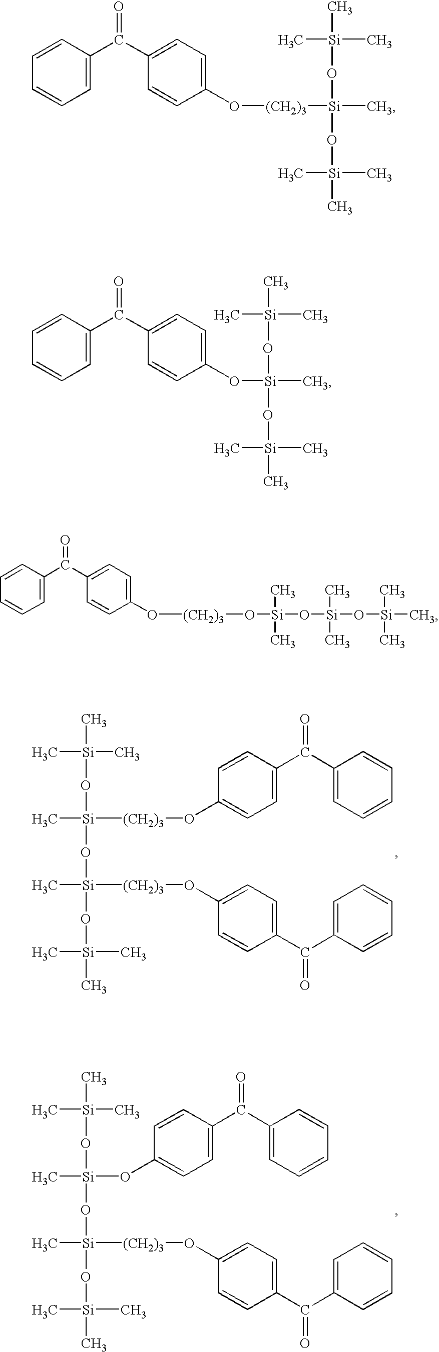

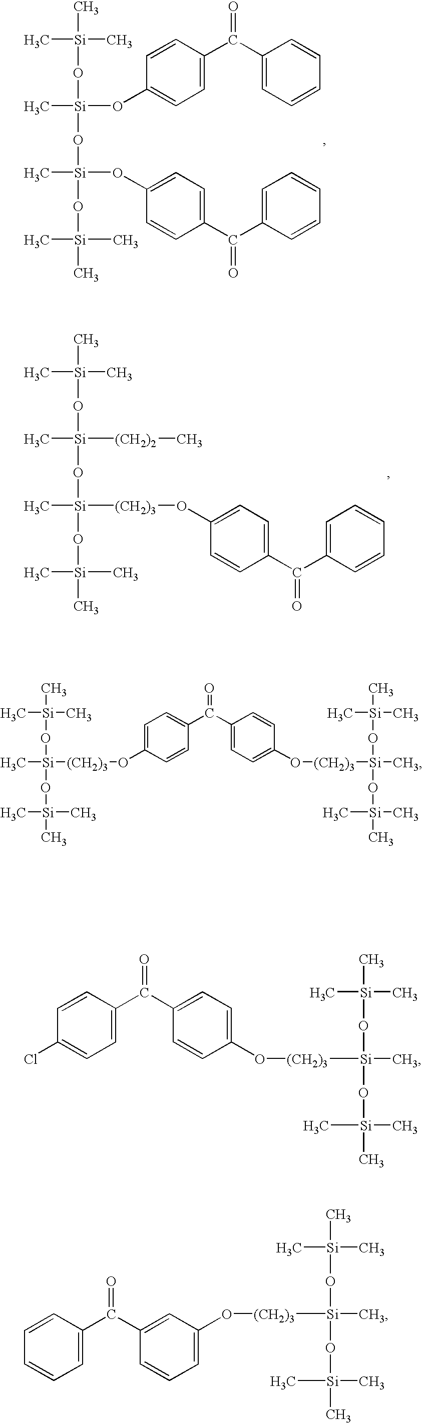

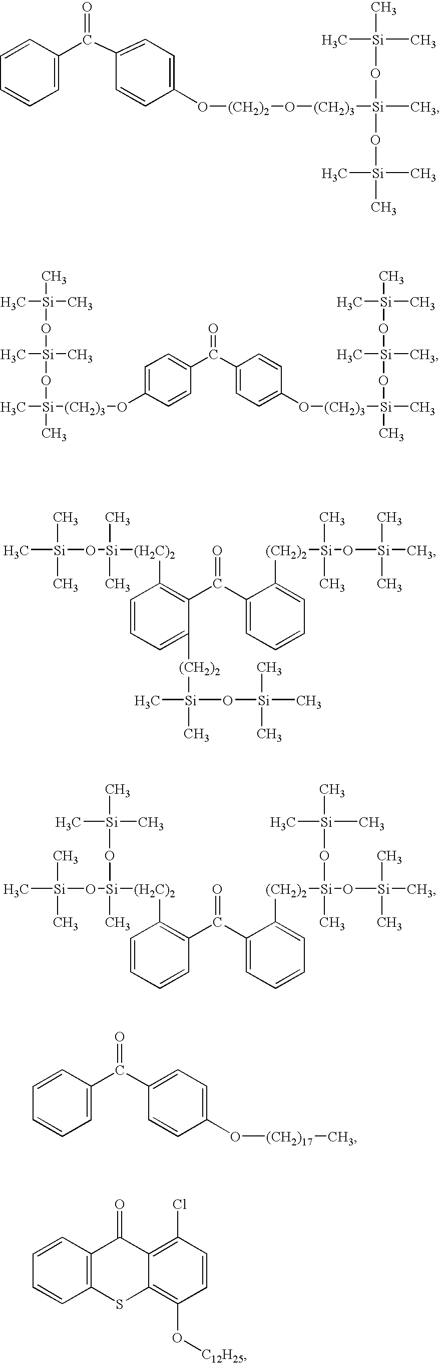

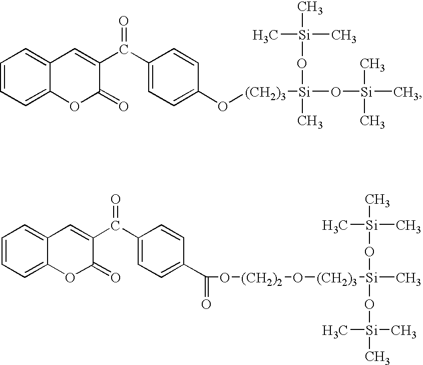

The compounds of formula I contain at least one substituent —X-A or —X₁-A₁. Those substituents are the radicals that bring about the surface activity of the photoinitiator compounds, that is to say ensure that the photoinitiator is concentrated at the surface of the formulation to be cured.

The photoinitiators are used in accordance with the invention to cure free-radical-polymerizable systems with the aim of obtaining a cured surface having excellent properties. For that purpose, it is crucial for the photoinitiator to be concentrated at the surface of the formulation to be cured. As has already been stated above, this is achieved by appropriate substituents on the photoinitiator. An improvement in the surface properties can be achieved with the aid of such initiators not only in purely photocurable systems but also in formulations that are a mixture of thermally curable and photocurable. The present invention accordingly relates both to the use of the photoinitiators of formula I in purely photocurable formulations and to the use of the photoinitiators of formula I in formulations that are a mixture of photochemically and thermally curable. The thermal curing can be effected before, during or after the exposure to light.

The invention accordingly relates also to a process as described above in which the photocurable formulation comprises as further component at least one thermally crosslinkable compound (C), and in which the formulation is cured by irradiation with light of a wavelength ranging from 200 nm into the IR region, and the prior, simultaneous and/or subsequent action of heat.

According to the invention, the compounds of formulae Ia, Ib, Ic and Id can be used as surface-active photoinitiators for the photopolymerization of ethylenically unsaturated compounds or of mixtures that comprise such compounds, and are oriented towards the surface of the formulation in question.

According to the invention, a process for concentrating a photoinitiator at the surface of coatings thus comprises adding a surface-active photoinitiator of formula Ia, Ib, Ic or Id to the photopolymerizable mixture comprising the ethylenically unsaturated photopolymerizable compounds.

According to the invention, when the intended use of the initiators of formula (I) is as surface-active photoinitiators, they are not used in compositions that contain siloxane-modified resin components. The compounds according to the invention are, however, excellently suitable for increasing the miscibility and compatibility of the initiator molecule with such siloxane-modified resins. Their use as surface-active photoinitiators is preferred. The photoinitiators can also be used in combination with other photoinitiators (E) and/or further additives (D).

The invention accordingly relates also to photopolymerizable compositions comprising

(A) at least one ethylenically unsaturated free-radical-photopolymerizable compound; and

(B) at least one surface-active photoinitiator of formula Ia, Ib, Ic or Id; and

(D) optionally, as additional additive, an amine.

The invention relates furthermore to photopolymerizable compositions comprising

(A) at least one ethylenically unsaturated free-radical-photopolymerizable compound;

(B) at least one surface-active photoinitiator of formula Ia, Ib, Ic or Id;

(C) at least one thermally crosslinkable compound; and

(D) optionally, as additional additive, an amine.

In accordance with the invention, the compositions may also comprise further different photoinitiators (E) and/or further additives (D). Catalysts for the thermal crosslinking may also be added. Suitable examples are listed hereinbelow.

The unsaturated compounds (A) may contain one or more olefinic double bonds. They may be low molecular weight (monomeric) or higher molecular weight (oligomeric).

Examples of monomers having a double bond include alkyl and hydroxyalkyl acrylates and methacrylates, for example methyl, ethyl, butyl, 2-ethylhexyl and 2-hydroxyethyl acrylate, isobornyl acrylate, methyl methacrylate and ethyl methacrylate. Further examples are acrylonitrile, acrylamide, methacrylamide, N-substituted (meth)acrylamides, vinyl esters, such as vinyl acetate, vinyl ethers, such as isobutyl vinyl ether, styrene, alkyl- and halostyrenes, N-vinylpyrrolidone, vinyl chloride and vinylidene chloride.

Examples of monomers having a plurality of double bonds include ethylene glycol diacrylate, propylene glycol diacrylate, neopentyl glycol diacrylate, hexamethylene glycol diacrylate and bisphenol-A diacrylate, 4,4′-bis(2-acryloyloxyethoxy)diphenylpropane, trimethylolpropane triacrylate, pentaerythritol triacrylate, pentaerythritol tetraacrylate, vinyl acrylate, divinylbenzene, divinyl succinate, diallyl phthalate, triallyl phosphate, triallyl isocyanurate and tris(2-acryloylethyl) isocyanurate.

Examples of higher molecular weight (oligomeric) polyunsaturated compounds include acrylated epoxy resins, acrylated or vinyl ether- or epoxy-group-containing polyesters, polyurethanes and polyethers. Further examples of unsaturated oligomers include unsaturated polyester resins, which are usually prepared from maleic acid, phthalic acid and one or more diols and have molecular weights of about from 500 to 3000. In addition, it is also possible to use vinyl ether monomers and oligomers, and also maleate-terminated oligomers having polyester, polyurethane, polyether, polyvinyl ether and epoxide main chains. Combinations of vinyl ether-group-carrying oligomers and polymers, as described in WO 90/01512, are especially suitable, but copolymers of monomers functionalized with vinyl ether and maleic acid also come into consideration.

Also suitable are compounds having one or more free-radical-polymerizable double bonds. Preferably, the free-radical-polymerizable double bonds in such compounds are in the form of (meth)acryloyl groups. (Meth)acryloyl and (meth)acryl, here and in the following, denote acryloyl and/or methacryloyl, and acryl and/or methacryl, respectively. Preferably at least two polymerizable double bonds in the form of (meth)acryloyl groups are present in the molecule. The compounds may be, for example, (meth)acryloyl-functional oligomeric and/or polymeric compounds of poly(meth)acrylate. The number average molecular weight of such a compound may be, for example, from 300 to 10 000, preferably from 800 to 10 000. The compounds containing preferably free-radical-polymerizable double bonds in the form of (meth)acryloyl groups can be obtained according to customary methods, for example by reaction of poly(meth)acrylates with (meth)acrylic acid. That method, and further methods of preparation, are described in the literature and are known to the person skilled in the art. Such unsaturated oligomers can also be termed prepolymers.

Functionalized acrylates are also suitable. Examples of suitable monomers normally used to form the backbone (the base polymer) of such functionalized acrylate and methacrylate polymers include, for example, acrylate, methyl acrylate, methyl methacrylate, ethyl acrylate, ethyl methacrylate, n-butyl acrylate, n-butyl methacrylate, isobutyl acrylate, isobutyl methacrylate, 2-ethylhexyl acrylate, 2-ethylhexyl methacrylate etc. In addition, suitable amounts of functional monomers are copolymerized during the polymerization in order to obtain the functional polymers in that way. Acid-functionalized acrylate or methacrylate polymers are obtained using acid-functional monomers, such as acrylic acid and methacrylic acid. Hydroxy-functional acrylate or methacrylate polymers are obtained from hydroxy-functional monomers, such as 2-hydroxyethyl methacrylate, 2-hydroxypropyl methacrylate, 3,4-dihydroxybutyl methacrylate. Epoxy-functionalized acrylate or methacrylate polymers are obtained using epoxy-functional monomers, such as glycidyl methacrylate, 2,3-epoxybutyl methacrylate, 3,4-epoxybutyl methacrylate, 2,3-epoxycyclohexyl methacrylate, 10,11-epoxyundecyl methacrylate etc. Similarly, it is possible, for example, for isocyanate-functionalized polymers to be prepared from isocyanate-functionalized monomers, for example metaisopropenyl-α,α-dimethylbenzyl isocyanate.

There are especially suitable, for example, esters of ethylenically unsaturated mono- or poly-functional carboxylic acids and polyols or polyepoxides, and polymers having ethylenically unsaturated groups in the chain or in side groups, e.g. unsaturated polyesters, polyamides and polyurethanes and copolymers thereof, alkyd resins, polybutadiene and butadiene copolymers, polyisoprene and isoprene copolymers, polymers and copolymers having (meth)acryl groups in side chains, and also mixtures of one or more such polymers.

Examples of suitable mono- or poly-functional unsaturated carboxylic acids are acrylic acid, methacrylic acid, crotonic acid, itaconic acid, cinnamic acid, maleic acid, fumaric acid, itaconic acid, and unsaturated fatty acids such as linolenic acid or oleic acid. Acrylic acid and methacrylic acid are preferred.

It is also possible, however, for saturated di- or poly-carboxylic acids to be used in admixture with unsaturated carboxylic acids. Examples of suitable saturated di- or poly-carboxylic acids include, for example, tetrachlorophthalic acid, tetrabromophthalic acid, phthalic anhydride, adipic acid, tetrahydrophthalic acid, isophthalic acid, terephthalic acid, trimellitic acid, heptanedicarboxylic acid, sebacic acid, dodecanedicarboxylic acid, hexahydrophthalic acid etc.

Suitable polyols are aromatic and especially aliphatic and cycloaliphatic polyols. Examples of aromatic polyols include hydroquinone, 4,4′-dihydroxydiphenyl, 2,2-di(4-hydroxyphenyl)propane, and novolaks and resols. Examples of polyepoxides are those based on the said polyols, especially the aromatic polyols, and epichlorohydrin. Also suitable as polyols are polymers and copolymers that contain hydroxyl groups in the polymer chain or in side groups, e.g. polyvinyl alcohol and copolymers thereof and polymethacrylic acid hydroxyalkyl esters or copolymers thereof. Further suitable polyols are oligo esters having hydroxyl terminal groups.

Examples of aliphatic and cycloaliphatic polyols include alkylenediols having preferably from 2 to 12 carbon atoms, such as ethylene glycol, 1,2- and 1,3-propanediol, 1,2-, 1,3- and 1,4 butanediol, pentanediol, hexanediol, octanediol, dodecanediol, diethylene glycol, triethylene glycol, polyethylene glycols having molecular weights of preferably from 200 to 1500, 1,3-cyclopentanediol, 1,2-, 1,3 and 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may be partially or fully esterified with one or with different unsaturated carboxylic acid(s), it being possible for the free hydroxyl groups in partial esters to be modified, for example etherdied, or esterdied with other carboxylic acids.

Examples of Esters Are:

trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentaacrylate, sorbitol hexaacrylate, oligo ester acrylates and methacrylates, glycerol di- and tri-acrylate, 1,4-cyclohexane diacrylate, bisacrylates and bismethacrylates of polyethylene glycol having a molecular weight of from 200 to 1500, and mixtures thereof.

Also suitable as component (A) are the amides of identical or different unsaturated carboxylic acids and aromatic, cycloaliphatic and aliphatic polyamines having preferably from 2 to 6, especially from 2 to 4, amino groups. Examples of such polyamines are ethylenediamine, 1,2- and 1,3-propylenediamine, 1,2-, 1,3- and 1,4-butylenediamine, 1,5-pentylenediamine, 1,6-hexylenediamine, octylenediamine, dodecylenediamine, 1,4-diaminocyclohexane, isophorone diamine, phenylenediamine, bisphenylenediamine, di-β-aminoethyl ether, diethylenetriamine, triethylenetetramine and di(β-aminoethoxy)- and di(β-aminopropoxy)-ethane. Further suitable polyamines are polymers and copolymers which may have additional amino groups in the side chain and oligoamides having amino terminal groups. Examples of such unsaturated amides are: methylene bisacrylamide, 1,6-hexamethylene bisacrylamide, diethylenetriamine trismethacrylamide, bis(methacrylamidopropoxy)ethane, β-methacrylamidoethyl methacrylat and N-[(β-hydroxyethoxy)ethyl]-acrylamid.

Suitable unsaturated polyesters and polyamides are derived, for example, from maleic acid and diols or diamines. The maleic acid may have been partially replaced by other dicarboxylic acids. They may be used together with ethylenically unsaturated comonomers, e.g. styrene. The polyesters and polyamides may also be derived from dicarboxylic acids and ethylenically unsaturated diols or diamines, especially from those having relatively long chains of e.g. from 6 to 20 carbon atoms. Examples of polyurethanes are those composed of saturated diisocyanates and unsaturated diols or unsaturated diisocyanates and saturated diols.

Polybutadiene and polyisoprene and copolymers thereof are known. Suitable comonomers Include, for example, olefins, such as ethylene, propene, butene and hexene, (meth)acrylates, acrylonitrile, styrene and vinyl chloride. Polymers having (meth)acrylate groups in the side chain are likewise known. They may be, for example, reaction products of novolak-based epoxy resins with (meth)acrylic acid; homo- or co-polymers of vinyl alcohol or hydroxyalkyl derivatives thereof that have been esterified with (meth)acrylic acid; or homo- and co-polymers of (meth)acrylates that have been esterified with hydroxyalkyl (meth)acrylates.

The photopolymerizable compounds (A) can be used on their own or in any desired mixtures. Preferably, mixtures of polyol (meth)acrylates are used.

Binders may also be added to the compositions according to the invention, this being particularly advantageous when the photopolymerizable compounds are liquid or viscous substances. The amount of binder may be, for example, from 5 to 95% by weight, preferably from 10 to 90% by weight and especially from 40 to 90% by weight, based on total solids. The choice of the binder is made in accordance with the field of use and the properties required therefor, such as developability in aqueous and organic solvent systems, adhesion to substrates and sensitivity to oxygen.

Suitable binders are, for example, polymers having a molecular weight of approximately from 5000 to 2 000 000, preferably from 10 000 to 1 000 000. Examples are: homo- and copolymers of acrylates and methacrylates, e.g. copolymers of methyl methacrylate/ethyl acrylate/methacrylic acid, poly(methacrylic acid alkyl esters), poly(acrylic acid alkyl esters); cellulose esters and ethers, such as cellulose acetate, cellulose acetate butyrate, methylcellulose, ethylcellulose; polyvinyl butyral, polyvinyl formal, cyclized caoutchouc, polyethers such as polyethylene oxide, polypropylene oxide, polytetrahydrofuran; polystyrene, polycarbonate, polyurethane, chlorinated polyolefins, polyvinyl chloride, copolymers of vinyl chloride/vinylidene chloride, copolymers of vinylidene-chloride with acrylonitrile, methyl methacrylate and vinyl acetate, polyvinyl acetate, copoly(ethylenealknyl acetate), polymers such as polycaprolactam and poly(hexamethylene adipamide), polyesters such as poly(ethylene glycol terephthalate) and poly(hexamethylene glycol succinate).

There may also be used as component (A), that is to say as UV-curable component, the resins listed hereinbelow under (C₁). Of special interest are, for example, unsaturated acrylates having reactive functional groups. The reactive functional group may, for example, be selected from a hydroxyl, thiol, isocyanate, epoxy, anhydride, carboxyl, amino and a blocked amino group. Examples of OH-group-containing unsaturated acrylates are hydroxyethyl, hydroxybutyl and also glycidyl acrylates.

The unsaturated compounds can also be used in admixture with non-photopolymerizable film-forming components. These may be, for example, polymers that can be dried physically or solutions thereof in organic solvents, for example nitrocellulose or cellulose acetobutyrate, but they may also be chemically or thermally curable resins, for example polyisocyanates, polyepoxides or melamine resins. Melamine resins are to be understood as meaning not only condensation products of melamine (=1,3,5-triazine-2,4,6-triamine) but also condensation products of melamine derivatives. They are generally film-forming binders based on a thermoplastic or thermocurable resin, mainly on a thermocurable resin. Examples include alkyd resins, acrylic resins, polyester resins, phenol resins, melamine resins, epoxy resins and polyurethane resins and mixtures thereof. The concomitant use of thermally curable resins is important for use in so-called hybrid systems, which are both photopolymerized and thermally crosslinked.

Component (A) may be, for example, a coating composition comprising

(A1) one or more compounds containing free-radical-polymerizable double bonds that, in addition, contain at least one further functional group that is reactive in terms of an addition and/or condensation reaction (examples are given hereinbefore),

(A2) one or more compounds containing free-radical-polymerizable double bonds that, in addition, contain at least one further functional group that is reactive in terms of an addition and/or condensation reaction, the additional reactive functional group being complementary to, that is to say reactive with, the additional reactive functional group(s) of component (A1), (A3) optionally at least one monomeric, oligomeric and/or polymeric compound having at least one functional group that is reactive, in terms of an addition and/or condensation reaction, with respect to the functional groups of component (A1) or component (A2) present in addition to the free-radical-polymerizable double bonds.

Component (A2) carries the relevant groups complementary to, that is to say reactive with, component (A1). It is also possible for different kinds of functional group to be present in one component. With component (A3), there is a further component available that contains functional groups reactive in terms of addition and/or condensation reactions, those groups being able to react with the functional groups of (A1) or (A2) present in addition to the free radical-polymerizable double bonds. Component (A3) does not contain any free-radical-polymerizable double bonds. Examples of such (A1), (A2), (A3) combinations are to be found in WO 99/55785. Examples of suitable reactive functional groups are selected, for example, from hydroxyl, thiol, isocyanate, epoxy, anhydride, carboxyl and blocked amino groups. Examples are described hereinbefore.

Constituents of component (C) include, for example, thermally curable surface-coating or coating-system constituents customary in the art. Where appropriate, component (C) accordingly consists of a plurality of constituents.

Examples of component (C) include, for example, oligomers and/or polymers derived from α,β-unsaturated acids and derivatives thereof, e.g. polyacrylates and polymethacrylates, polymethyl methacrylates modified in respect of impact resistance using butyl acrylate, polyacrylamides and polyacrylonitriles. Further examples of component (C) are urethanes, polyurethanes that are derived on the one hand from polyethers, polyesters and polyacrylates having free hydroxyl groups or thiol groups and on the other hand from aliphatic or aromatic polyisocyanates, and precursors thereof. Accordingly component (C) includes, for example, also crosslinkable acrylic resins derived from substituted acrylic acid esters, e.g. epoxy acrylates, urethane acrylates or polyester acrylates. In addition, alkyd resins, polyester resins and acrylate resins and modifications thereof that are crosslinked with melamine resins, urea resins, isocyanates, isocyanurates, polyisocyanates, polyisocyanurates and epoxy resins, can be constituents of component (C).

Component (C) is, for xample, generally a film-forming binder based on a thermoplastic or thermocurable resin, chiefly on a thermocurable resin. Examples include alkyd resins, acrylic resins, polyester resins, phenol resins, melamine resins, epoxy resins, polyurethane resins and mixtures thereof. Examples of such resins are described, for example, in Ullmann's Encyclopedia of Industrial Chemistry, 5th edition, Vol. A18, pp. 368-426, VCH, Weinheim 1991.

Component (C) can be a cold-curable or a hot-curable binder, the addition of a curing catalyst possibly being advantageous. Suitable catalysts for accelerating the full cure of the binder are described, for example, in Ullmann's Encyclopedia of Industrial Chemistry, Vol. A18, p. 469, VCH Verlagsgesellschaft, Weinheim 1991.

The following are examples of special binders suitable as component (C):

1. surface-coating compositions based on cold- or hot-crosslinkable alkyd, acrylate, polyester, epoxy or melamine resins or mixtures of such resins, optionally with the addition of a curing catalyst;

2. two-component polyurethane surface-coating compositions based on hydroxyl-group-containing acrylate, polyester or polyether resins and aliphatic or aromatic isocyanates, isocyanurates or polyisocyanates;

3. two-component polyurethane surface-coating compositions based on thiol-group-containing acrylate, polyester or polyether resins and aliphatic or aromatic isocyanates, isocyanurates or polyisocyanates;

4. one-component polyurethane surface-coating compositions based on blocked isocyanates, isocyanurates or polyisocyanates which are deblocked during stoving; the addition of melamine resins is also possible, if desired;

5. one-component polyurethane surface-coating compositions based on aliphatic or aromatic urethanes or polyurethanes and hydroxyl-group-containing acrylate, polyester or polyether resins;

6. one-component polyurethane surface-coating compositions based on aliphatic or aromatic urethane acrylates or polyurethane acrylates having free amine groups in the urethane structure and melamine resins or polyether resins, optionally with the addition of a curing catalyst;

7. two-component surface-coating compositions based on (poly)ketimines and aliphatic or aromatic isocyanates, isocyanurates or polyisocyanates;

8. two-component surface-coating compositions based on (poly)ketimines and an unsaturated acrylate resin or a polyacetoacetate resin or a methacrylamidoglycolate methyl ester;

9. two-component surface-coating compositions based on carboxyl- or amino-group-containing polyacrylates and polyepoxides;

10. two-component surface-coating compositions based on anhydride-group-containing acrylate resins and a polyhydroxy or polyamino component;

11. two-component surface-coating compositions based on acrylate-containing anhydrides and polyepoxides;

12. two-component surface-coating compositions based on (poly)oxazolines and anhydride-group-containing acrylate resins or unsaturated acrylate resins or aliphatic or aromatic isocyanates, isocyanurates or polyisocyanates;

13. two-component surface-coating compositions based on unsaturated (poly)acrylates and (poly)malonates;

14. thermoplastic polyacrylate surface-coating compositions based on thermoplastic acrylate resins or extrinsically crosslinking acrylate resins in combination with etherified melamine resins;

15. surface-coating systems, especially clear lacquers, based on malonate-blocked isocyanates with melamine resins (e.g. hexamethoxymethylmelamine) as crosslinkers (acidcatalysed);

16. UV-curable systems based on oligomeric urethane acrylates and/or acylate acrylates, optionally with the addition of other oligomers or monomers;

17. dual-cure systems, which are cured first thermally and then by UV, or vice versa, the constituents of the surface-coating formulation containing double bonds that can be caused to react by UV light and photoinitiators and/or by electron beam curing.

Blocked isocyanates as may be employed, inter alia, in component (C) are described, for example, in Organischer Metallschutz: Entwicklung und Anwendung von Beschichtungsstoffen [Organic Protection of Metals: Development and Application of Coating Materials], page 159-160, Vincentz Verlag, Hannover (1993). These are compounds in which the highly reactive NCO group is “blocked” by reaction with specific radicals, such as primary alcohols, phenol, acetoacetates, ε-caprolactam, phthalimide, imidazole, oxime or amine. The blocked isocyanate is stable in liquid systems and also in the presence of hydroxyl groups. On heating, the blocking agents are eliminated again and the NCO group is exposed.

Both 1-component (1K) and 2-component (2K) systems may be used as component (C). Examples of such systems are described in Ullmann's Encyclopedia of Industrial Chemistry, Vol. A18, Paints and Coatings, page 404-407, VCH Verlagsgesellschaft mbH, Weinheim (1991).

The composition may be optimized by specially adapting the formulation, for example by varying the binder/crosslinker ratio. Such measures are well known to the person skilled in the art of coatings technology.

In the curing process of the invention, component (C) is preferably a mixture based on acrylate/melamine (and melamine derivatives), 2-component polyurethane, 1-component polyurethane, 2-component epoxy/carboxy or 1-component epoxy/carboxy. Mixtures of these systems are also possible, an example being the addition of melamine (or derivatives thereof) to 1-component polyurethanes.

Component (C) is preferably a binder based on a polyacrylate with melamine or on a melamine derivative. Preference is also given to a system based on a polyacrylate polyol or/and polyester polyol with an unblocked polyisocyanate or polyisocyanurate.

Component (C) may furthermore comprise monomeric or/and oligomeric compounds containing ethylenically unsaturated bonds (prepolymers) which additionally contain at least one or more OH, HS, NH₂, COOH, epoxy or NCO groups (=C₁) capable of reaction with the binder and/or crosslinker constituent of component (C). Following application and thermal curing, the ethylenically unsaturated bonds are converted by UV radiation into a crosslinked, high molecular weight form. Examples of such components (C) are described, for example, in the above-mentioned publication, Ullmann's Encyclopedia of Industrial Chemistry, 5^{th} edition, Vol. A18, pages 451-453, or by S. Urano, K. Aoki, N. Tsuboniva and R. Mizuguchi in Progress in Organic Coatings, 20 (1992), 471-486, or by H. Terashima and O. Isozaki in JOCCA 1992 (6), 222.

(C₁) may be, for example, an OH-group-containing unsaturated acrylate, e.g. hydroxyethyl or hydroxybutyl acrylate, or a glycidyl acrylate. Component (C₁) may be of any desired construction (may comprise, e.g., polyester, polyacrylate, polyether units, etc.) provided that an ethylenically unsaturated double bond and also free OH, COOH, NH₂, epoxy or NCO groups are present.

(C₁) can also be obtained, for example, by reacting an epoxy-functional oligomer with acrylic acid or methacrylic acid. A typical example of an OH-functional oligomer containing vinylic double bonds is

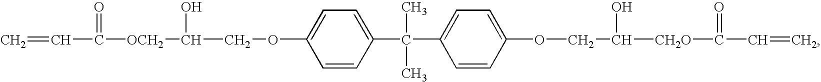

obtained by reacting

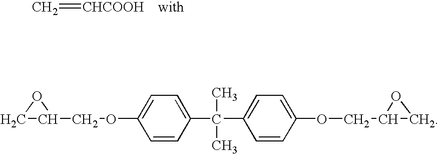

One possibility for preparing component (C₁) is also, for example, the reaction of an oligomer that contains only one epoxy group and at another position in the molecule possesses a free OH group.

The ratio of components (A) to (C) in the UV-crosslinking and thermally crosslinking formulations is not critical. “Dual-cure” systems are well known to the person skilled in the art, who is therefore well aware of the optimum ratios of the UV-crosslinkable and thermally crosslinkable components for the particular desired application. For example, the compositions may comprise components (A) and (C) in a ratio of from 5:95 to 95:5, from 20:80 to 80:20 or from 30:70 to 70:30, e.g. from 40:60 to 60:40.

Examples of “dual-cure” systems, I.e. systems containing both UV-curable and thermally curable components, may be found, inter alla, in U.S. Pat. No. 5,922,473, columns 6 to 10.

It is also possible to add solvents or water to the compositions used in the process of the invention. Where the compositions are used without solvents, they are, for example, powder coating formulations. Suitable solvents are solvents which are known to the person skilled in the art and are customary particularly in coatings technology. Examples are various organic solvents, such as ketones, e.g. methyl ethyl ketone, cyclohexanone; aromatic hydrocarbons, e.g. toluene, xylene or tetramethylbenzene; glycol ethers, such as diethylene glycol monoethyl ether, dipropylene glycol diethyl ether; esters, such as ethyl acetate; aliphatic hydrocarbons, such as hexane, octane, decane; or petroleum solvents, such as petroleum ether.

The invention also provides compositions comprising as component (A) at least one ethylenically unsaturated photopolymerizable compound in emulsion or solution in water. Such radiation-curable aqueous prepolymer dispersions are available commercially in numerous variations. They are understood to be a dispersion of water and at least one prepolymer dispersed therein. The concentration of the water in these systems is, for example, from 5 to 80% by weight, especially from 30 to 60% by weight. The radiation-curable prepolymer or prepolymer mixture is present, for example, in concentrations of from 95 to 20% by weight, especially from 70 to 40% by weight. In these compositions the sum of the percentages stated for water and prepolymers is in each case 100; the auxiliaries and additives are extra in different amounts depending on the intended use.

The radiation-curable film-forming prepolymers which are in dispersion, and often also in solution, in water are monofunctional or polyfunctional ethylenically unsaturated prepolymers which are known per se for aqueous prepolymer dispersions, can be initiated by means of free radicals, and have a polymerizable double bond content of, for example, from 0.01 to 1.0 mol per 100 g of prepolymer and also have an average molecular weight of, for example, at least 400, especially from 500 to 10 000. Depending on the intended application, however, prepolymers with higher molecular weights may also be suitable.

Use is made, for example, of polyesters containing polymerizable C—C double bonds and having an acid number of not more than 10, polyethers containing polymerizable C—C double bonds, hydroxyl-group-containing reaction products of a polyepoxide containing at least two epoxide groups per molecule with at least one α,β-ethylenically unsaturated carboxylic acid, polyurethane (meth)acrylates, and also acrylic copolymers containing α,β-ethylenically unsaturated acrylic radicals, as described, for example, in EP 012 339. Mixtures of these prepolymers can likewise be used. Examples of further suitable prepolymers include the polymerizable prepolymers described in EP 033 896, which are thioether adducts of polymerizable prepolymers having an average molecular weight of at least 600, a carboxyl group content of from 0.2 to 15% and a polymerizable C—C double bond content of from 0.01 to 0.8 mol per 100 g of prepolymer. Other suitable aqueous dispersions based on specific alkyl (meth)acrylate polymers are described in EP 041 125; suitable water-dispersible, radiation-curable prepolymers of urethane acrylates are given, for example, In DE 29 36 039.

As further additives, these radiation-curable aqueous prepolymer dispersions may comprise dispersing aids, mulsifiers, antioxidants, light stabilizers, dyes, pigments, fillers, e.g. talc, gypsum, silica, rutile, carbon black, zinc oxide, iron oxides, reaction accelerators, flow agents, lubricants, wetting agents, thickeners, matting agents, antifoams, and other auxiliaries customary in coatings technology. Suitable dispersing aids include water-soluble organic compounds of high molecular weight containing polar groups, such as polyvinyl alcohols, polyvinylpyrrolidone or cellulose ethers. Emulsifiers that can be used include nonionic, and possibly also ionic, emulsifiers.

The compounds of the invention and mixtures thereof may also be used in dual-cure latex compositions as described in the U.S. Pat. No. 5,780,117, wherein “latex” or “latex composition” refers to a dispersion of a water-insoluble polymer which may be prepared by conventional polymerization techniques such as, for example, by emulsion polymerization. The resins, i.e. the polymer in the latex include but are not limited to: addition polymers of at least one ethylenically unsaturated monomer; condensation polymers made by the reaction of one or more diisocyanates or polyisocyanates with one or more compounds containing groups with active hydrogens; and polyester resins made by the reaction of one or more alcohols, especially diols or polyols, with polyhydric acids or anhydrides of polybasic acids. Such addition polymers include, for example, those prepared from acrylic ester monomers including methyl acrylate, ethyl acrylate, butyl acrylate, 2-ethylhexyl acrylate, methyl methacrylate, butyl methacrylate; styrene or substituted styrenes; butadiene; vinyl acetate or other vinyl esters; vinyl monomers such as vinyl chloride, vinylidene chloride, N-vinyl pyrrolidone; and acrylonitrile or methacrylonitrile. The condensation polymers include, for example, polyurethanes and polyureas such as those made by the reaction of one or more diisocyanates or polyisocyanates with one or more compounds containing groups with active hydrogens such as, for example, polyester, polycarbonate, or polyether di- or poly-ols, monomeric alcohols, diols or polyols, primary or secondary amines or hydrazine compounds, mercaptans, or compounds containing enolic hydrogens such as acetoacetate groups; likewise included are polyester resins made by the reaction of one or more alcohols, especially diols or polyols, with polyhydric acids or anhydrides of polybasic acids, such as, for instance, reaction products of ethylene glycol, propylene glycol, the isomeric butanediols or hexanediols, glycerol, neopentylglycol, allyl alcohol, trimethylolpropane, diethylene glycol, triethylene glycol, dipropylene glycol, or polyether oligomers made by the condensation of one or more of these alcohols, with acids or acid anhydrides such as adipic acid, maleic acid, maleic anhydride, phthalic acid, phthalic anhydride, tetrahydrophthalic acid, tetrahydrophthalic anhydrid , trimellitic anhydride, acrylic acid, methacrylic acid, fumaric acid, itaconic acid, or natural oil fatty acids such as linseed oil fatty acids, tall oil fatty acids, soybean oil fatty acids, or abietic acid. Polyester resins or their precursors may also be made by using transesterification reaction methods well known in the art for the production of alkyd polyesters.

Dispersions of these resins may be in the form of single or multi-staged particles. Multi-staged particles will comprise at least two mutually incompatible copolymers having any of a number of morphological configurations-for example: core/shell; core/shell particles with shell stages incompletely encapsulating the core; core/shell particles with a multiplicity of cores, interpenetrating network particles; and the like, where the greater portion of the surface area of the particles will be occupied by at least one outer stage, and the interior of the particle will be occupied by at least one inner stage.

For addition polymers anionic stabilization may be conferred through the copolymerization of low levels of ethylenically-unsaturated acid monomers (e.g., 0.1-7%, by weight, based on the weight of the addition polymer). Examples of ethylenically unsaturated acid monomers include but are not limited to those of: acrylic acid, methacrylic acid, crotonic acid, itaconic acid, fumaric acid, maleic acid, monomethyl itaconate, monomethyl fumarate, maleic anhydride, 2-acrylamido-2-methyl-1-propanesulfonic acid, sodium vinyl sulfonate, and phosphoethyl methacrylate.

For polyurethane condensation polymers anionic stabilization may be conferred through the copolymerization of acid-containing compounds into the polymer backbone, such as, for example, 0.1-15 wt %, based on the weight of the polyurethane polymer, of dimethylolpropionic acid or of its sulfonic acid analogue. For polyester condensation polymers anionic stabilization may be conferred through the use of a molar excess of acid functional groups during the polymerization of the resin, such that the resin has an acid equivalent weight between about 600 and 20 000 (for water-reducible resins, preferably between about 900 and 1400).

The polymers are rendered radiation-curable through the incorporation of ethylenically unsaturated groups, which may either be directly incorporated Into the polymer backbone during its manufacture, or attached to the polymer backbone at some subsequent point.

Depending on the particular use, the resins will generally be supplied as aqueous dispersions at solids levels between about 5 wt % and 70 wt %, or in water-reducible form (with or without a cosolvent) at solids levels between about 50 wt % and 100 wt %; The level of solids preferred for coatings applications depends upon the requirements of the particular application. For those applications where a low solids coating is preferred, it is preferred to use formulations between 5 wt % and 60 wt % of polymer solids, most preferably between about 20 wt % and 50 wt %. High solids coatings are preferably formulated at solids levels in excess of 60%, most preferably between 80 and 100 wt %.

The compounds of the invention and mixtures thereof may also be used as free-radical photoinitiators or photoinitiating systems for radiation-curable powder coating compositions. The powder coating compositions may be based on solid resins and monomers containing reactive double bonds, such as maleates, vinyl ethers, acrylates, acrylamides and mixtures thereof. A free-radically UV-curable powder coating composition can be formulated by mixing unsaturated polyester resins with solid acrylamides (e.g. methylacrylamidoglycolate methyl ester) and a free-radical photoinitiator of the invention, as described for example in the paper “Radiation Curing of Powder Coating”, Conference Proceedings, Radtech Europe 1993 by M. Wittig and Th. Gohmann. Free-radically UV-curable powder coating compositions can also be formulated by mixing unsaturated polyester resins with solid acrylates, methacrylates or vinyl ethers and a photoinitiator (or photoinitiator mixture) of the invention. The powder coating compositions may also include binders, as described for example in DE 42 28 514 and EP 636 669. The powder coating formulations described in EP 636 669 contain, for example, a) an unsaturated Tesin from the group of the (semi)crystalline or amorphous unsaturated polyesters, unsaturated polyacrylates or mixtures thereof with unsaturated polyesters, particular preference being given to those derived from maleic acid or fumaric acid; b) an oligomeric or polymeric crosslinking agent containing vinyl ether-functional, vinyl ester-functional or (meth)acrylate-functional groups, particular preference being given to vinyl ether oligomers, such as divinyl ether-functionalized urethanes; c) the photoinitiator. The UV-curable powder coating compositions may also comprise white or coloured pigments. For example, preferably rutile titanium dioxide may be used in concentrations of up to 50% by weight in order to give a cured powder coating possessing good hiding power. The techniqu normally involves applying the powder to the substrate, such as metal or wood, by electrostatic or tribostatic spraying, melting the powder by heating and, after a smooth film has formed, radiation-curing the coating with ultraviolet and/or visible light, for example using medium-pressure mercury lamps, metal halide lamps or xenon lamps. A particular advantage of the radiation-curable powder coating compositions over their thermally curable counterparts is that the flow time after melting of the powder particles can be selectively extended in order to ensure the formation of a smooth, high-gloss coating. Unlike thermally curable systems, radiation-curable powder coating compositions can be so formulated, without the unwanted effect of a shortened lifetime, that they melt at relatively low temperatures. For this reason they are also suitable as coatings for heat-sensitive substrates, such as wood or plastics.

Where the powder coating compositions are to be applied to non-heat-sensitive substrates, for example metals (vehicle coatings), however, it is also possible to provide dual-cure powder coating formulations with the photoinitiators of the invention. Such formulations are known to the person skilled in the art; they are cured both thermally and by means of UV. Formulations of this kind may be found, for example, in U.S. Pat. No. 5,922,473.

Besides the photoinitiators of the invention, the powder coating formulations may also comprise UV absorbers. Appropriate examples are listed hereinbelow.

The photopolymerizable mixtures can also contain various additives (D) in addition to the photoinitiator. Examples thereof are thermal inhibitors, which are intended to prevent premature polymerization, e.g. 2,2,6,6-tetramethyl-4-hydroxypiperidin-1-oxyl (4-hydroxyTEMPO) and derivatives thereof, e.g. bis(2,2,6,6-tetramethylpiperidin-1-oxyl-4-yl)decanedioate or polyalkyl-piperidin-N-oxyl free radicals, 3-arylbenzofuran-2-one and derivatives thereof, e.g. 5,7-di-tert-butyl-3-phenyl-3H-benzofuran-2-one (as described, for example, in PCT publication WO 01/42313), hydroquinone, hydroquinone derivatives, p-methoxyphenol, P-naphthol and sterically hindered phenols, e.g. 2,6-di(tert-butyl)-p-cresol. In order to increase dark-storage stability it is possible to use, for example, copper compounds, such as copper naphthenate, stearate or octoate, phosphorus compounds, for example triphenylphosphine, tributyiphosphine, triethyl phosphite, triphenyl phosphite or tribenzyl phosphite, quaternary ammonium compounds, e.g. tetramethylammonium chloride or trimethylbenzylammonium chloride, or hydroxylamine derivatives, e.g. N-diethylhydroxylamine. For the purpose of xcluding atmospheric oxygen during polymerization it is possible to add paraffin or similar wax-like substances which, being insoluble in the polymer, migrate to the surface at the beginning of the polymerization and form a transparent surface layer which prevents air from entering. Equally possible is the application of a layer that is impermeable to oxygen. As light stabilizers it is possible to add UV absorbers, e.g. those of the hydroxyphenylbenzotriazole, hydroxyphenylbenzophenone, oxalic acid amide or hydroxyphenyl-s-triazine type. Such compounds can be used on their own or in the form of mixtures, with or without the use of sterically hindered amines (HALS).

The following are examples of such UV absorbers and light stabilizers:

1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2(3′,5′-di-tert-butyl-2′-hydroxyphenyl)-5-chloro-benzotriazole, 2-(3′-tert-butyl-2′-hydroxy-5′ methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2,1-hydroxy-5′-(2-methoxycarbonylethyl) phenyl)-5-chloro-benzotriazole, 2-(3′-tert-butyl-2′-hydroxy-5′-(2-methoxycarbonylethyl)phenyl)benzotriazole, 2-(3′-tert-butyl-2¹-hydroxy-5′-(2-octyloxycarbonylethyl)phenyl)benzotriazole, 2-(3′-tert-butyl-5′-[2-(2-ethylhexyloxy)carbonyjethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenyl; the transesterification product of 2-[3′-tert-butyl-5′-(2-methoxycarbonylethyl)-2′-hydroxyphenyl]-2H-benzotriazole with polyethylene glycol 300; [(R—CH₂CH₂—COO—CH₂CH₂]₂— where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole; 2-[2′-hydroxy-3′-(1,1,3,3-tetramethylbutyl)-5′-(α,α-dimethylbenzyl)phenyl]benzotriazole.

2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

3. Esters of substituted and unsubstituted benzoic acids, as for example 4-tert-butyl-phenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butylhydroxybenzoate, hexadecyl 3,5-di-tert-butylhydroxybenzoate, octadecyl 3,5-di-tert-butyl-4-hydroxybenzoate, 2-methyl-4,6-di-tert-butylphenyl 3,5-di-tert-butyl-4-hydroxybenzoate.

4. Acrylates, for example ethyl α-cyano-,β,β-diphenylacrylate, isooctyl α-cyano-β,β-diphenylacrylate, methyl α-carbomethoxycinnamate, methyl α-cyano-β,β-methyl-β-methoxy-cinnamate, butyl α-cyano-β-methyl-β-methoxy-cinnamate, methyl α-carbomethoxy-p-methoxycinnamate and N—(β-carbomethoxy-β-cyanovinyl)-2-methylindoline.

5. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetraids(2,2,6,6-tetramethyl-4-piperidyl)-1,2,3,4-butane-tetracarboxylate, 1,1′-(1,2-ethanediyl)-bis(3,3,5,5-tetramethylpiperazinone)-4,4-benzoyl-2,2,6,6-tetramethylpiperidine, 4-stearyloxy-2,2,6,6-tetramethylpiperidine, bis(1 ,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl -1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylaminoyethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. (13650496-61); N-(2,2,6,6-tetramethyl-4-piperidyl)-n-dodecylsuccinimide, N-(1 ,2,2,6,6-pentamethyl-4-piperidyl)-n-dodecylsuccinimide, 2-undecyl-7,7,9,9-tetramethyl-1-oxa-3,8-diaza-4-oxospiro[4,5]decane, a reaction product of 7,7,9,9-tetramethyl-2-cycloundecyl-1-oxa-3,8-diaza-4-oxospiro [4,5]decane and epichlorohydrin, 1,1-bis(1,2,2,6,6-pentamethyl-4piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, polytmethylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

6. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

7. 2-(2-Hydroxyphenyl)-1.3.5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxy-propyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tnis[2-hydroxy-4-(3-butoxy-2-hydroxy-propoxy)phenyl)-1,3,5-triazine, 2-(2-hydroxyphenyl)-4-(4-methoxyphenyl)-6-phenyl-1,3,5-triazine, 2-(2-hydroxy-4-[3-(2-ethylhexyl-1-oxy)-2-hydroxypropyloxy]phenyl)-4,6-bis(2,4-dimethylphenyl)-1,3,5-triazine.

8. Phosphites and phosphonites. for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-1,2H-dibenz[d,g]-1,3,2-dioxaphosphocin, bis(2,4-di-tertbutyl-6-methylphenyl) methyl phosphite, bis(2,4-di-tert-butyl-6-methylphenyl) ethyl phosphite, 6-fluoro-2,4,8,110-tetra-tert-butyl-1,2-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tritert-butylphenoxy)-1,3,2-dioxaphosphirane.

Furthermore, it is possible to use additives customary in the art, such as antistatics, flow improvers and adhesion promoters.

The photoinitiators of formulae Ia, Ib, Ic and Id can also act as flow improvers, since they are oriented towards the surface and also influence the surface properties through the group A or A₁. Further flow improvers customary in the art may also be added. Examples include siloxane compounds and fluorohydrocarbon compounds and polyacrylates widely available on the market.

The invention relates also to the use of compounds of formulae Ia, Ib, Ic and Id as flow improvers, optionally in combination with further customary flow improvers.

DIN 55945 defines levelling as “the more or less pronounced capacity of a still-liquid coating itself to compensate the unevennesses which arise in the course of its application.” (cf. J. Bieleman, Lack additive [Additives for Coatings], VCH Weinheim 1998, chapter 6). The levelling of a coating composition depends greatly on its flow behaviour and on its surface tension. Flow improvers are substances that, by reducing the viscosity and/or surface tension, help wet coatings to become films that flow out evenly. In the case of powder coating compositions, flow improvers also lower the melt viscosity and the glass transition temperature and have an additional degassing effect. Flow improvers are used to eliminate levelling defects or surface defects which detract from the overall appearance of the coating. Levelling defects or surface defects include the orange peel effect, formation of structures, cratering, fisheyes, sensitivity to draughts, substrate wetting problems, brush marks, runs, bittiness, pinholes, etc. The use of the compounds of the invention as flow improvers makes it possible to lower the surface tension. The surface tension can be calculated by determining the marginal angle of a drop of liquid on a surface (contact angle measurement).

In order to accelerate the photopolymerization, there may be added as further additives (D) amines, especially tertiary amines, for example tributylamine, triethanolamine, p-dimethylaminobenzoic acid ethyl ester, Michler's ketone, N-methyl-diethanolamine, N-dimethylethanolamine, N-ethylmorpholine, N-methylmorpholine, diazabicyclooctane (triethylenediamine), 18-diazabicyclo[5.4.0]undec-7-ene (DBU), 1,5-diazabicyclo(4.3.0]non-5-ene (DBN) and salts thereof. Further examples include quaternary ammonium salts, for example trimethylbenzylammonium chloride. It is also possible to add masked or surface-active masked amines; such masked amines are described, for example, in EP 764 698 and EP 747 454. The action of the amines can be enhanced by the addition of aromatic ketones of the benzophenone type. Amines suitable for use as oxygen capture agents are, for example, substituted N,N-dialkylanilines, as described in EP 339 841. Further accelerators, co-initiators and auto-oxidizers are thiols, thioethers, disulfides and phosphines, as described e.g. in EP 438 123 and GB 2 180 358.

It is also possible to add chain transfer reagents customary in the art to the compositions of the invention. Examples are mercaptans, amines and benzothiazole.

The photopolymerization may furthermore be accelerated by adding photosensitizers as further additives (D), which shift or broaden the spectral sensitivity. These photosensitizers are, in particular, aromatic carbonyl compounds such as benzophenone derivatives, thioxanthone derivatives, and also especially isopropylthioxanthone, anthraquinone derivatives and 3-acylcoumarin derivatives, terphenyls, styryl ketones, and also 3(aroylmethylene)thiazolines, camphorquinone, and also eosine dyes, rhodamine dyes and erythrosine dyes.

The amines indicated above, for example, may also be considered as photosensitizers.

The curing process, especially of compositions that are pigmented (with titanium dioxide for example), may also be assisted by adding an additional additive (D) which is a component which under thermal conditions forms free radicals, such as an azo compound, for instance 2,2′-azobis(4-methoxy-2,4-dimnethylvaleronitrile), a triazene, diazo sulfide, pentazadiene or a peroxy compound such as hydroperoxide or peroxycarbonate, e.g. tert-butyl hydroperoxide, as described for example in EP 245 639.

As further additives (D), the compositions may also comprise, for example, a photoreducible dye, such as xanthene, benzoxanthene, benzothioxanthene, thiazine, pyronine, porphyrin or acridine dyes, and/or a radiation-cleavable trihalomethyl compound. Similar compositions are described, for example, in EP 445 624.

Further common additives (D)—depending on the intended use—include optical brighteners, fillers, e.g. kaolin, talc, barytes, gypsum, chalk or silicate fillers, pigments, dyes, wetting agents or flow improvers.

For the hardening of thick and pigmented coatings it is appropriate to add glass microbeads or pulverized glass fibres, as described for example in U.S. Pat. No. 5,013,768.

The formulations may also comprise dyes and/or white or coloured pigments. Depending on the intended application, both inorganic and organic pigments may be used. Such additives are known to the person skilled in the art; some examples are titanium dioxide pigments, of, for example, the rutile or anatase type, carbon black, zinc oxide, such as zinc white, iron oxides, such as yellow iron oxide, red iron oxide, chrome yellow, chrome green, nickel titanium yellow, ultramarine blue, cobalt blue, bismuth vanadate, cadmium yellow or cadmium red. Examples of organic pigments are monoazo or bisazo pigments, and also metal complexes thereof, phthalocyanine pigments, polycyclic pigments, such as perylene, anthraquinone, thioindigo, quinacridone or triphenylmethane pigments, and also diketopyrrolopyrrole, isoindolinone, e.g. tetrachloroisoindolinone, isoindoline, dioxazine, benzimidazolone and quinophthalone pigments.

The pigments may be used individually or in a mixture in the formulations.

The pigments, depending on the intended use, are added to the formulations in the amounts customary in the art, for example in an amount of from 1 to 60% by weight, or from 10 to 30% by weight, based on the total mass.

The formulations may, for example, also comprise organic dyes from a very wide variety of classes. Examples are azo dyes, methine dyes, anthraquinone dyes or metal complex dyes. Customary concentrations are, for example, from 0.1 to 20%, especially from 1 to 5%, based on the total mass.

The choice of additives is guided by the respective field of application and by the properties desired for that field. The above-described additives (D) are customary in the art and, accordingly, are used in the amounts that are customary in the art.

In certain cases it may be of advantage to use mixtures of two or more of the photoinitiators of the formulae Ia, Ib, Ic or/and Id; it is advantageous, for example, to use mixtures obtained directly in the preparation. It is of course also possible to use mixtures with known photoinitiators (E), examples being mixtures with camphorquinone, benzophenone, benzophenone derivatives, acetophenone, acetophenone derivatives, such as α-hydroxycycloalkyl phenyl ketones or 2-hydroxy-2-methyl-1-phenylpropanone, dialkoxyacetophenones, α-hydroxy- or α-amino-acetophenones, such as (4-methylthiobenzoyl)-1-methyl-1-morpholinoethane, (4-morpholinobenzoyl)-1-benzyl-1-dimethylaminopropane, 4-aroyl-1,3-dioxolanes, benzoin alkyl ethers and benzil ketals, such as benzil dimethyl ketal, phenyl glyoxalates and derivatives thereof, dimeric phenyl glyoxalates, peresters, for example benzophenonetetracarboxylic peresters as described, for example, in EP 126 541, monoacylphosphine oxides, such as (2,4,6-trimethylbenzoyl)phenylphosphine oxide, bisacylphosphine oxides, such as bis(2,6-methoxybenzoyl)(2,4,4-trimethylpent-1-yl)phosphine oxide, bis(2,4,6-trimethylbenzoyl)phenylphosphine oxide or bis(2,4,6-trimethylbenzoyl)(2,4-dipentyloxyphenyl)phosphine oxide, trisacylphosphine oxides, halomethyltriazines, e.g. 2-[2-(4-methoxyphenyl)vinyl]4,6-bistrichloromethyl[1,3,5]-triazine, 2-(4-methoxyphenyl)-4,6-bistrichloromethyl[1,3,5]triazine, 2-(3,4-dimethoxyphenyl)-4,6-bistrichloromethyl[1,3,5]triazine, 2-methyl-4,6-bistrichloromethyl[1,3,5]triazine, hexaarylbisimidazole/coinitiator systems, e.g. ortho-chlorohexaphenylbisimidazole together with 2-mercaptobenzothiazole, ferrocenium compounds or titanocenes, such as dicyclopentadienyl bis(2,6-difluoro-3-pyrrolophenyl)titanium, borate photoinitiators or o-acyloxime photoinitiators, as described, for example, in GB 2 339 571.

Where the photoinitiators of the invention are employed in hybrid systems, i.e. systems which can be cured both free-radically and cationically, use is made, in addition to the free-radical curing agents of formula I and any further free-radical curing agents, of cationic photoinitiators, such as benzoyl peroxide (other suitable peroxides are described in

U.S. Pat. No. 4,950,581, column 19, lines 17-25), or aromatic sulfonium, phosphonium or iodonium salts, as described, for example, in U.S. Pat. No. 4,950,581, column 18, line 60 to column 19, line 10.

The photopolymerizable compositions contain the photoinitiator advantageously in an amount of from 0.05 to 15% by weight, preferably from 0.1 to 5% by weight, based on the composition. The stated amount of photoinitiator is based on the sum of all of the photoinitiators added, if mixtures thereof are used, i.e. both on the photoinitiator (B) and on the photoinitiators (B)+(E).

The photopolymerizable compositions can be used for a variety of purposes: for example, as a printing ink, as a clear lacquer, as a white paint, as a chromatically pigmented paint, for example for wood or metal, as powder coating compositions, as coating compositions for, inter alia, paper, wood, metal or plastics, as a daylight-curable coating for the marking of buildings and roads, for photographic reproduction techniques, for holographic recording materials, for image recording techniques or for producing printing plates which can be developed with organic solvents or using aqueous alkalis, for producing masks for screen printing, as dental filling compounds, as adhesives, as pressure-sensitive adhesives, as laminating resins, as etch resists or permanent resists, both liquid and in the form of dry films, as photostructurable dielectrics, and as solder resists for electronic circuits, as resists for producing colour filters for any type of screen, or for producing structures in the production process of plasma displays and electroluminescent displays, for the production of optical switches, optical lattices (interference grids), for the production of three-dimensional articles by mass curing (UV curing in transparent moulds) or by the stereolithography process, as described, for example, in U.S. Pat. No. 4,575,330, for producing composite materials (e.g. styrene polyesters which may, where appropriate, contain glass fibres and/or other fibres and other auxiliaries), and of fine layers (gel coats) and high-film-build compositions, for the coating or sealing of electronic components, or as coatings for optical fibres. The compositions are suitable, furthermore, for the production of optical lenses, e.g. contact lenses or Fresnel lenses, and also for producing medical instruments, aids or implants.

The compositions may also be used to produce gels having thermotropic properties, as described, for example, in DE 19 700 064 and EP 678 534.

The compounds of the formulae Ia, Ib, Ic and Id may additionally be used as initiators for emulsion, bead or suspension polymerization or as initiators in a polymerization for the fixing of states of order of liquid-crystalline monomers and oligomers, or as initiators for the fixing of dyes on organic materials.

The photocurable compositions of the invention are suitable, for example, as coating materials for substrates of all kinds, e.g. wood, textiles, paper, ceramics, glass, plastics, such as polyesters, polyethylene terephthalate, polyolefins or cellulose acetate, especially in the form of films, and also metals, such as Al, Cu, Ni, Fe, Zn, Mg or Co and GaAs, Si or SiO₂, to which a protective coat, or—by imagewise exposure—an image, is to be applied.

The photoinitiators according to present invention are also suitable for use in compositions as coatings for optical fibers. In general, optical fibers are coated with protective coats directly after their production. The fiber of glass is drawn and then one or more coatings are applied to the glass string. Usually, one, two or three coats are applied, the top coating, for example, is colored (“ink layer or ink coating”). Further, several thus coated optical fibers may be put together to a bundle and be coated all together, i.e. cabling of the fibers. The compositions according to the present invention in general are suitable for any of these coatings, which have to exhibit good softness over a broad temperature range, good tensile strength and toughness and rapid UV-curing characteristics.

Each of the coats, inner primary (usually a soft coating), outer primary or secondary (usually a harder coating than the inner coating), tertiary or the cabling coat, may comprise at least one radiation-curable oligomer, at least one radiation curable monomer diluent, at least one photoinitiator, and additives.

In general all radiation curable oligomers are suitable. Preferred are oligomers with a molecular weight of at least 500, for example 500-10'000, 700-1 0'000, 1'000-8'000 or 1'0007'000, in particular urethane oligomers, containing at least one unsaturated group. Preferably the radiation curable oligomer has two terminal functional groups. The coat may contain not only one specific oligomer, but also mixtures of different oligomers. The preparation of suitable oligomers is known to the person skilled in the art and for example published in U.S. Pat. No. 6,136,880, incorporated herein by reference. The oligomers are, for example, prepared by reacting an oligomer diol, preferably a diol having 2-10 polyoxaalkylene groups, with a diisocyanate or a polyisocyanate and a hydroxy-functional ethylenically unsaturated monomer, e.g. hydroxyalkyl(meth)acrylate. Specific examples of each of the components named above, as well as suitable ratios of these components are given in U.S. Pat. No. 6,136,880, incorporated herein by reference.

The radiation curable monomer can be used in a manner to control the viscosity of the coating formulation. Accordingly, a low viscosity monomer with at least one functional group capable of photoinitiated polymerization is employed. The amount for example is chosen to adjust the viscosity in a range from 1'000 to 10'000 mPas, i.e. usually for example from 10-90, or 10-80 wt/o are used. The functional group of the monomer diluent preferably is of the same kind than the one of the oligomer component, for example ah acrylate or vinyl ether function and a higher alkyl or polyether moiety. Examples of monomer diluents suitable for coating compositions for optical fibers are published in U.S. Pat. No. 6,136,880, col. 12, line 11ff., incorporated herein by reference.

In primary coatings preferably monomers having an acrylate or vinyl ether functionality and a polyether moiety of 4 to 20 C atoms is used. Specific examples are given in the US patent incorporated by reference and cited above.

The composition may also comprise a poly(siloxane) as described in U.S. Pat. No. 5,595,820 to improve the adhesive properties of the formulation on the optical fiber glass substrate. The coating composition usually also comprises further additives, e.g. antioxidants, light stabilizers, UV absorbers such as for example given in the list above in particular ^{RTM}IRGANOX 1035, 1010, 1076,1222, ^{RTM}INUVIN P, 234, 320, 326, 327, 328, 329, 213, 292, 144, 622LD (all provided by Ciba Specialty Chemicals), ^{RTM}ANTIGENE P, 3C, FR, GA80, ^{RTM}SUMISORB TM-061 (provided by Sumitomo Chemical Industries Co.),4 ^{RTM}SEESORB 102, 103, 501, 202, 712, 704 (provided by Sypro Chemical Co., Ltd.), ^{RTM}SANOL LS770 (provided by Sankyo Co. Ltd.) to prevent the coloring of the coat, in particular during the processing, and to Improve the stability of the cured coat. Particularly interesting are stabilizer combinations of hindered piperidine derivatives (HALS) and hindered phenol compounds, e.g. a combination of IRGANOX 1035 and TINUVIN 292, for example in a ratio of 1:1. Further, additives are for example wetting agents and other additives having an effect on the rheology properties of the coating. Also amines, for example diethylamine, can be added.

Other examples for additives for compositions for the coating of optical fibers are silane coupling agents, e.g. γ-aminopropyltriethoxysilane, γ-mercaptopropyltrimethoxysilane, γ-methacryloxypropyl-trimethoxysilane, SH6062, SH6030 (provided by Toray-Dow Corning Silcone Co., Ltd.), KBE 903, KBE 603, KBE 403 (provided by Shin-Etsu Chemical Co., Ltd.)

In order to prevent coloring of the coatings the compositions may also comprise fluorescent additives or optical brighteners, as, for example, ^{RTM}UVITEX OB, provided by Ciba Specialty Chemicals.

The photoinitiators according to the present application in coating compositions for optical fibers can be admixed with one or more other known photoinitiators. These are in particular monoacylphosphine oxides, such as diphenyl-2,4,6-trimethylbenzoyl phosphine oxide; bisacylphosphine oxides, such as bis(2,4,6-trimethylbenzoyl)-phenyl phosphine oxide (^{RTM}IRGACURE 819), bis(2,6-dimethoxybenzoyl)-2,4,4-trimethylpentyl phosphine oxide; α-hydroxyketones, such as 1-hydroxycyclohexyl phenyl ketone (^{RTM}IRGACURE 184), 2-hydroxy-2-methyl-1-phenyl-1-propanone (^{RTM}DAROCUR 1173), 2-hydroxy-1-[4-(2-hydroxyethoxy)phenyl]-2-methyl-1-propanone (^{RTM}IRGACURE 2959); α-aminoketones, such as 2-methyl-1-[4-(methylthio)phenyl]-2-(4-morpholinyl)-1-propanone (^{RTM}IRGACURE 907), 2-benzyl-2-(dimethylamino)-1-[4-(4-morpholinyl)phenyl]-1-butanone (^{RTM}IRGACURE 369); benzophenones, such as benzophenone, 2,4,6-trimethylbenzophenone, 4-methylbenzophenone, 2-methylbenzophenone, 2-methoxycarbonylbenzophenone, 4,4′-bis(chloromethyl)benzophenone, 4-chlorobenzophenone, 4-phenylbenzophenone, 4,4′-bis(dimethylamino)benzophenone, 4,4′-bis(diethylamino)benzophenone, methyl 2-benzoylbenzoate, 3,3′-dimethyl4-methoxybenzophenone, 4-(4-methylphenylthio)benzophenone and also ketal compounds, for example 2,2-dimethoxy-1,2-diphenyl-ethanone (^{RTM}IRGACURE 651); monomeric or dimeric phenylglyoxalic acid esters, such as for example methyl phenylglyoxalic acid ester or 1,2-(benzoylcarboxy)ethane. In particular suitable are admixtures with mono- or bisacylphosphine oxides and/or α-hydroxy ketones.

It is evident that the formulations, in order to enhance the properties of the photoinitiators may also comprise sensitizer compounds, for example amines.

The coatings are either applied “wet on dry” or “wet on wet”. In the first case after the application of the primary coat a curing step by irradiation with UV light is carried out prior to the application of the second coat. In the second case both coatings are applied and cured together by irradiation with UV light.

The curing with UV irradiation in this application usually takes place in a nitrogen atmosphere. In general all radiation sources usually employed in the photocuring technique can be used for the curing of optical fiber coatings. These are, for example the radiation sources listed below Generally, mercury medium pressure lamps or/and Fusion D lamps are used. Also flash lights are suitable. It is evident that the emission of the lamps is matched with the absorption of the photoinitiator or photoinitiator mixture which is used. The optical fiber coating compositions may also be cured by irradiation with an electron beam, in particular with low power electron beams, as is, for example disclosed in WO 98/41484.

In order to distinguish different fibers in an assembly, the fibers may be covered with a third colored coating (“ink coating”). The compositions used for this coating in addition to the polymerizable components and the photoinitiator comprise a pigment or dye. Examples for pigments suitable for optical fiber coatings are inorganic pigments, such as for example titanium dioxide, zinc oxide, zinc sulfide, barium sulfate, aluminium silicate, calcium silicate, carbon black, black iron oxide, copper chromite black, iron oxides, chromium oxide greens, iron blue, chrome green, violet (e.g. manganese violet, cobalt phosphate, CoLiPO₄), lead chromates, lead molybdates, cadmium titanate and pearlescent and metallic pigments, as well as organic pigments, such as monoazo pigments, di-azo pigments, di-azo condensation pigments, quinacridone pigments, dioxazine violet, vat pigments, perylene pigments, thioindigo pigments, phthalocyanine pigments and tetrachloroisoindolinones. Examples for suitable pigments are carbon black for a black coating, titanium dioxide for a white coating, diarylide yellow or diazo based pigments for yellow coatings, phthalocyanine blue, and other phthalocyanines for blue coatings, anthraquinone red, naphthole red, monazo based pigments, quinacridone pigments, anthraquinone and perylenes for red coatings, phthalocyanine green and nitroso based pigments for green coatings, monazo and diazo based pigments, quinacridone pigments, anthraquinones and perylenes for orange coatings, and quinacridone violet, basic dye pigments and carbazole dioxazine based pigments for violet coatings. The person skilled in the art is well aware of formulating and combining suitable further pigments if even more colored coatings, such as aqua, brown, gray, pink etc. are needed.

The mean particle size of the pigments usually is about 1 μm or less. The size of commercial pigments can be reduced by milling, if necessary. The pigments for example, can be added to the formulation in the form of a dispersion in order to simplify the mixing with the other ingredients of the formulation. The pigments are, for example dispersed in a low viscosity liquid, e.g. a reactive diluent. Preferred is the use of organic pigments.

Suitable amounts for pigment in the ink coating are for example 1-20, 1-15, preferably 1-10 wt %.

The ink coating in general also comprises a lubricant to provide improved break-out properties of the single coated optical fiber from the matrix. Examples of such lubricants are silicones, fluorocarbon oils or resins and the like, preferably a silicone oil or a functionalized silicone compound, e.g. silicone diacrylate is used.

The compositions according to the present invention are further suitable as a matrix material for an assembly of coated optical fibers. That is, several of the primary, secondary (and in some cases tertiary) coated fibers, for example, in the third coat being differentiated by different colors, are assembled in a matrix.

The coating of an assembly preferably besides the additives given above also contains a release agent to allow for easy access to the individual fibers during the installation of the optical fiber cables. I.e.

Examples for such release agents are teflon, silicones, silicon acrylates, fluorocarbon oils or resins and the like. The release agents suitably are added in an amount of 0.5-20 wt %.

Examples of ink coatings and matrix materials for coated optical fibers are given in U.S. Pat. Nos. 6,197,422, 6,130,980 and EP 614099, incorporated herein by reference.

The substrates can be coated by applying a liquid composition, a solution or suspension to the substrate. The choice of solvent and the concentration are guided primarily by the nature of the composition and by the coating technique. The solvent should be inert, i.e. it should not enter into any chemical reaction with the components and it should be able to be removed again in the course of drying after coating. Examples of suitable solvents are ketones, ethers and esters, such as methyl ethyl ketone, isobutyl methyl ketone, cyclopentanone, cyclohexanone, N-methylpyrrolidone, dioxane, tetrahydrofuran, 2-methoxyethanol, 2-ethoxyethanol, 1-methoxy-2-propanol, 1,2-dimethoxyethane, ethyl acetate, n-butyl acetate and ethyl 3-ethoxypropionate.

The formulation is applied uniformly to a substrate by means of known coating techniques, for example by spincoating, dipping, knife coating, curtain coating techniques, brush application, spraying, especially by electrostatic spraying, and reverse roll coating, and also by electrophoretic deposition. It is also possible to apply the photosensitive layer to a temporary flexible support and then, by layer transfer via lamination, to the final substrate. Examples of methods of application are described in Ullmann's Encyclopedia of Industrial Chemistry, 5^{th} edition, Vol. A18, pp. 491-500.

The application amount (coat thickness) and nature of the substrate (coat support) are dependent on the desired field of application. The dry film thickness range generally embraces values from about 0.1 μm to more than 100 μm, preferably from 0.02 to 2 cm.

A further field of use of photocuring is that of metal coating, as in the coating of metal sheets and tubes, cans or bottle closures, for example, and also photocuring on plastics coatings, for example PVC-based wall or floor coverings.

Examples of the photocuring of paper coatings are the colourless varnishing of labels, record sleeves or book covers.

Also preferred is the use of the coating formulation comprising the surface-active photoinitiators as a finishing paint for applications in the automobile industry, especially as a pigmented or unpigmented top coat of the coating, but use for layers beneath the top coat is also possible.

The photosensitivity of the compositions of the invention generally ranges from about 200 nm into the IR region. Suitable radiation is present, for example, in sunlight or light from artificial sources. Light sources employed therefore include a large number of a very wide variety of types. Both point sources and arrays (lamp carpets) are suitable. Examples are carbon arc lamps, xenon arc lamps, medium-, high- and low-pressure mercury lamps, possibly doped with metal halides (metal-halogen lamps), microwave-excited metal vapour lamps, excimer lamps, superactinic fluorescent tubes, fluorescent lamps, argon incandescent lamps, flashlights, e.g. high-energy flashlights, photographic floodlamps, light-emitting diodes (LEDs), electron beams and X-rays. The distance between the lamp and the substrate to be exposed may vary, depending on the intended application and the type and output of the lamps, for example between 2 cm and 150 cm. Especially suitable are laser light sources, e.g. excimer lasers, such as Krypton-F lasers for exposure at 248 nm. Lasers in the visible range can also be used.

As already mentioned, curing in the process of the invention may take place solely by exposure to electromagnetic radiation. Depending on the composition of the formulation to be cured, however, thermal curing before, during or after irradiation is advantageous. Thermal curing takes place in accordance with methods known to the person skilled in the art. Curing is generally carried out in an oven, e.g. a circulating air oven, on a hotplate, or by irradiation using IR lamps. Curing without auxiliaries at room temperature is likewise possible, depending on the binder system used. The curing temperatures are generally between room temperature and 150° C., e.g. 25-150° C. or 50-150° C. In the case of powder coating compositions or “coil coat” compositions, the curing temperatures may also be higher, e.g. up to 350° C.

Where the formulation includes thermally curable components (C), it is additionally possible In accordance with the invention to add thermal drying catalysts or curing catalysts to the formulation as additional additives (D). Examples of possible drying catalysts, or thermal curing catalysts, are organic metal compounds, amines or/and phosphines. Organic metal compounds are, for example, metal carboxylates, especially those of the metals Pb, Mn, Co, Zn, Hf, Zr or Cu, or metal chelates, especially those of the metals Hf, Al, Ti or Zr, or organo-metal compounds such as organotin compounds. Examples of metal carboxylates are the stearates of Pb, Mn or Zn, the octoates of Co, Zn or Cu, the naphthenates of Mn and Co or the corresponding linoleates or tallates. Examples of metal chelates are the aluminium, titanium or zirconium chelates of acetylacetone, ethyl acetylacetate, salicylaldehyde, salicylaldoxime, o-hydroxyacetophenone or ethyl trifluoroacetylacetate and the alkoxides of those metals. Examples of organotin compounds are dibutyltin oxide, dibutyltin dilaurate and dibutyltin dioctoate. These amines can also be used as synergistic compounds in purely UV-curable systems. Also suitable are surface-active amines as described in EP-0 764 698 B1. There are described in EP-0 764 698 B1 masked amine compounds that are surface-active in radiation-curable, free-radical-polymerizable compounds and that free amino compounds during irradiation.

Examples of amines are especially tertiary amines, for example tributylamine, triethanolamine, N-methyldiethanolamine, N-dimethylethanolamine, N-ethylmorpholine, N-methylmorpholine and diazabicyclooctane (triethylenediamine) and salts thereof. Further examples include quaternary ammonium salts, for example trimethylbenzylammonium chloride. It is also possible to use phosphines as curing catalyst, for example triphenylphosphine. Suitable catalysts are also described, for example, in J. Bielemann, -Lackadditive, Wiley-VCH Verlag GmbH, Weinheim, 1998, pages 244-247. Examples include carboxylic acids, for example p-toluenesulfonic acid, dodecylbenzenesulfonic acid, dinonylnaphthalenesulfonic acid and dinonyinaphthalenedisulfonic acid. Latent or blocked sulfonic acids, for example, can also be used, it being possible for the acid to be blocked ionically or non-ionically.

Such catalysts are used in concentrations known to the person skilled in the art and customary in the art.

The invention relates also to a process for photopolymerizing non-volatile monomeric, oligomeric or polymeric compounds containing at least one ethylenically unsaturated double bond, which process comprises exposing a composition as described above to electromagnetic radiation ranging from 200 to 600 nm.

The invention relates also to the use of the above-described composition and to a process for the production of pigmented and unpigmented surface coatings, powder coatings, fine layers (gel coats), composite materials or glass fibre cable coatings.

The invention likewise relates to a coated substrate that is coated on at least one surface with a composition as described above.

The Examples which follow illustrate the invention further, without any intention of restricting the invention to the Examples. As in the remainder of the description and in the claims, parts and percentages are by weight unless indicated otherwise. References to alkyl radicals containing more than three carbon atoms without indication of the isomer should be understood in each case as referring to the n-isomers.

### EXAMPLE A

(4Allyloxyphenyl) Phenyl Methanone

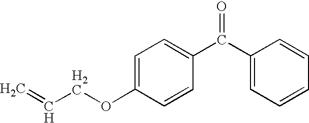

Allyl bromide (4.7 ml, 55.5 mmol) is added dropwise, at room temperature (RT), to a mixture of 4-hydroxybenzophenone (10 g, 50.45 mmol) and potassium carbonate (7.67 g, 55.5 mmol) in acetone (160 ml). The mixture is heated for 20 hours at 57° C. under N₂. Potassium carbonate (15.34 g, 100.9 mmol) and allyl bromide (6.4 ml, 75.6 mmol) are again added, and the mixture is heated for a further 4 hours, after which it is cooled to RT. After filtration and removal of th solvent by evaporation, a yellow solid is obtained which is recrystallised from ethanol (20 ml). Yellow crystals having a melting point of from 77 to 780C are obtained (9.84 g).

¹H-NMR (CDCl₃) δ [ppm]: 7.80 (m, 4H arom.); 7.51 (m, 3H arom.); 6.99 (m, 2H arom.); 6.06 (m, 1H, allyl); 5.38 (m, 2H, allyl); 4.62 (m, 2H, CH₂—O).

### EXAMPLE B

Bis(4-allyloxyphenyl) Methanone

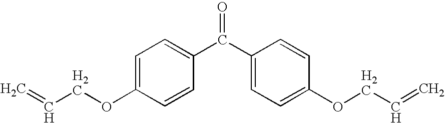

The compound of Example B is prepared in accordance with the method described in Example A, using 1 mol equivalent of 4,4′-bishydroxybenzophenone and 2.2 mol equivalents of allyl bromide.

M.p.=127° C. ¹H-NMR (CDCl₃) δ [ppm]: 7.78 (m, 2×2H arom.); 6.99 (m, 2×2H arom.); 6.06 (m, 2×1 H, allyl); 5.39 (m, 2×2H, allyl); 4.62 (m, 2×2H, CH₂—O).

### EXAMPLE C

(3-Allyloxyphenyl) Phenyl Methanon

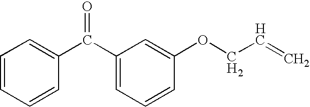

The compound of Example C is prepared in accordance with the method described in Example A, using 1 mol equivalent of 3-hydroxybenzophenone and 1.1 mol equivalents of allyl bromide.

¹H-NMR (CDCl₃) δ [ppm]: 8.01 (m, 2H arom.); 7.79 (m, 1H.arom.); 7.68 (m, 2H arom.); 7.57 (m, 3H arom.); 7.35 (m, 1H arom.); 6.26 (m, 1H, allyl); 5.58 (m, 2H, allyl), 4.80 (m, 2H, CH₂—O).

### EXAMPLE D

(4-Allyloxyphenyl)-(4-chlorophenyl) Methanone

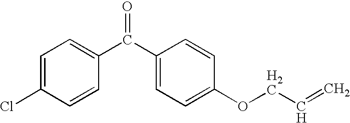

The compound of Example D is prepared in accordance with the method described in Example A, using 1 mol equivalent of 4-chloro-4′-hydroxybenzophenone and 1.1 mol equivalents of allyl bromide.

¹H-NMR (CDCl₃) δ [ppm]: 7.72 (d, J=9, 2H arom.); 7.63 (d, J=8.4, 2H arom.); 7.38 (d, J=8.4, 2H arom.); 6.91 (d, J=9, 2H arom.); 6.00 (m, 1H, allyl); 5.33 (m, 2H, allyl); 4.56 (d, J=5.1, 2H, CH₂—O).

### EXAMPLE E

[4-(2-Allyloxyethoxy)phenyl] Phenyl Methanone

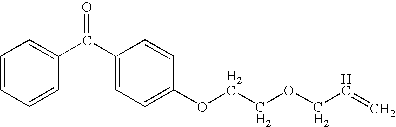

The compound of Example E is prepared in accordance with the method described in Example A, using 1 mol equivalent of 4-hydroxyethoxybenzophenone and 1.1 mol equivalents of allyl bromide.

¹H-NMR (CDCl₃) δ [ppm]: 7.86 (m, 4H arom.); 7.51 (m, 3H arom.); 6.97 (m, 2H arom.); 5.95 (m, 1H, allyl); 5.28 (m, 2H, allyl); 4.22 (m, 2H); 4.12 (m, 2H); 3.83 (m. 2H).

### EXAMPLE 1

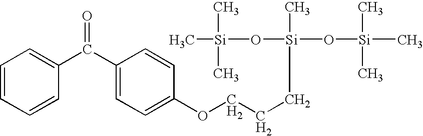

Compound of Formula Ia

R=phenyl, R₁=a radical of formula II wherein R₂, R₃, R₅, R₆=H and R₄=A-X— in which X≡—O—(CH₂)₃— and A=a radical of formula III wherein n=1, m=0, p=0, G₁≡—O—Si(CH₃)₃, G₂=-Si(CH₃)₃

A mixture of one equivalent of the compound from Example A and 1.1 equivalents of 1,1,1,3,5,5,5-heptamethyltrisiloxane in toluene is heated at 60° C. for 48 hours in the presence of 0.004 equivalent (based on the Pt content) of a Pt catalyst on an aluminium oxide support. The mixture is then filtered and the solution obtained is treated with activated carbon. After filtration and removal of the solvent by evaporation, the compound is obtained in quantitative yield in the form of an oil.

UV (CH₃CN) max at 286 nm (ε 17 189). ¹H NMR (CDCl₃) δ [ppm]: 7.65 (m, 4H arom.); 7.35 (m, 3H arom.); 6.90 (m, 2H arom.); 3.83 (m, 2H, Ar—OCH₂); 1.74 (m, 2H, Ar—OCH₂—CH₂); 0.49 (m, 2H, Ar—O—CH₂—CH₂—CH₂—Si); 0.01 (m, 21H, 7S₁—CH₃) m/z (Cl): 460 (M⁺); according to mass spectrum, further compounds are also present in small amounts: 460 (second isomer) ((M⁺)); 418 ((M⁺)); 240 ((M⁺)); 238 ((M⁺)); 310 ((M⁺)); 238 ((M⁺)).

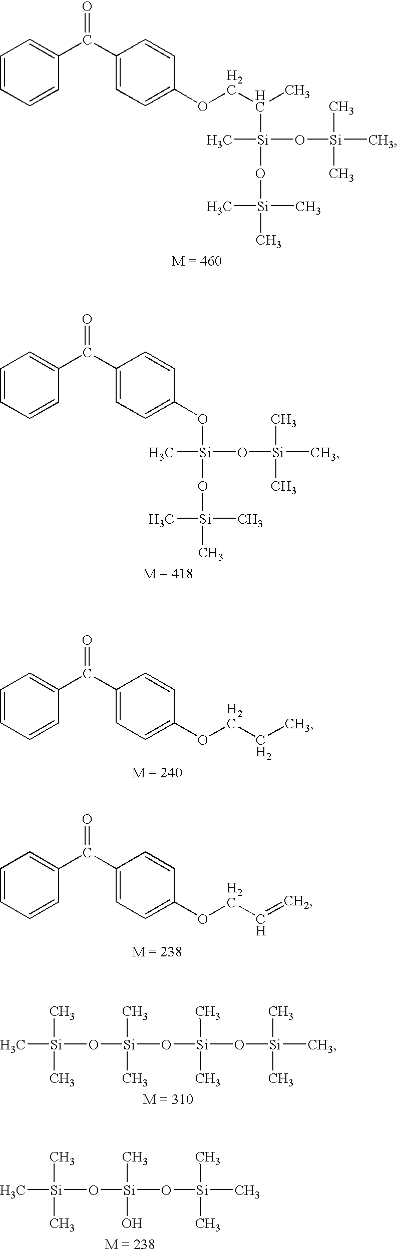

### EXAMPLE 2

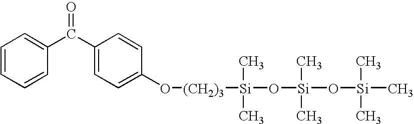

Compound of Formula Ia

R=phenyl, R, =a radical of formula II wherein R₂, RF, R₅, R₆═H and R₄ A-X— in which X≡O—(CH₂)₃— and A=a radical of formula III wherein n=1, m=0, p=1, G₁=—(CH₃), G₂=—Si(CH₃)₃

The compound of Example 2 is prepared in accordance with the method described in Example 1, using 1 mol equivalent of the compound from Example A and 1.1 mol equivalents of 1,1,1,3,3,5,5-heptamethyltrisiloxane.

UV (CH₃CN) max. at 286 nm (ε 18 286). ¹H NMR (CDCl₃) ε [ppm]: 7.67 (m, 4H arom.); 7.38 (m, 3H arom.); 6.84 (m, 2H arom.); 3.89 (t, 2H, J=6.0, Ar—OCH₂); 1.76 (m, 2H, Ar—OCH₂CH₂); 0.57 (m, 2H, Ar—O—CH₂—CH₂—CH₂—Si); 0.01 (m, 21H, 7S₁—CH₃). m/z (Cl): 460 ((M⁺)); according to mass spectrum, further compounds are also present in small amounts: 418 ((M⁺)); 240 ((M⁺)); 238 ((M⁺)); 238 (second isomer) ((M⁺)).

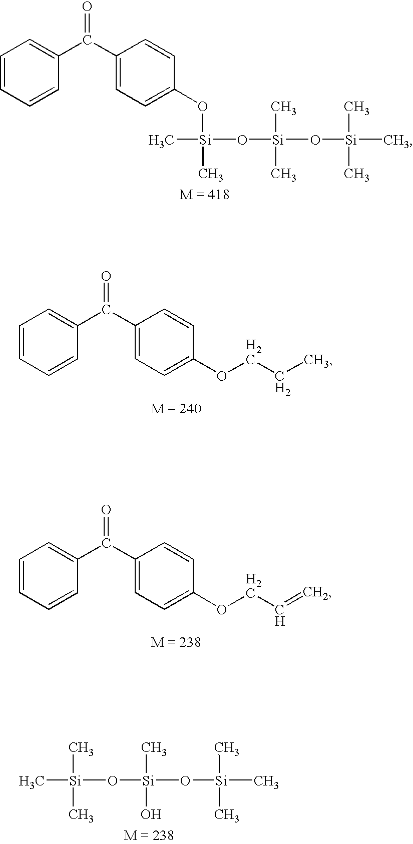

### EXAMPLE 3

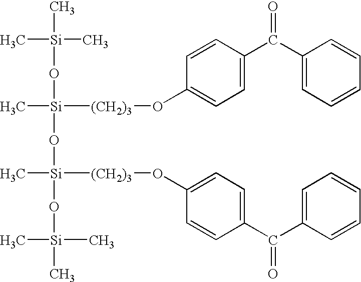

Compound of Formula Ia

R=phenyl, R₁=a radical of formula II wherein R₂, R₃, R₅, Re=H and R₄=A-X— in which X=—O—(CH₂)₃— and A=a radical of formula III wherein n=2, m=O, p=O, G₁=—OtSi(CH₃)₃, G₂=—Si(CH₃)₃

The compound of Example 3 is prepared in accordance with the method described in Example 1, using 2 mol equivalents of the compound from Example A and 1.1 mol equivalents of 1,1,1,3,5,7,7,7-octamethyltetrasiloxane.

UV (CH₃CN) max. at 285 nm (ε 32 056) ¹H NMR (CDCl₃) δ [ppm]: 7.78 (m, 8H arom.); 7.50 (m, 6H arom.); 6.94 (m, 4H arom.); 3.98 (m, 4H, Ar—OCH₂); 1.88 (m, 4H, Ar—OCH₂—CH₂); 0.64 (m, 2H, Ar—O—CH₂—CH₂—CH₂—Si); 0.01 (m, 24H, 8S₁—CH₃). m/z (Cl): 759 (MH⁺); according to mass spectrum, further compounds are also present in small amounts: 717 (MH⁺); 675 (MH⁺); 563 (MH⁺); 537 (MH⁺); 521 (MH⁺); 241 (MH⁺); 239 (MH⁺).

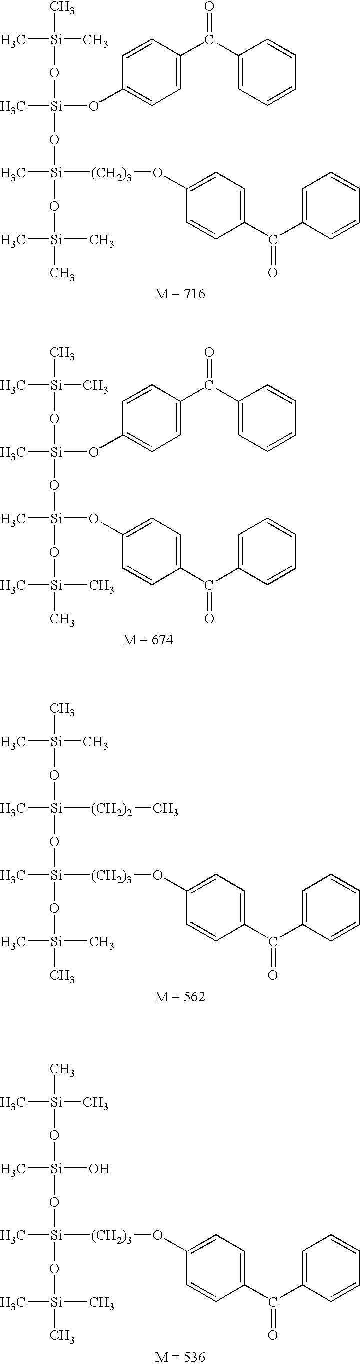

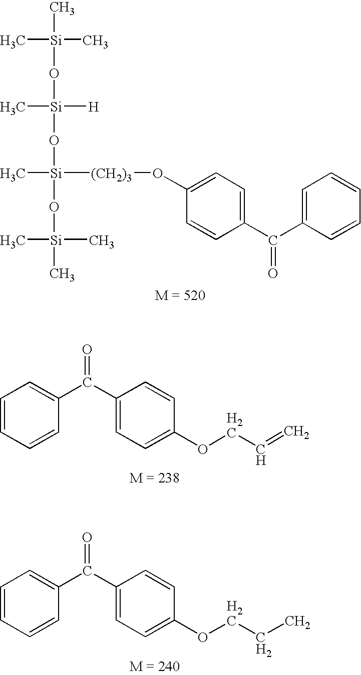

### EXAMPLE 4

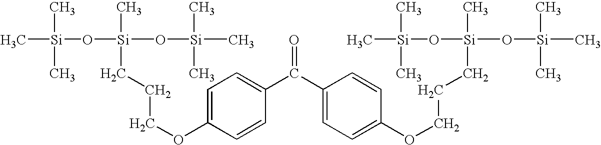

Compound of Formula Ia

R═R₁ a radical of formula II wherein R₂, R₃, R₅, R₁=H and R₄=A-X— in which X=—O—(CH₂)₃—, and A=a radical of formula III wherein n=1, m=0, p=0, G₁—O-Si(CH₃)₃, G2=—Si(CH₃)₃

The compound of Example 4 is prepared in accordance with the method described in Example 1, using 1 mol equivalent of the compound from Example B and 2.2 mol equivalents of 1,1,1,3,5,5,5-heptamethyltrisiloxane.

UV (CH₃CN) max. at 292 nm (E 30 122). ¹H NMR (CDCl₃) δ [ppm]: 7.66 (m, 4H arom.); 6.84 (m, 4H arom.); 3.89 (m, 4H, Ar—OCH₂); 1.74 (m, 4H, Ar—OCH₂—CH₂); 0.50 (m, 4H, Ar—O—CH₂—CH₂—CH₂—Si); 0.01 (m, 42H, 14S₁—CH₃). m/z (CI): 739 (MH⁺); according to mass spectrum, further compounds are also present in small amounts: 697 (MH⁺); 655 (MH⁺); 519 (MH⁺); 517 (MH⁺); 477 (MH⁺).

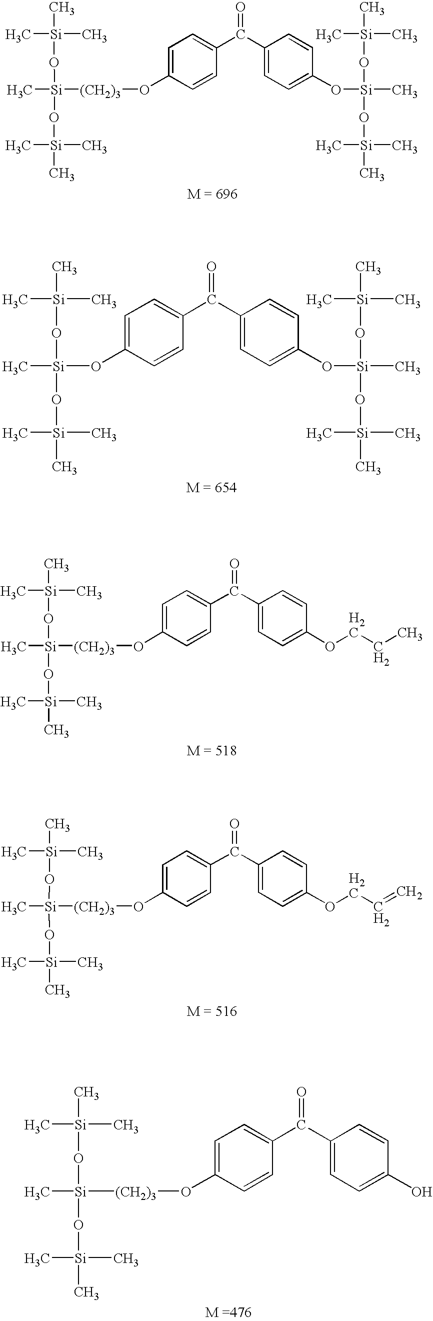

### EXAMPLE 5

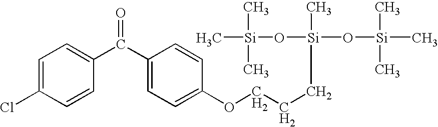

Compound of Formula Ia

R=a radical of formula II wherein R₂, R₃, R₅, R₅=H and R₆═C₁, R₁=a radical of formula II wherein R₂, R₃, R₅, R₆H and R₄ A-X— in which X=—O—(CH₂)₃— and A=a radical of formula III wherein n=1, m=O, p=O, G₁=—O—Si(CH₃)₃, G₂=—Si(CH₃)₃

The compound of Example 5 is prepared in accordance with the method described in Example 1, using 1 mol equivalent of the compound from Example D and 1.1 mol equivalents of 1,1,1,3,5,5,5-heptamethyltrisiloxane.

UV (CH₃CN) max. at 289 nm (ε 19456). ¹H NMR (CDCl₃) δ [ppm]: 7.64 (m, 4H arom.); 7.34 (m, 2H arom.); 6.81 (m, 2H arom.); 3.89 (t, J=7.5 Hz, 2H, Ar—OCH₂); 1.74 (m, 2H, Ar—OCH₂-CH₂); 0.49 (m, 2H, Ar—O—CH₂—CH₂—CH₂—Si); 0.01 (m, 21HH, 7i-CH₃). m/z (El): 494E(M⁺); according to mass spectrum, further compounds are also present in small amounts: 452 ((M⁺)).

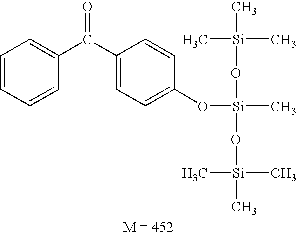

### EXAMPLE 6

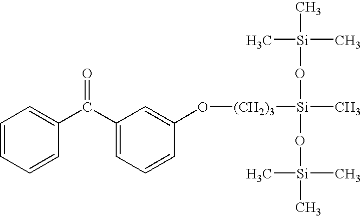

R=phenyl, R₁=a radical of formula II wherein R₂, R₃, R₄, R₆=H and R₅=A-X— in which X≡O—(CH₂)₃— and A=a radical of formula III wherein n=1, m=0, p=0, G₁=—O—Si(CH₃)₃, G₂=—Si(CH₃)₃

The compound of Example 6 is prepared in accordance with the method described in Example 1, using 1 mol equivalent of the compound from Example C and 1.1 mol equivalents of 1,1,1,3,5,5,5-heptamethyltrisiloxane.

UV (CH₃CN) max. at 251 nm (e 14 263). ¹H NMR (CDCl₃) δ [ppm]: 7.70 (m, 2H arom.); 7.47-6.98 (m, 7H arom.); 3.86 (t, 2H, J=6.0, Ar—OCH₂); 1.73 (m, 2H, Ar—OCH₂—CH₂); 0.49 (m, 2H, Ar—O—CH₂—CH₂—CH₂—Si); 0.01 (m, 21H, 78i-CH₃). m/z (El): 460 ((M⁺)); according to mass spectrum, further compounds are also present in small amounts: 418 ((M⁺)).

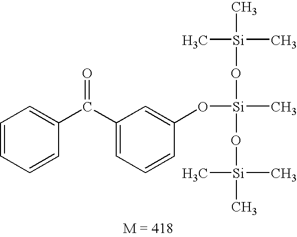

### EXAMPLE 7

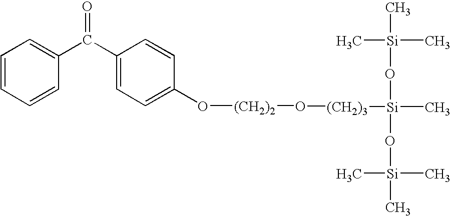

R=a radical of formula II wherein R₂, R₃, R₅, R₆=H and R₄=C₁, R₁=a radical of formula II wherein R₂, R₃, R₅, R₆=H and R₄=A-X— in which X≡O—(CH₂)₃— and A=a radical of formula III wherein n=1, m=0, p=0, G₁=—O—SI(CH₃)₃, G₂=—Si(CH₃)₃

The compound of Example 7 is prepared in accordance with the method described in Example 1, using 1 mol equivalent of the compound from Example E and 1.1 mol equivalents of 1,1,1,3,5,5,5-heptamethyltrisiloxane.

UV (CH₃CN) max. at 285 nm (e 19 833). ¹H NMR (CDCl₃) δ [ppm]: 7.66 (m, 4H arom.); 7.37 (m, 3H arom.); 6.85 (m, 2H arom.); 4.08 (m, 2H, Ar—O—CH₂); 3.68 (m, 2H, Ar—O—CH₂—CH₂—O-C₂H); 3.38 (m, 2H, Ar—O—CH₂—CH₂CH₂—Si); 1.53 (m, 2H, —OCH₂—CH₂—O—CH₂—CH₂); 0.39 (m, 2H, —O—CH₂—CH₂—CH₂—Si); 0.01 (m, 21H, 7S1-CH₃). m/z (E1): 504 ((M⁺)); according to mass spectrum, further compounds are also present in small amounts: 462 ((M⁺)); 284 ((M⁺)); 242 ((M⁺)).

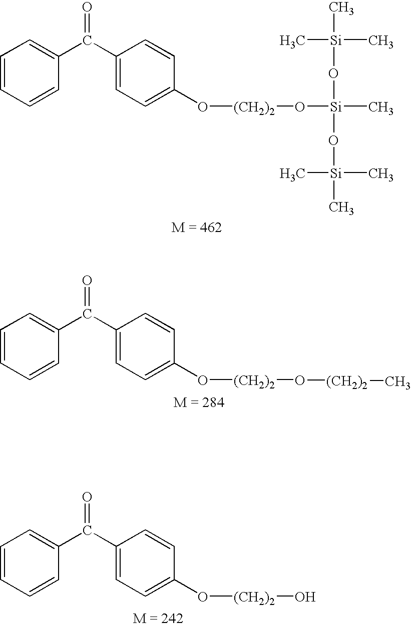

### EXAMPLE 8

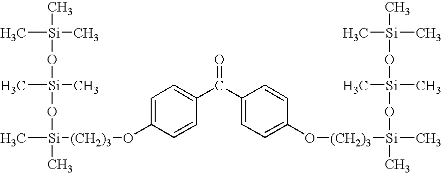

R═R₁ =a radical of formula II wherein R₂, R₃, R₅, Re=H and R₄=A-X— in which X=—O—(CH₂)₃— and A=a radical of formula III wherein n=1, m=0, p=1, G₁═(CH₃), G₂=—Si(CH₃)₃

The compound of Example 8 is prepared in accordance with the method described in Example 1, using 1 mol equivalent of the compound from Example B and 2.2 mol equivalents of 1,1,1,3,5,5,5-heptamethyltrisiloxane.

¹H NMR (CDCl₃) δ [ppm]: 7.67 (m, 4H arom.); 6.84 (m, 4H arom.); 3.90 (m, 4H, 2Ar—O—CH₂); 1.77 (m, 0.4H, 2-O—CH₂—CH₂); 0.58 (m, 4H, 2-O—CH₂—CH₂—CH₂—Si); 0.01 (m, 42H, 14S₁—CH₃). m/z (El): 738 (M); according to mass spectrum, further compounds are also present in small amounts: 696 (M); 654 ((M⁺)).

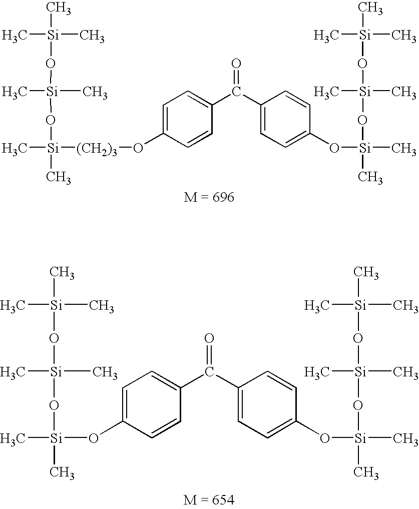

### EXAMPLE 9

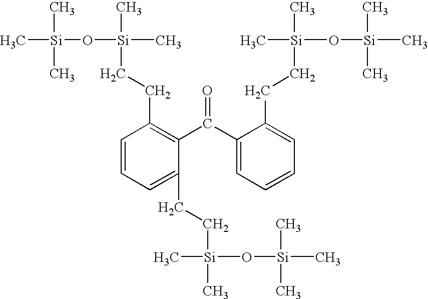

R=a radical of formula II wherein R₃, R₄, R₅═H and R₂ and R₆=A-X—, R₁=a radical of formula II wherein R₃, R₄, R₅, R₆═H and R₂=A-X— in which X=—(CH₂)₂— and A=a radical of formula III wherein n=1, m=0, p=0, G₁=(CH₃), G₂=—Si(CH₃)

Benzophenone (0.36.g, 1.97 mmol), vinylpentamethyldisiloxane (0.69 g, 3.95 mmol) and Ru(H)₂(CO)(PPh₃)₃ (0.037 g, 0.040 mmol) are introduced into toluene (3.0 ml). The reaction solution is boiled at reflux for 60 minutes. A further portion of vinylpentamethyldisiloxane (0.69 g, 3.95 mmol) is then added. The reaction solution is boiled at reflux for a further 120 minutes. When benzophenone can no longer be detected, the reaction solution is cooled to room temperature. Distillation under a high vacuum results in a slightly violet-coloured liquid (1.35 g). Flash chromatography yields 1.31 g of an almost colourless liquid consisting chiefly of the 1:3 product (main product), the 1:2 and the 1:4 product.

UV (CH₃CN) max. at 251 nm (ε 5 650). ¹H NMR (CDCl₃) δ [ppm]: 7.43-7.29 (m, H arom.); 7.15-7.03 (m, H arom.); 3.13-3.06 (m, CH₂—CH₂—Si); 2.87-2.77 (m, CH₂—CH₂—Si); 2.50-2.38 (m, CH₂—CH₂—Si); 1.03-0.98 (m, CH₂—CH₂—Si); 0.940.89 (m, CH₂—CH₂—Si); 0.82-0.74 (m, CH₂—CH₂—Si); 0.20/0.15/0.08/0.07/0.0210.01/0.00/−0.05 (s, CH₃). m/z (El): 704 ((M⁺)); according to mass spectrum, further compounds are also present in small amounts: 878 ((M⁺)); 542 (M); 530 ((M⁺)).

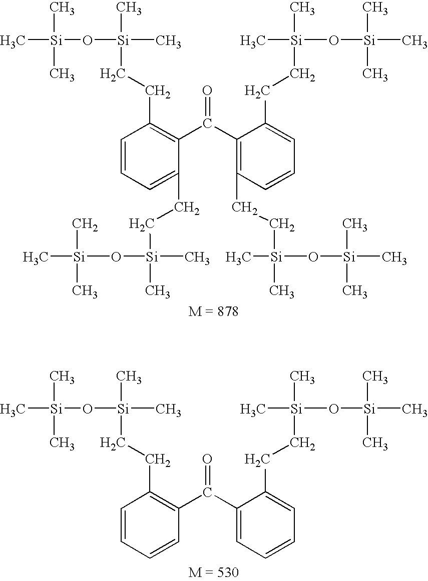

### EXAMPLE 10

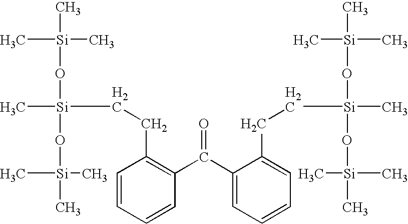

R═R₁=a radical of formula II wherein R₃, R₄, Rr, H and R₂=A-X—In which X═(CH₂)₂— and A=a radical of formula III wherein n=1, m=0, p=1, G, =—O—Si(CH₃)₃, G₂=Si(CH₃)₃

The compound of Example 10 is prepared in accordance with the method described in Example 9, using 1 mol equivalent of benzophenone and 2 portions of 1 mol equivalent of vinylmethylbis(trimethylsilyloxy)silane.

UV (CH₃CN) max. at 250 nm (ε 8 225). ¹H NMR (CDCl₃) δ [ppm]: 7.74 (d, H arom.); 7.51 (t, H arom.); 7.45-7.02 (m, H arom.); 3.04-2.99 (m, CH₂—CH₂—Si); 2.77-2.71 (m, CH₂—CH₂—Si); 2.57-2.53 (m, CH₂—CH₂—Si); 0.90-0.85 (m, CH₂—CH₂—Si); 0.78-0.71 (m, CH₂—CH₂—Si); 0.70-0.62 (m, CH₂—CH₂—Si); 0.07/0.06/0.00/−0.02/−0.04/−0.06/−0.07/−0.08/−0.011/−0.121−0.15/−0.23 (s, CH₃). m/z (El): 678 ((M⁺)); according to mass spectrum, further compounds are also present in small amounts: 926 ((M⁺)); 764 ((M⁺)); 515 ((M⁺)); 430 ((M⁺)).

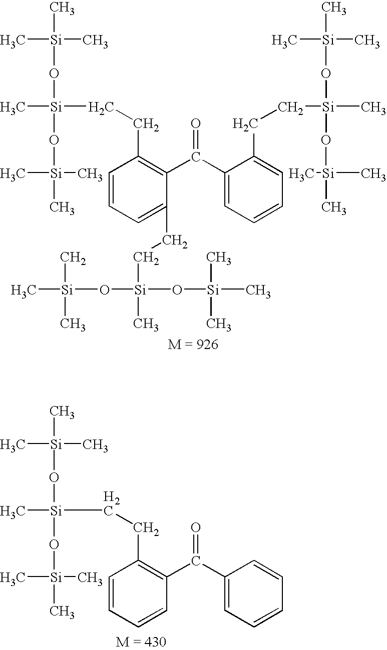

### EXAMPLE 11

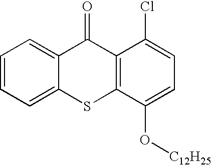

(Formula Ic, R₂, R₃, R₄, R₅, R₇ R H, R₆=—X-A₀, R₉ =—Cl, X≡—O—, A₀—C₁₂H₂₅)

A solution of 1-chloro-4-hydroxy-thioxanthen-9-one (3.05 g, 11.6 mmol), 1-Bromo-dodecane (3.47 g, 13.9 mmol) and potassium carbonate (8.02 g, 58 mmol) in 120 ml acetone is heated for 3.5 hours under reflux. The mixture is then filtered After filtration and removal of the solvent by evaporation an orange solid is obtained. After recrystallisation in methanol (2.3 g, 46%) of the above compound is obtained as yellow crystalline solid.

mp.=77° C. U.V. (THF) max. at 379 nm (ε 6'544), 314 nm (ε 11'515), 257 nm (ε 40'754). ¹H NMR (CDCl₃) δ [ppm]: 8.47 (d, 1H arom.); 7.59 (m, 2H arom.); 7.44 (m, 2H arom.); 6.98 (d, 1H arom.), 4.15 (t, J=6, 2H. —O—CH₂—); 1.91 (m, 2H, —O—CH₂—CH₂—); 1.54 (m, 2H , —OCH₂—CH₂—CH₂—); 1.41-1.27 (m, 16H, 8-CH₂—); 0.86 (t, J=12, —CH₃); 0.70-0.62 (m, CH₂—CH₂—Si).

### EXAMPLE 12

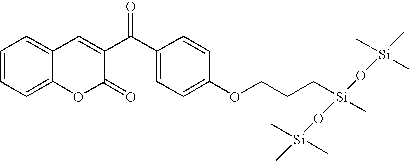

(Formula Id, R₂, R₃, R₄, R₅═H, R₁₀—C₆H₄—X-A, X=—O—(CH₂)₃—, A Rest der Formel III, R₁₈, R₂₂, R₂₃, R₂₄, R₂₅, R₂₆, R₂₇=CH₃, n=1, m=p=0)

A) Preparation of

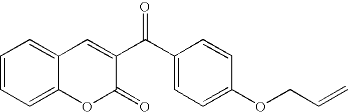

A solution of 3-(4-hydroxy-benzoyl)-chromen-2-one (1 g, 3.76 mmol), allylbromide (0.45 g, 3.76 mmol) and potassium carbonate (0.57 g, 4.13 mmol) in 10 ml acetoneis heated for 14 hours under reflux. The mixture is then filtered. After filtration, removal of the solvent by evaporation and recrystallisation in methanol (0.1 g, 9%) of the above compound is obtained as light yellow crystalline solid.

¹H NMR (CDCl₃) δ [ppm]: 8.02 (s, 1H arom.); 7.89 (d, 2H arom.); 7.60 (m, 2H arom.); 7.37 (m, 2H arom.); 6.95 (m, 2H arom.); 6.05 (m, 1H, —O—CH₂—CH═CH₂); 5.38 (m, 2H, —O—CH₂CH═CH₂); 4.63 (m, 2H, —O—CH₂—CH═CH₂).

B) Preparation of

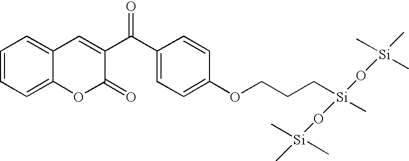

A mixture of one equivalent of the compound from Example 12A (0.1 g, 0.32 mmol) and 1.1 equivalent of 1,1,1,3,5,5,5-heptamethyltrisiloxane (0.08 g, 0.36 mmol) in toluene is heated at 110° C. for 25 hours in the presence of 0.004 equivalent (based on the Pt content) of a Pt catalyst on an activated carbon support. The mixture is then filtered and the solution obtained is treated with activated carbon. After filtration and removal of the solvent by evaporation, the compound is obtained in the form of an oil (0,06 g, 35%).

U.V. (CH₃CN) max. at 285 nm (e 16'436). ¹H NMR (CDCl₃) δ [ppm]: 7.89-7.73 (m, 3H arom.); 7.51-7.45 (m, 2H arom.); 7.29-7.22 (m, 2H arom.); 6.89-6.76 (m, 2H arom.); 3.88 (t, J=6, 2H, —O—CH₂—); 1.73 (m, 2H, —O—CH₂—CH₂); 0.48 (m, 2H , —O—CH₂—CH₂—CH₂); −0.01 (m, 21H, 7-S₁—CH₃). m/z (APCI): 528 ((M⁺)); according to mass spectrum, further compounds are also present in small amounts: 530 ((M⁺)); 308 (MN); 306 ((M⁺)); 268 ((M⁺)); 266 ((M⁺)).

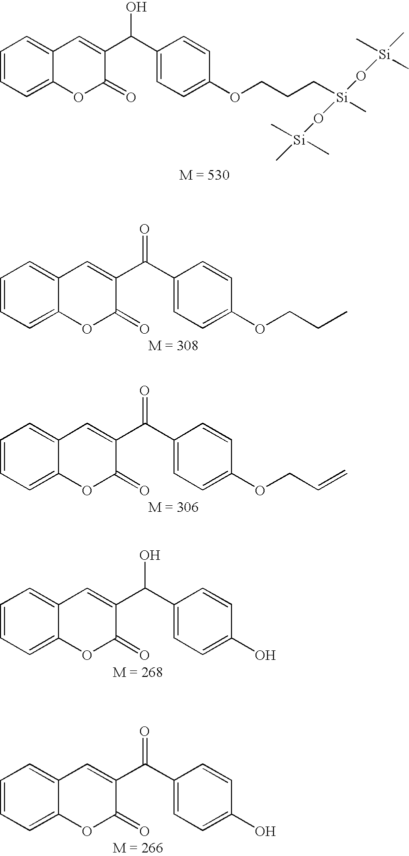

### EXAMPLE 13

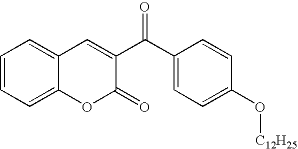

(Formula Id, R₂, R₃, R₄, R₅═H, R₁₁—C₆H₄—X-A, X=—O—, A=Ao=-C₁₂H₂₅)

A solution of 1 mole equivalent 3-(4-hydroxy-benzoyl)-chromen-2-one (0.4 g, 1.77 mmol), 1 bromo-dodecane (0.48 g, 1.95 mmol) and potassium carbonate (0.27 g, 1.95 mmol) in 7 ml acetone is heated for 24 hours under reflux. The mixture is then filtered. After filtration, removal of the solvent by evaporation and recrystallisation in methanol (0.18 g, 23.4%) of the above compound is obtained as yellow crystalline solid.

mp.=122.5-122.8° C. U.V. (DMSO) max. at 315 nm (ε 23500).

### EXAMPLE 14

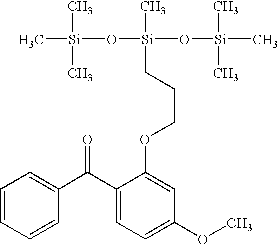

Formula Ia, R=phenyl, R₁=a radical of formula II wherein R₃, R₅, R₆H, R₄ methoxy and R₂=A-X— in which X=—O—(CH₂)₃— and A=a radical of formula III wherein n=1, m=0, p=1, G₁=—O—Si(CH₃)₃, G₂=—Si(CH₃)₃

The compound of Example 11 is prepared in accordance with the method described in Example 1, using 1 mol equivalent of (2-allyloxy-4-methoxyphenyl)phenylmethanone and 1.2 mol equivalents of 1,1,1,3,5,5,5-heptamethyltrisiloxane.

### EXAMPLE 15

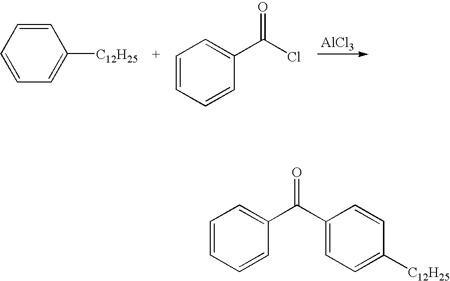

Formula Ia,R=phenyl, R₁=a radical of formula II wherein R₂, R₃, R₅, R₆═H, R₄=A-X— in which A=Ao and X=a single bond, Ao=C₁₂alkyl

52,0 g (0.39 mol) AlCl₃ is added at 0-5° C. to a solution of 86.25 g (0.35 mol) dodecylbenzene and 52.0 g (0.37 mol) benzoylchloride in 400 ml tetrachlorethane. The mixture is stirred over night at room temperature and then pourred onto water. The organic phase is separated.

The solvent is removed by evaporation. After distillation (163° C./1 mbar) 76.5 g of the above product are obtained as yellow liquid.

### APPLICATION EXAMPLES

### Example A1

A UV-curable clear lacquer based on polyurethane acrylate is prepared by mixing the following components:

50.0 parts of a difunctional urethane acrylate (RmActylan 200, Akcros)

25.0 parts tripropylene glycol diacrylate (SR 306, Cray Valley)

15.0 parts trimethylolpropane triacrylate (UCB)

10.0 parts dipentaerythrol pentaacrylate (SR 399, Cray Valley)

2% photoinitiator+1% N-methyldiethanolamine are added to the resulting mixture.

The mixture is applied to a white chipboard and cured using a UV processor under two 80 W/cm lamps at a belt speed of 3 m/min. A tack-free cured film with a thickness of approximately 50 μm is obtained. 30 minutes after cure, the pendulum hardness according to König (DIN 53157) is measured in seconds. The higher the value, the harder is the crosslinked surface. In addition, the static water contact angle (θ) is measured using a contact angle measurement system G10 from Krüss. The greater the measured contact angle, the better are the moisture resistance and scratch resistance of the cured surface. The results are given in the following Table 1:

TABLE 1

| | Pendulum | |
|---|---|---|
| | hardness | |
| Initiator | [sec] | Water contact angle θ |
| 2% photoinitiator from Example 1 | 123 | 86 |
| 2% photoinitiator from Example 4 | 132 | 86 |
| 2% photoinitiator from Example 5 | 132 | 79 |
| 2% photoinitiator from Example 6 | 101 | 82 |
| 2% photoinitiator from Example 7 | 113 | 86 |
| 2% photoinitiator from Example 14 | 120 | 84 |
| 2% IRGACURE 500 (comparative) | 119 | 65 |

IRGACURE 500 is a 1:1 mixture of 50% by wt. 1-hydroxycyclohexyl phenyl ketone and 50% by wt. benzophenone

### Example A2

A UV-curable clear lacquer based on polyurethane acrylat is prepared by mixing the following components:

50.0 parts of a difunctional urethane acrylate (^{RTM}Actylan 200, Akcros)

25.0 parts tripropylene glycol diacrylate (SR 306, Cray Valley)

15.0 parts trimethylolpropane triacrylate (UCB)

10.0 parts dipentaerythrol pentaacrylate (SR 399, Cray Valley)

2% photoinitiator from Example 4+1% 3,5-dimethoxy-octadecylcarbamate benzyl ester (described in EP 764 698) are added to the resulting mixture.

The mixture is applied to a white chipboard and cured using a UV processor under two 80 W/cm lamps at a belt speed of 3 mlmin. A tack-free cured film with a thickness of approximately 50 μm is obtained. 30 minutes after cure, the pendulum hardness according to König (DIN 53157) is measured in seconds. The higher the value, the harder is the crosslinked surface. In addition, the static water contact angle (θ) is measured using a contact angle measurement system G10 from Krümss. The greater the measured contact angle, the better are the moisture resistance and scratch resistance of the cured surface. The results are given in the following Table 2:

TABLE 2

| | Pendulum hardness | |
|---|---|---|
| Initiator | [sec] | Water contact angle θ |
| 2% IRGACURE 500 | 102 | 77 |
| comparative | | |
| 2% photoinitiator from | 97 | 87 |
| Example 4 | | |
| 2% photoinitiator from | 101 | 85 |
| Example 14 | | |

### EXAMPLE A3

A clear UV-curable system based on amine-modified oligoether acrylate

100 parts Laromer PO 84F amine-modified oligoether acrylate

The samples were prepared by adding 2% photoinitiator.

The mixtures were applied to a white chipboard, irradiated by using a UV-processor (2×80 W/cm) at a belt speed of 10 m/min. A tack- free dry film with a thickness of approximately 50 μm is obtained.

30 minutes after cure, the pendulum hardness according to König (DIN 53157) is measured. Surface energy of the coating is determined by measuring the static water contact angle (θ) using a contact angle measuring system G10 from Krüss. The higher the values of the pendulum hardness measurement, the harder is the cured surface. The higher the contact angle, the better is the moisture resistance and scratch resistance.

| | pendulum hardness | water contact |
|---|---|---|
| Initiator | [sec] | angle θ |
| 2% Benzophenone comparative | 53 | 57 |
| 2% Photoinitiator Ex. 15 | 56 | 66 |

### Example A4

A clear and a white pigmented latex solution were prepared containing Clear

10% Nordel hydrocarbon rubber sold by Du Pont de Nemours

90% toluene

White Pigmented

10% Nordel

0.9% TiO2

89.1% toluene

The samples were prepared by adding 1% of the photoinitiator. The mixtures were applied to a glaa plate, dried for 60 minutes at 50° C. in an oven, irradiated by using 6 TL 40W/03 lamps from Philips for 24 hours. A tack-free dry film with a thickness of approximately 30 μm is obtained. After cure the solvent resistance is measured. A piece of felt soaked with toluene is placed on top of the film. After evaporation of the solvent the tackiness of the film is determined. A tacky film (−) is not well crosslinked. A well-cured film is tack-free (+).

| | | Solvent |
|---|---|---|
| Photoinitiator | Solvent resistance clear | resistance white |
| without photoinitiator | − | − |
| Example 1 | + | + |
| Example 2 | + | + |
| Example 3 | + | + |
| Example 5 | + | + |
| Example 6 | + | + |
| Example 7 | + | + |
| Example 8 | + | + |
| Example 9 | + | + |

### Example A5

Surfaceactive Thioxantones

A clear Dual-Cure-System Based on Polyurethenes is Prepared by Mixing:

| | |
|---|---|
| 21.1 | Parts Desmophen ® LS 2009/1, hydroxy functional polyacrylate, |
| | (Bayer AG) |
| | Parts Roskydal ® FWO 2518C, isocyanurate based urethane |
| | acrylate, 80% |
| 32.3 | in butyl acetate (Bayer AG) |
| | Parts Baysilone ® OL 17, flow improver, 10% in Xylene |
| | (Bayer AG) |
| 0.3 | Parts Modaflow ®, flow improver (Monsanto) |
| 0.3 | Parts 1-Methoxy-2-propanol, (Fluka Chemicals) |
| 26.0 | Parts Byk ® 306, flow improver (Byk-Chemie) |
| 0.5 | Parts Roskydal ® FWO 2545 E, urethane acrylate with isocyanate |
| | groups |
| 11.2 | (Bayer AG) |

The mixtures were applied to white coil-coat aluminum, air-dried for 5 minutes at room temperature and heated on a hot plate at 80° C. for 10 minutes. Irradiation is the carried out using a UV-processor (2×120 W/cm)at a belt speed of 5 m/min. A tack free dry film with a thickness of approximately 40 μm is obtained.

45 Minutes after cure, the pendulum hardness according to König (DIN 53157) is measured. Surface energy of the coating is determined by measuring static water contact angle (θ) using a contact angle measuring system G10 from Krüss. The higher the values of the pendulum hardness measurement, the harder is the cured surface. The higher the contact angle, the better is the moisture resistance and scratch resistance.

| | pendulum | |
|---|---|---|
| | hardness | |
| Initiator + Sensitizer | [sec] | water contact angle θ |
| 1% Irg. 369 + 1% ITX | 20 | 90 |
| 1% Irg. 369 + 1% Example 11 | 17 | 96 |

Irgacure 369: 2-benzyl-2-dimethylamino-1(4-morpholinophenyl)-butanone-1 ITX. isopropyl-thioxanthone.

### Example A6

A clear UV-curable System based on polyurethane acrylate is prepared by mixing:

| | |
|---|---|
| 50 | Parts Actilan ® 200, difunktional urethane acrylate (Akcros) |
| 25 | Parts SR 306, tripropylene glycol diacrylate (Cray Valley) |
| 15 | Parts TMPTA, trimethylolpropane triacrylate (UCB) |
| 10 | Parts SR 399, dipentaerythrol pentaacrylate (Cray Valley) |

The mixtures were applied to a white chipboard, irradiated by using a UV-processor (2×80 W/cm) at a belt speed of 3 m/min. A tack free dry film with a thickness of approximately 50 μm is obtained.

30 Minutes after cure, the pendulum hardness according to König (DIN 53157) is measured. Surface energy of the coating is determined by measuring static water contact angle (θ) using a contact angle measuring system G10 from Krüss. The higher the value of the pendulum hardness measurement, the harder is the cured surface. The higher the contact angle, the better is the moisture resistance and scratch resistance.

What is claimed is:

1. A process for the production of a coating having a scratch-resistant durable surface, which comprises
(1) preparing a photocurable formulation comprising
(A) an ethylenically unsaturated polymerizable compound; and
(B) a photoinitiator;
(2) applying the formulation to a substrate; and
(3) curing the formulation either solely by irradiation with electromagnetic radiation, for example of a wavelength ranging from 200 nm into the IR region, especially, for example, from 200 to 800 nm or from 200 to 600 nm, or
by irradiation with electromagnetic radiation, for example of a wavelength ranging from 200 nm into the IR region, especially, for example, from 200 to 800 nm or from 200 to 600 nm, and the prior, simultaneous and/or subsequent action of heat;
wherein
the formulation comprises as photoinitiator (B) at least one surface-active photoinitiator, concentrated at the surface of the formulation, of formula Ia, Ib, Ic or Id: 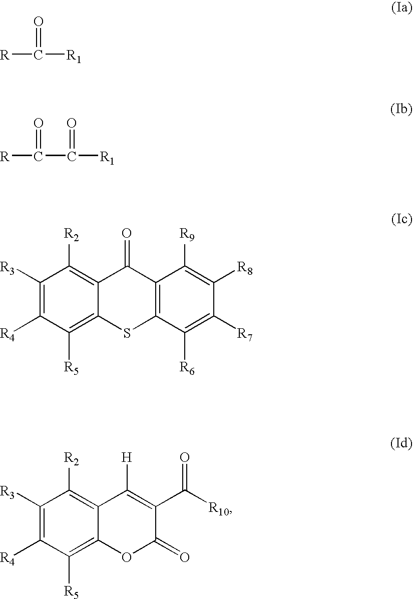
wherein
R and R₁ are each independently of the other a radical of formula 11 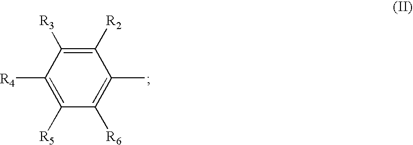
wherein in formula II
R₂, R₃, R₄, R₅ and R₆ are each independently of the others hydrogen; A-X—, A₁-X₁—; C₁-C₁₂alkyl unsubstituted or substituted by OH, C₁-C₄alkoxy, phenyl, naphthyl, halogen, CN, —C(O)R₁₁ or by —O(CO)R₁₁; or C₂—C₁₂alkyl interrupted by one or more non-consecutive oxygen atoms; or R₂, R₃, R₄, R₅ and R₆ each independently are OR₁₂, SR₁₃, NR₁₄R₁₅, —(C₁-C₆alkyl)NR₁₄R₁₅, —O—(C₁-C₆alkyl)-NR₁₄R₁₅, —C(O)R₁₁ or halogen; or are phenyl unsubstituted or substituted by C₁-C₄alkyl or/and by C₁-C₄alkoxy, the substituents OR₁₂, SR₁₃ and NR₁₄R₁₅ being capable, by way of the radicals R₁₂, R₁₃, R₁₄ and/or R₁₅ together with further substituents on the phenyl ring or together with one of the carbon atoms of the phenyl ring, of forming 5- or 6-membered rings;
with the proviso that in formulae (Ia) and (Ib) at least one substituent A-X— or A₁-X₁— is present in at least one of the radicals R and R₁;
or
R and R₁ are naphthyl, anthracyl, phenanthryl or a heterocyclic radical, the radicals naphthyl, anthracyl, phenanthryl and the heterocycle being unsubstituted or substituted by A-X—, A₁-X₁-—C₁-C₈alkyl, phenyl, OR₁₂, SR₁₃, NR₁₄R_{1 5}, —(C₁-C₆alkyl)-NR₁₄R₁₅ or/and by —O—(C₁-C₆alkyl)-NR₁₄R₁₅, and the substituents OR₁₂, SR₁₃ and NR₁₄R₁₅ being capable, by way of the radicals R₁₂, R₁₃, R₁₄ and/or R₁₅ together with further substituents on the naphthyl ring, anthracyl ring, phenanthryl ring or heterocycle or together with one of the carbon atoms of the naphthyl ring, anthracyl ring, phenanthryl ring or heterocycle, of forming 5- or 6-membered rings;
wherein in formula Ic
R₂, R₃, R₄, R₅, R₆, R₇, R₈ and R₉ are each independently of the others hydrogen; A-X—, A₁-X₁; C₁-C₁₂alkyl unsubstituted or substituted by OH, C₁-C₄alkoxy, phenyl, naphthyl, halogen, CN, —C(O)R₁₁ or by —O(CO)R₁₁; or C₂-C₁₂alkyl interrupted by one or more non-consecutive oxygen atoms; or R₂, R₃, R₄, R₅, R₆, R₇, R₈ and R₉ are each independently OR₁₂, SR₁₃, NR₁₄R₁₅, —(C₁-C₆alkyl)-NR₁₄R₁₅, —O-(C₁-C₆alkyl)NR₁₄R₁₅, —C(O)R₁₁ or halogen; or are phenyl unsubstituted or substituted by C₁-C₄alkyl or/and by C₁-C₄alkoxy, the substituents OR₁₂, SR₁₃ and NR₁₄R₁₅ being capable, by way of the radicals R₁₂, R₁₃, R₁₄ and/or R₁ together with further substituents on the phenyl ring or together with one of the carbon atoms of the phenyl ring, of forming 5- or 6-membered rings;
with the proviso that in formula (Ic) at least one of the radicals R₂, R₃, R₄, R₅, R₆, R₇, R₈ and R₉ is A-X— or A₁-X₁—;
wherein in formula Id
R₂, R₃, R₄ and R₅ are each independently of the others hydrogen; A-X—, A₁-X₁—; C₁-C₁₂alkyl unsubstftuted or substituted by OH, C₁-C₄alkoxy, phenyl, naphthyl, halogen, CN, —C(O)R₁₁ or by —O(CO)R₁₁; or C₂-C₁₂alkyl interrupted by one or more nonconsecutive oxygen atoms; or R₂, R₃, R₄ and R₅ are each independently OR₁₂, SR₁₃, NR₁₄R₁₅, —(C₁-C₆alkyl)-NR₁₄R₁₅, —O—(C₁-C₆alkyl)-NR₁₄R₁₅, —C(O)R₁₁ or halogen; or are phenyl unsubstituted or substituted by C₁-C₄alkyl or/and by C₁-C₄alkoxy, the substituents OR₁₂, SR₁₃ and NR₁₄R₁₅ being capable, by way of the radicals R₁₂, R₁₃, R₁₄ and/or R₁₅ together with further substituents on the phenyl ring or together with one of the carbon atoms of the phenyl ring, of forming 5- or 6-membered rings;
with the proviso that in formula (Id) at least one of the radicals R₂, R₃, R₄ and R₅ is A-X— or A₁-X₁—;
R₁₀ is C₁-C₈alkyl, or phenyl unsubstituted or substituted by A-X—, C₁-C₄alkyl and/or by O₁-C₄alkoxy;
R₁₁ is C₁-C₈alkyl, or phenyl unsubstituted or substituted by C₁-C₄alkyl and/or by O₁-C₄alkoxy;
R₁₂ and R₁₃ are each independently of the other hydrogen; or C₁-C₁₂alkyl unsubstituted or substituted by OH, C₁-C₄alkoxy, phenyl, phenoxy or/and by —O(CO)R₁₁; or R₁₂ and R₁₃ are C₂-C₁₂alkyl interrupted by one or more non-consecutive oxygen atoms; or R₁₂ and R₁₃ are phenyl, C₃-C₆alkenyl, cyclopentyl, cyclohexyl or naphthyl, those radicals being unsubstituted or substituted by C₁-C₄alkoxy, phenyl or/and by C₁-C₄alkyl;
R₁₄ and R₁₅ are each independently of the other hydrogen; C₁-C₁₂alkyl unsubstituted or substituted by OH, C₁-C₄alkoxy or/and by phenyl; or C₂-C₁₂alkyl interrupted by one or more non-consecutive oxygen atoms; or R₁₄ and R₁₅ are phenyl, —(CO)R₁₁ or SO₂R₁₀; or R₁₄ and R₁₅, together with the nitrogen atom to which they are bonded, form a 5-, 6- or 7-membered ring that is optionally interrupted by —O— or by —NR₁₇—;
R₁₆ is C₁-C₁₂alkyl, unsubstituted phenyl or phenyl substituted by C₁-C₄alkyl;
R₁₇ is hydrogen, C₁-C₈alkyl unsubstituted or substituted by OH or by C₁-C₄alkoxy; or phenyl unsubstituted or substituted by OH, C₁-C₄alkyl or by C₁-C₄alkoxy;
A and A₁ are each independently of the other a surface-active radical of formula III 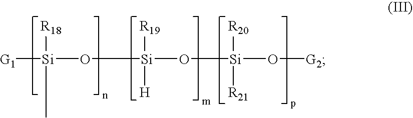
wherein the units IIIa1, IIIa2, IIIa3, IIIa4, IIIb and/or IIIc 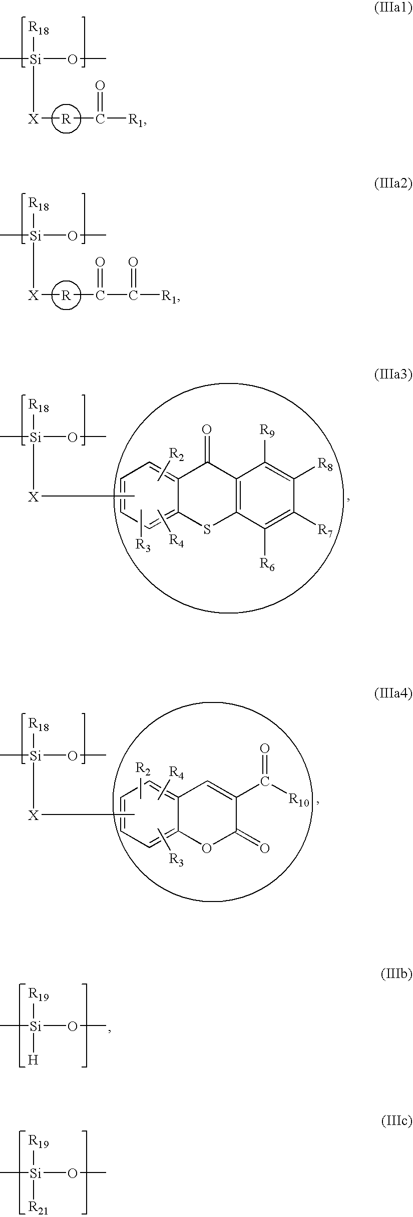
are distributed randomly or in blocks, and in which formulae the circle is intended to denote that an aromatic radical of formula Ia, Ib, Ic or Id as defined above is substituted by the appropriate silyl radical by way of the bridge X; or
A and A₁ are each independently of the other a surface-active radical Ao; n is a number from 1 to 1000 or, when the siloxane starting material is a mixture of oligomeric siloxanes, n can also be less than 1 but greater than 0;
m is a number from 0 to 100;
p is a number from 0 to 10 000;
A₀ is C₆-C₃₀alkyl, C₆-C₃₀alkenyl, C₆-C₃₀alkynyl, C₆-C₃₀aralkyl, C₆-C₃₀alkyl-(CO)—, C₆-C₃₀alkenyl-(CO)—, C₆-C₃₀alkynyl-(CO)—, C₆-C₃₀aralkyl-(CO)—, C₆-C₃₀alkyl(R₁₈)(R₁₉)—, C₆-C₃₀alkenyl-Si(R₁₈)(R₁₉)- or C₆-C₃₀alkynyl—Si(R₁₈)(R₁₉)—, each of which being unsubstituted or substituted by OH, C₁-C₄alkoxy, phenyl, naphthyl, halogen, CN, SR₁₃, NR₁₄R₁₅ and/or by O(CO)R₁₁ and optionally being interrupted by one or more —O—, —S— or NR₁₇—;
G₁ is C₁-C₁₈alkyl or a radical of formula 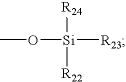
G₂ is C₁-C₁₈alkyl or a radical of formula 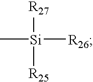
or
G₁ and G₂ together are a single bond;
R₁₈, R₁₉, R₂₀, R₂₂, R₂₃, R₂₄, R₂₅, R₂₆ and R₂₇ are each independently of the others C₁-C₁₈alkyl, phenyl, C₂-C₆hydroxyalkyl, C₂-C₆aminoalkyl or C₅-C₈cycloalkyl;
R₂₁ is unsubstituted C₁-C₁₈alkyl or C₁-C₁₈alkyl substituted by hydroxy, C₁-C₁₂alkoxy, halogen, C₃-C₈cycloalkyl and/or by N(R₁₄)(R₁₅); or R₂₁ is unsubstituted phenyl or phenyl substituted by C₁-C₁₂alkyl, C₁-C₁₂alkoxy, halogen, hydroxy and/or by N(R₁₄)(R₁₅); or R₂₁ is Cs-C₈cycloalkyl;
X and X₁, when A or A₁ is a radical of formula III, are each independently of the other a single bond,
-U-C₁-C₁₀alkylene, -U-C₃-C₁₂cycloalkylene, -U-C₆-C₁₂bicycloalkylene,
-U-C₁-C₁₀alkylene interrupted by one or more non-consecutive C₃-C₁₂cycloalkylene,
-U-C₃-C₁₂cycloalkylene, C₆-C₁₂bicycloalkylene or -U-C₆-C₁₂bicycloalkylene,
-U-C₁-C₁₀alkylene interrupted by one or more non-consecutive O and C₃-C₁₂cycloalkylene, -U-C₃-C₁₂cycloalkylene, C₆-C₁₂bicycloalkylene and/or -U-C₆-C₁₂bicycloalkylene, 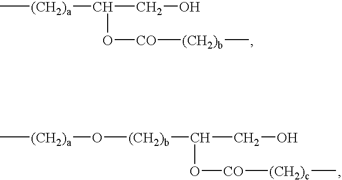
—(CH₂)ₐ—O—(CH₂)_{b}—CH(OH)—CH₂—O—CO(CH₂)_{c}—,
C₂-C₁₀alkenylene, C₂-C₁₀alkynylene, (CH₂)ₐ—O—, —O—(CH₂)ₐ—, —O(CH₂)ₐ—O—,
—(CH₂)ₐ—O—(CH₂)_{b}—, —O—(CH₂)ₐ—O—(CH₂)_{b}—, (CH₂)ₐ—O—(CH₂)_{b}—O—,
—(CH₂)a-NR₁₇(CH₂)_{b}—, —(CH₂)ₐ—NR₁₇—, —(CH₂)ₐ—O—(CH₂)_{b}—NR₁₇—(CH₂)_{c}—,
—(CH₂)ₐ—O—(CH₂)_{b}—NR₁₇—, —(C₂-C₁₀alkenylene)-O—(CH₂)ₐ—, —(C₂-C₁₀alkenylene)—O—,
—(C₂-C₁₀alkynylene)-O—(CH₂)ₐ—, —(C₂-C₁₀alkynylene)—O—,
—(C₂-C₁₀alkenylene)—O—(CH₂)a-O—, —(C₂-C₁₀alkynylene)-O—(CH₂)ₐ—O—,
—(C₂-C₁₀alkenylene)—NR₁₇—, —(C₆C₁₀alkynylene)—NR₁₇—,
—(C₂-C₁₀alkenylene)-NR₁r(CH₂)_{c}—, —(C₂-C₁₀alkynylene)-NR₁₇(CH₂)ₐ—,
—(C₂-C₁₀alkenylene)-O—(CH₂)ₐ—NR₁₇— or —(C₂-C₁₀alkynylene)-O—(CH₂)ₐ—NR₁₇—;
and
X and X₁, when A or A₁ denotes A₀, are each independently of the other a single bond,
—O—, —S— or —NR₁₇—;
-U- is —COO—, —(CH₂)ₐ—COO—Si— or (CH₂)ₐ—Si—;
a, b and c are each independently of the others a number from 0 to 10; with the proviso, however, that they are at least 1- when the methylene group in question is positioned between two oxygen atoms or between an oxygen atom and a nitrogen atom.

2. A process according to claim 1, wherein in the compounds of formulae Ia, Ib, Ic and Id R and R₁ are each independently of the other a radical of formula II,
wherein in formula II
R₂, R₃, R₄, R₅ and R₆ are each independently of the others hydrogen; A-X—, A₁-X₁—, unsubstituted C₁-C₁₂alkyl, or C₂-C₁₂alkyl interrupted by one or more nonconsecutive oxygen atoms; or R₂, R₃, R₄, R₅ and R₆ are OR₁₂, halogen or unsubstituted phenyl;
with the proviso that in formulae (Ia) and (Ib) at least one substituent A-X— or A₁-X₁— is present in at least one of the radicals R and R₁;
or
R and R₁ are naphthyl, the naphthyl radical being -unsubstituted or substituted by A-X—, A₁-X₁—, C₁-C₈alkyl and/or by OR₁₂;
wherein in formula Ic
R₂, R₃, R₄, R₅, R₆, R₇, R₈ and R₉ are each independently of the others hydrogen; A-X—, A₁-X₁—, unsubstituted C₁-C₁₂alkyl, or C₂-C₁₂alkyl interrupted by one or more non-consecutive oxygen atoms; or R₂, R₆, R₄, R₅ and R₆ are OR₁₂, halogen or unsubstituted phenyl;
with the proviso that in formula (Ic) at least one of the radicals R₂, R₃, R₄, R₅, R₆, R₇, R₈ and R₉ is A-X— or A₁-X₁—;
wherein in formula Id
R₂, R₃, R₄ and R₅ are each independently of the others hydrogen; A-X—, A₁-X₁—, unsubstituted C₁-C₁₂alkyl, or C₂-C₁₂alkyl interrupted by one or more nonconsecutive oxygen atoms; or R₂, R₃, R₄, R₅ and R₆ are OR₁₂, halogen or unsubstituted phenyl;
with the proviso that in formula (Id) at least one of the radicals R₂, R₃, R₄ and R₅ is A-X— or A₁-X₁—;
R₁₀ is C₁-C₈alkyl, or phenyl unsubstituted or substituted by A-X—;
R₁₂ is hydrogen or unsubstituted C₁-C₁₂alkyl; or R₁₂ is C₂-C₁₂alkyl interrupted by one or more non-consecutive oxygen atoms; or R₁₂ is phenyl, C₃-C₆alkenyl, cyclopentyl or cyclohexyl;
R₁₈, R₁₉, R₂₀, R₂₁, R₂₂, R₂₃, R₂₄, R₂₅, R₂₆ and R₂₇ are each independently of the others C₁-C₁₈alkyl or phenyl;
X and X₁, when A or A₁ is a radical of formula III, are each independently of the other C₁-C₁₀alkylene, —(CH₂)ₐ—O—, (CH₂)ₐ—O(CH₂)_{b}, —O—(CH₂)ₐ—O—(CH₂)_{b}, —(CH₂)ₐ—O—(CH₂)_{b}—O—, (CH₂)ₐ—NR₁₇—(CH₂)_{b} or —(CH₂)ₐ—NR₁₇—;
and
X and X₁, when A or A₁ denotes A₀, are each independently of the other a single bond, —O—, —S— or —NR₁—.

3. A process according to either claim 1 or claim 2, wherein in the compounds of formulae Ia, Ib, Ic and Id according to claim 1, A and A₁ are a radical of formula III.

4. A composition comprising
(A) at least one ethylenically unsaturated free-radical-photopolymerizable compound; and
(B) at least one surface-active photoinitiator of formula Ia, Ib, Ic or Id; and
(D) optionally, as additional additive, an amine.

5. A composition comprising
(A) at least one ethylenically unsaturated free-radical-photopolymerizable compound;
(B) at least one surface-active photoinitiator of formula Ia, Ib, Ic or Id;
(C) at least one thermally crosslinkable compound; and
(D) optionally, as additional additive, an amine.

6. A composition according to either claim 4 or claim 5, comprising, in addition to components (A) and (B), or (A), (B) and (C), further additives (D) and/or additional photoinitiators (E).

7. A compound of formula Ia, Ib, Ic or Id as defined in claim 1.

8. A process according to claim 1, wherein the photocurable formulation comprises as further component at least one thermally crosslinkable compound (C), and wherein the formulation is cured by irradiation with electromagnetic radiation and the prior, simultaneous and/or subsequent action of heat.

9. A process according to claim 8, wherein the thermally crosslinkable compound (C) is a binder based on a polyacrylate with melamine or on a melamine derivative, or a system based on a polyacrylate polyol or/and polyester polyol with an unblocked polyisocyanate or polyisocyanurate.

10. A process according to claim 1 for the production of pigmented and unpigmented surface coatings, powder coatings, fine layers (gel coats), composite materials or glass fibre cable coatings.

11. A method of concentrating a photoinitiator at the surface of coatings comprising ethylenically unsaturated photopolymerizable compounds, wherein there is added to the photopolymerizable mixture comprising the ethylenically unsaturated photopolymerizable compounds a surface-active photoinitiator of formula Ia, Ib, Ic or Id as defined in claim 1.

12. Use of a compound of formula Ia, Ib, Ic or Id according to claim 7 as a surface-active photoinitiator for the photopolymerization of ethylenically unsaturated compounds or of a mixture that comprises such compounds, as well as in dual-cure latex compositions.

13. A coated substrate that is coated on at least one surface with a composition according to either claim 4 or claim 5.

14. Use of a compound of formula Ia, Ib, Ic or Id according to claim 7 as a flow improver, optionally in combination with further customary flow improver(s).
